(19) United States
(12) Patent Application Publication
(10) Pub. No.: US 2006/0105155 A1
(43) Pub. Date: May 18, 2006

(54) Optical film, polarizing plate and method for forming optical film

(75) Inventors: Akihiro Ikeyama, Odawara-shi (JP); Tsutomu Sugou, Minami-Ashigara-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: FUJI PHOTO FILM CO., LTD., Minami-Ashigara-shi (JP)

(21) Appl. No.: 11/272,797

(22) Filed: Nov. 15, 2005

(30) Foreign Application Priority Data
Nov. 16, 2004 (JP) 2004-331826

(51) Int. Cl. B32B 27/00; B05D 5/06; B05D 3/02

(52) U.S. Cl. 428/220; 428/532; 427/372.2; 427/162

(57) ABSTRACT

An optical film comprises a support having thereon a coat layer formed by directly coating a coating solution containing at least one organic solvent selected from ketones and esters on the support surface, the support comprising a cellulose acylate film containing at least one plasticizer, wherein a surface plasticizer amount in the cellulose acylate film is from 1 to 20 mass % of the cellulose acylate film.

### BACKGROUND OF THE INVENTION

1. Field of the Invention

The present invention relates to an optical film, a polarizing plate using the same and a method for forming the optical film. More specifically, the present invention relates to a method for forming an optical film reduced in the coating failure such as coating streak and drying unevenness, and also relates to the optical film and a polarizing plate using the same.

2. Description of the Related Art

An optical functional film is generally applied to an image display device such as cathode ray tube display device (CRT), plasma display panel (PDP), electroluminescence display (ELD) and liquid crystal display device (LCD). Examples of the optical film include an antireflection film, an antiglare film, a light-scattering film, an optical compensatory film, a surface protective film and a polarizing plate.

In such an optical film, an optical functional layer is imparted in many cases by coating a solution, particularly, a solution containing an organic solvent, on the substrate film. Since this optical film is used for an image display device directly viewed with an eye, the quality required against the coating failure such as streak and drying unevenness at the coating is very severe. In particular, with the progress of a large-screen display, even a weak coating failure becomes readily recognizable and therefore, it is demanded to cause almost no coating failure.

Meanwhile, the substrate generally used for the optical film is a cellulose acylate film, particularly, a cellulose triacetate film. The cellulose acylate film is usually produced by a solution film-forming method or a melt film-forming method, but a film with good planarity can be produced by the solution film-forming method rather than the melt film-forming method. For example, JP-B-5-17844 describes a production method of a cellulose acylate film. Accordingly, the solution film-forming method is commonly employed in practice.

In such a cellulose acylate film, a plasticizer is generally added so as to control the flexibility, moisture permeability and the like of the substrate. JP-A-8-57879 describes a method for controlling the surface plasticizer amount.

In the cellulose acylate film, the cellulose acylate or plasticizer has solubility in a solvent and therefore, in the case of applying a coat layer using an organic solvent directly on the cellulose acylate film, this affects the solubility and permeability of the film substrate for the coating solvent. JP-A-2002-169001 describes a method where in the case of coating an optical functional layer on such a cellulose acylate film, the adhesive property and optical properties are controlled by selecting solvent species differing in the solubility for the support and the ratio therebetween.

As described above, in the case of applying an organic solvent-containing coating solution to a cellulose acylate film containing a plasticizer, the coating property and the drying property are affected due to affinity, solubility and the like of the cellulose acylate or plasticizer for the organic solvent.

Also, the coating solution usually contains components for forming an optical functional layer or a physical functional layer. As for the coating solvent, a solvent ensuring good solubility and stability of these components must be selected. Furthermore, at the coating process using an organic solvent-containing coating solution, in the light of working environment and residual solvent in the finished optical film, a solvent less harmful to human body and ecological system and reduced in the problem on the environmental safety must be selected.

### SUMMARY OF THE INVENTION

An object of the present invention is to provide a high-quality optical film which is, at the coating of an organic solvent-containing coating solution on a cellulose acylate film, assured of good stability of the coating solution and reduced in the harmful effect and environmental load due to coating solvent as well as in the coating failure such as coating streak and drying unevenness.

Another object of the present invention is to provide a method for forming such an optical film.

In order to attain the above-described objects, the present inventors have made studies for the improvement of coating streak and drying unevenness when the organic solvent species used in the coating solution is selected from ketones and esters ensuring not only good solubility-stability for the optical functional components and physical functional components but also less problem in view of safety and environment and the coating solution is directly coated on a cellulose acylate film. As a result, it has been found that the coating streak and the drying unevenness are affected by the amount of the plasticizer in the cellulose acylate film, particularly, the surface plasticizer amount in the film on the side coated with the coating solution.

That is, the objects of the present invention are attained by an optical film and an optical film forming method having the following constitutions.

1. An optical film comprising a support having thereon a coat layer formed by directly coating a coating solution containing at least one organic solvent selected from ketones and esters on a surface of the support, the support comprising a cellulose acylate film containing at least one plasticizer, wherein a surface plasticizer amount in the cellulose acylate film is from 1 to 20 mass % of the cellulose acylate film.

2. The optical film as described in 1 above, wherein the at least one organic solvent selected from ketones and esters is a solvent having permeability into the cellulose acylate film.

3. The optical film as described in 1 or 2 above, wherein the coating solution contains at least one solvent having no permeability into the cellulose acylate film other than the at least one organic solvent selected from ketones and esters.

4. The optical film as described in any one of 1 to 3 above, wherein the surface plasticizer amount in the cellulose acylate film is from 3 to 12 mass % of the cellulose acylate film.

5. The optical film as described in any one of 1 to 4 above, wherein the surface plasticizer amount in the cellulose acylate film is smaller than an average plasticizer amount in whole of the cellulose acylate film.

6. The optical film as described in any one of 1 to 5 above, wherein the cellulose acylate film is heat-treated at a temperature of 100 to 160° C. for 30 seconds or more before the coating.

7. The optical film as described in any one of 1 to 6 above, wherein the plasticizer is a phosphoric acid ester compound.

8. The optical film as described in any one of 1 to 7 above, wherein a thickness of the cellulose acylate film is from 20 to 120 μm.

9. The optical film as described in any one of 1 to 8 above, wherein the coating solution comprises at least one kind of translucent particles.

10. The optical film as described in 9 above, wherein the coat layer is an antiglare property-imparting layer.

11. The optical film as described in any one of 1 to 10 above, wherein a low refractive index layer having a refractive index of 1.31 to 1.45 is further provided on the coat layer directly or through another layer to impart antireflection property.

12. A polarizing plate comprising a polarizing film; and a protective film at least on one side of the polarizing film, wherein is the protective film is an optical film described in any one of 1 to 11 above.

13. A method for forming an optical film, comprising: directly coating a coating solution containing at least one organic solvent selected from ketones and esters on a surface of a support, the support comprising a cellulose acylate film in which at least one plasticizer is contained and a surface plasticizer amount is from 1 to 20 mass % of the cellulose acylate film; and drying it to form a coat layer.

### BRIEF DESCRIPTION OF THE DRAWING

FIG. 1A is a schematic cross-sectional view showing the layer structure of an antiglare and antireflection film; and

FIG. 1B is a schematic cross-sectional view showing the layer structure of an antireflection film excellent in the antireflection performance.

1 denotes an antireflection film; 2 denotes a transparent support; 3 denotes a hard coat layer; 4 denotes an antiglare hard coat layer; 5 denotes a low refractive index layer; 6 denotes a fine particle; 7 denotes a medium refractive index layer; and 8 denotes a high refractive index layer

### DETAILED DESCRIPTION OF THE INVENTION

The optical film of the present invention is described in detail below.

The optical film of the present invention is an optical film produced by a process of directly coating an organic solvent-containing coating solution on a support comprising a cellulose acylate film.

In the following, the support, the coat layer on the support and other layers are described in this order. Incidentally, the term “from (numerical value A) to (numerical value B)” as used in the present invention for expressing a physical value means that “(numerical value A) or more and (numerical value B) or less”.

<Support>

The support for use in the present invention comprises a cellulose acylate film. This cellulose acylate film is obtained by adding various additives to the following cellulose acylate and processing it into a film. On this film support, a functional layer can be formed by the coating of a solution.

Examples of the cellulose as the raw material of the cellulose acylate film for use in the present invention include cotton linter, kenaf and wood pulp (e.g., hardwood pulp, softwood pulp). A cellulose ester obtained from any raw material cellulose may be used and depending on the case, a mixture thereof may also be used.

In the present invention, the cellulose acylate is produced by esterification from a cellulose. In particular, a cellulose obtained by purifying linter, kenaf or pulp is preferably used.

In the present invention, the cellulose acylate is a carboxylic acid ester of cellulose, having a total carbon number of 2 to 22.

The acyl group having a carbon number of 2 to 22 in the cellulose acylate for use in the present invention is not particularly limited and may be either an aliphatic group or an aryl group. Examples of the cellulose acylate include an alkylcarbonyl ester, an alkenylcarbonyl ester, a cycloalkylcarbonyl ester, an aromatic carbonyl ester and an aromatic alkylcarbonyl ester of cellulose, which esters each may further have a substituted group. Preferred examples of the acyl group therefor include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, a cyclohexanecarbonyl group, an adamantanecarbonyl group, an oleoyl group, a phenylacetyl group, a benzoyl group, a naphthylcarbonyl group and a cinnamoyl group. Among these acyl groups, preferred are acetyl, propionyl, butanoyl, pentanoyl, hexanoyl, cyclohexanecarbonyl, dodecanoyl, octadecanoyl, oleoyl, benzoyl, naphthylcarbonyl and cinnamoyl.

The synthesis method of the cellulose acylate is described in detail in JIII Journal of Technical Disclosure, No. 2001-1745 (issued on Mar. 15, 2001 by Japan Institute of Invention and Innovation), page 9.

The cellulose acylate for use in the present invention is preferably a cellulose acylate where the substitution degrees to the hydroxyl groups of cellulose satisfy the following formulae (1) and (2):
2.3≦SA′+SB′≦3.0 Formula (1)
0≦SA′≦3.0 Formula (2)
wherein SA′ represents a substitution degree of the acetyl group substituted to the hydrogen atom of the hydroxyl group in the cellulose, and SB′ represents a substitution degree of the acyl group having a carbon number of 3 to 22 substituted to the hydrogen atom of the hydroxyl group in the cellulose. Incidentally, SA represents an acetyl group substituted to the hydrogen atom of the hydroxyl group in the cellulose and SB represents an acyl group having a carbon number of 3 to 22 substituted to the hydrogen atom of the hydroxyl group in the cellulose.

The β-1,4-bonded glucose unit constituting the cellulose has a free hydroxyl group at the 2-position, 3-position and 6-position. The cellulose acylate is a polymer where these hydroxyl groups are partially or entirely esterified by an acyl group. The acyl substitution degree means a ratio of esterification of the cellulose at each of the 2-position, 3-position and 6-position (100% esterification at each position is a substitution degree of 1).

In the present invention, the sum total (SA′+SB′) of the substitution degrees of SA and SB is preferably from 2.6 to 3.0, more preferably from 2.80 to 3.00.

The substitution degree (SA′) of SA is preferably from 1.4 to 3.0, more preferably from 2.3 to 2.9.

At the same time, the substitution degree preferably satisfies the following formula (3):
0≦SB″≦1.2 Formula (3)
wherein SB″ represents an acyl group having a carbon number of 3 or 4 substituted to the hydrogen atom of the hydroxyl group in the cellulose.

Out of SB″, the substituent to the hydroxyl group at the 6-position preferably occupies 28% or more, more preferably 30% or more, still more preferably 31% or more, yet still more preferably 32% or more. The cellulose acylate film may be also preferably a cellulose acylate film where the sum total of the substitution degrees of SA′ and SB″ at the 6-position of cellulose acylate is 0.8 or more, more preferably 0.85 or more, still more preferably 0.90 or more. With such a cellulose acylate film, a solution having a preferred solubility can be produced and particularly in the case of a chlorine-free organic solvent, a good solution can be produced.

In determining the substitution degree, the bonding degree of fatty acid bonded to the hydroxyl group in the cellulose is measured and the substitution degree is obtained by calculation. As for the measuring method, the bonding degree may be measured according to ASTM D-817-91 and ASTM D-817-96.

Also, the substitution state of the acyl group to the hydroxyl group is measured by the ¹³C-NMR method.

The cellulose acylate film for use in the present invention preferably comprises a cellulose acylate in which the polymer components constituting the film substantially have the above-described definitions. The “substantially” means 55 mass % or more (preferably 70 mass % or more, more preferably 80 mass % or more) of all polymer components. One cellulose acylate may be used alone or two or more cellulose acylates may be used in combination.

The polymerization degree of the cellulose acylate preferably used in the present invention is, in terms of the viscosity average polymerization degree, from 200 to 700, preferably from 230 to 550, more preferably from 230 to 350, still more preferably from 240 to 320. The average polymerization degree can be measured according to the limiting viscosity method by Uda, et al. (Kazuo Uda and Hideo Saito, JOURNAL OF THE SOCIETY OF FIBER SCIENCE AND TECHNOLOGY, JAPAN, Vol. 18, No. 1, pp. 105-120 (1962)). Furthermore, this is described in detail in JP-A-9-95538.

The number average molecular weight Mn of the cellulose acylate is preferably from 7×10⁴ to 25×10⁴, more preferably from 8×10⁴ to 15×10⁴. The ratio Mw/Mn to the mass average molecular weight Mw of the cellulose acylate is preferably from 1.0 to 5.0, more preferably from 1.0 to 3.0. The average molecular weight and the molecular weight distribution of the cellulose ester can be measured by using a high-performance liquid chromatography. Mn and Mw are calculated by using it and then, Mw/Mn can be calculated.

In the cellulose acylate film for use in the present invention, a cellulose acylate satisfying formulae (1) and (2) is preferably used.

[Plasticizer]

The plasticizer used in the cellulose acylate film for use in the present invention is described below. The plasticizer is a component added for imparting flexibility to the cellulose acylate film, enhancing the dimensional stability and the moisture resistance, and reducing the curling. The plasticizer for use in the present invention may be a plasticizer conventionally known as a plasticizer for the cellulose acylate. Among these conventional plasticizers, for example, a phosphoric acid ester-based plasticizer, a phthalic acid ester-based plasticizer and a glycolate-based plasticizer can be preferably used. Examples of the phosphoric acid ester-based plasticizer which can be used include triphenyl phosphate, tricresyl phosphate, cresyl diphenyl phosphate, octyl diphenyl phosphate, diphenyl biphenyl phosphate, trioctyl phosphate, and tributyl phosphate. Examples of the phthalic acid ester-based plasticizer which can be used include diethyl phthalate, dimethoxyethyl phthalate, dimethyl phthalate, dioctyl phthalate, dibutyl phthalate and di-2-ethylhexyl phthalate. Examples of the glycolate-based plasticizer which can be used include butylphthalylbutyl glycolate, ethylphthalylethyl glycolate and methylphthalylethyl glycolate. The plasticizer preferably keeps its stable and uniform distribution in the film, and a less hydrolyzable plasticizer with excellent bleed-out property is preferred.

It is also preferred to use an aliphatic polyhydric alcohol ester as the plasticizer for use in the present invention.

The aliphatic polyhydric alcohol ester for use in the present invention is an ester of an aliphatic dihydric or greater polyhydric alcohol and one or more monocarboxylic acid.

(Aliphatic Polyhydric Alcohol)

The aliphatic polyhydric alcohol for use in the invention is a dihydric or greater polyhydric alcohol and represented by the following formula a:
R¹—(OH)ₙ Formula a
wherein R¹ represents an n-valent aliphatic organic group, n represents a positive integer of 2 or more, and a plurality of OH groups each represents an alcoholic or phenolic hydroxyl group.

Examples of the n-valent aliphatic organic group include an alkylene group (e.g., methylene, ethylene, trimethylene, tetramethylene), an alkenylene group (e.g., ethenylene), an alkynylene group (e.g., ethynylene), a cycloalkylene group (e.g., 1,4-cyclohexanediyl) and an alkanetriyl group (e.g., 1,2,3-propanetriyl). The n-valent aliphatic organic group includes those having a substituent (for example, a hydroxyl group, an alkyl group or a halogen atom).

Preferred examples of the polyhydric alcohol include adonitol, arabitol, ethylene glycol, diethylene glycol, triethylene glycol, tetraethylene glycol, 1,2-propanediol, 1,3-propanediol, dipropylene glycol, tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane and xylitol. Among these, more preferred are triethylene glycol, tetraethylene glycol, dipropylene glycol, tripropylene glycol, sorbitol, trimethylolpropane and xylitol.

(Monocarboxylic Acid)

The monocarboxylic acid in the polyhydric alcohol ester for use in the invention is not particularly limited and, for example, a known aliphatic monocarboxylic acid, alicyclic monocarboxylic acid or aromatic monocarboxylic acid may be used. An alicyclic monocarboxylic acid and an aromatic monocarboxylic acid are preferred in that the moisture permeability and retentivity are enhanced. Preferred examples of the monocarboxylic acid include the followings, but the present invention is not limited thereto. The aliphatic monocarboxylic acid is preferably a linear or branched fatty acid having a carbon number of 1 to 32, more preferably from 1 to 20, still more preferably from 1 to 10. When an acetic acid is contained, the compatibility with cellulose ester increases and this is preferred. It is also preferred to use a mixture of an acetic acid and another monocarboxylic acid.

Preferred examples of the aliphatic monocarboxylic acid include a saturated fatty acid such as acetic acid, propionic acid, butyric acid, valeric acid, caproic acid, enanthic acid, caprylic acid, pelargonic acid, capric acid, 2-ethylhexanecarboxylic acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid and lacceric acid; and an unsaturated fatty acid such as undecylenic acid, oleic acid, sorbic acid, linolic acid, linolenic acid and arachidonic acid. These acids each may have a substituent.

Preferred examples of the alicyclic monocarboxylic acid include a carboxylic acid such as cyclopentane carboxylic acid, cyclohexane carboxylic acid, cyclooctane carboxylic acid, bicyclononane carboxylic acid, bicyclodecane carboxylic acid, norbornene carboxylic acid and adamantane carboxylic acid, and a derivative thereof. Preferred examples of the aromatic monocarboxylic acid include a benzoic acid; those in which an alkyl group is introduced into the benzene ring of a benzoic acid such as toluic acid; an aromatic monocarboxylic acid having two or more benzene rings, such as biphenyl carboxylic acid, naphthalene carboxylic acid and tetralin carboxylic acid; and a derivative thereof. Among these, a benzoic acid is more preferred.

(Polyhydric Alcohol Ester)

The molecular weight of the polyhydric alcohol ester for use in the invention is not particularly limited but is preferably from 300 to 1,500, more preferably from 350 to 750. The molecular weight is preferably higher in view of bleed-out property and preferably lower in view of moisture permeability and compatibility with cellulose ester.

In the polyhydric alcohol ester for use in the present invention, one kind of a carboxylic acid may be used or a mixture of two or more kinds of carboxylic acids may be used. Also, the OH groups in the polyhydric alcohol all may be esterified or may partially remain as the OH group. The polyhydric alcohol ester preferably has three or more aromatic rings or cycloalkyl rings within the molecule.

Examples of the polyhydric alcohol ester for use in the present invention are set forth below.

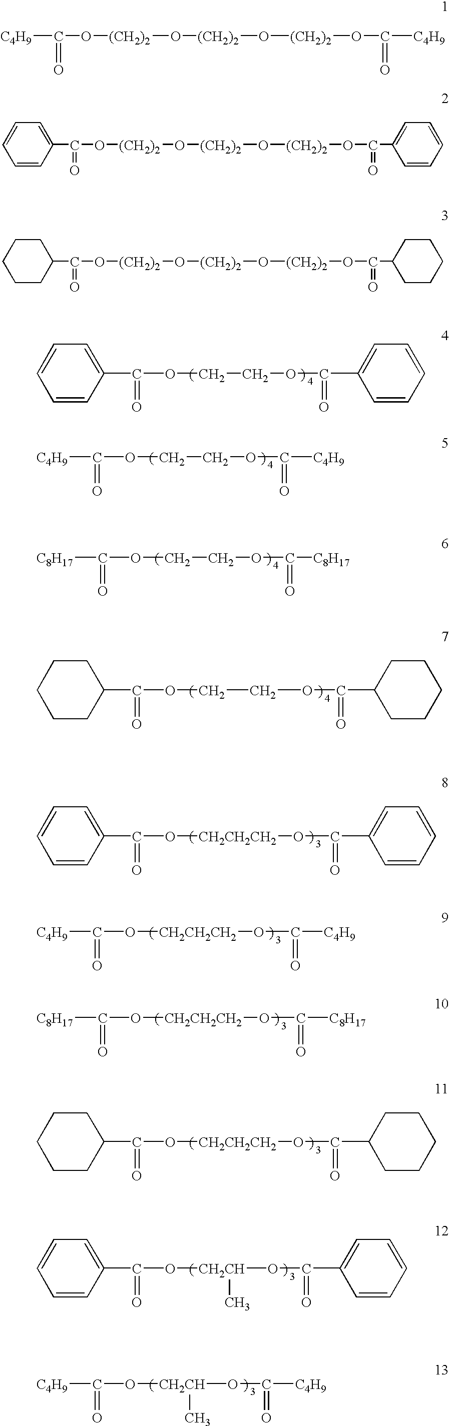

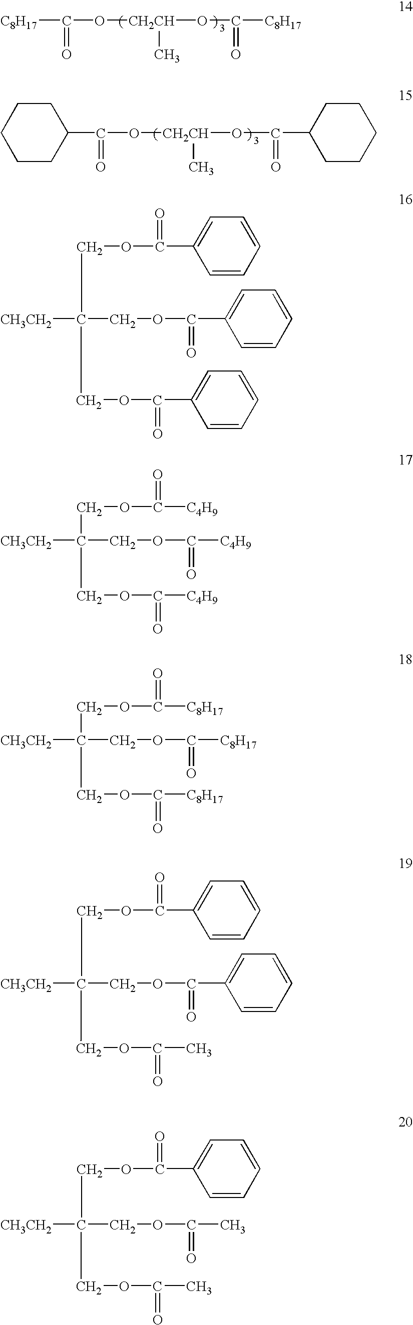

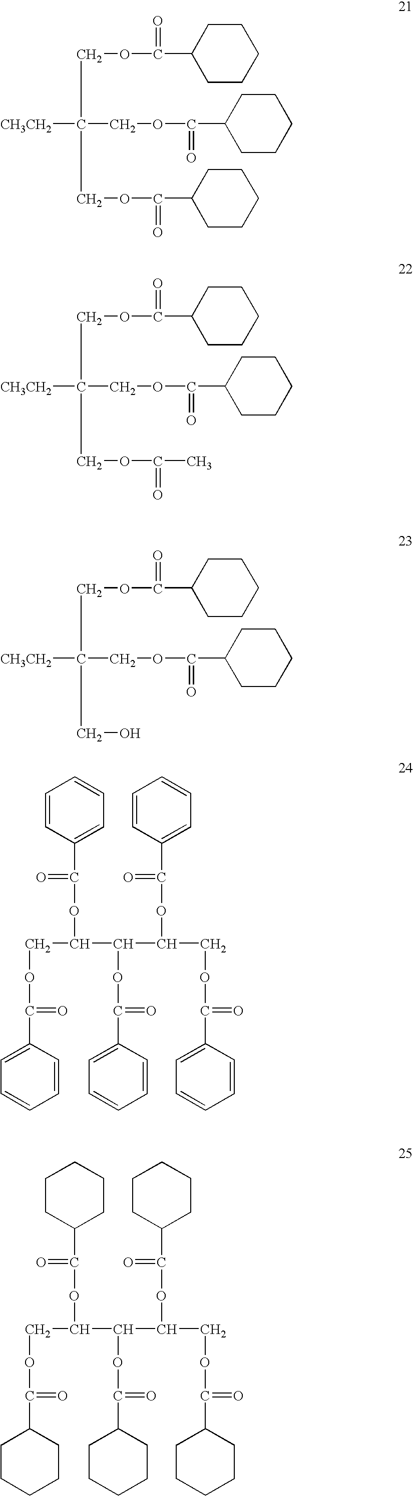

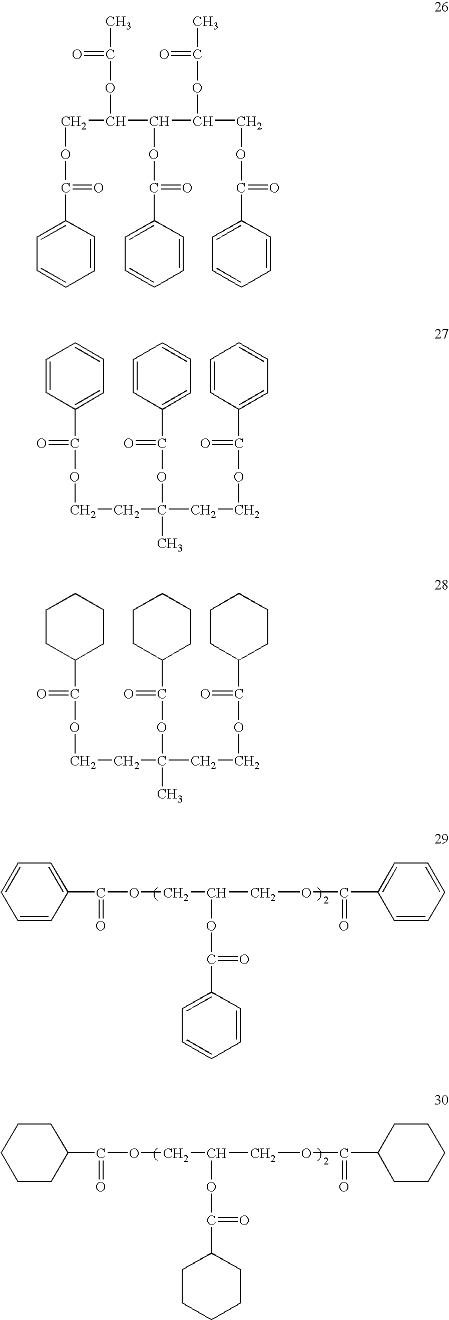

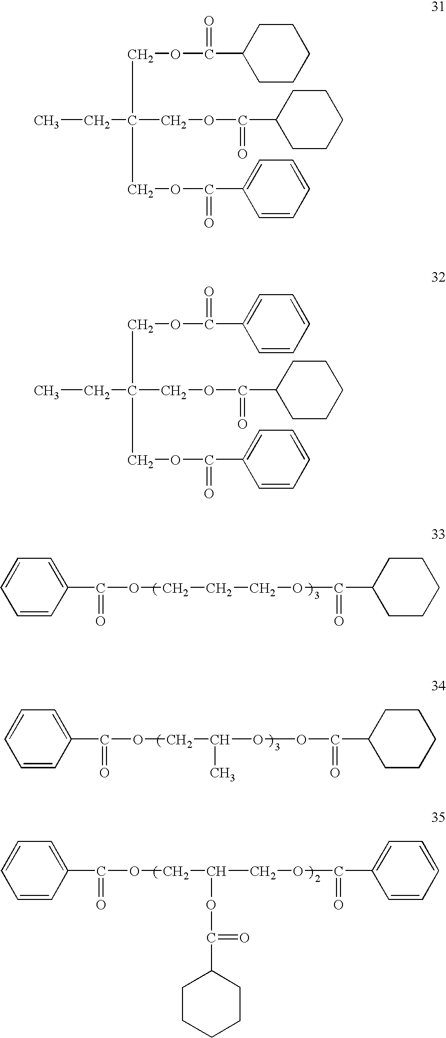

The plasticizer particularly preferred in the present invention is a liquid having a boiling point of 200° C. or more and being liquid at 25° C. or a solid having a melting point of 25 to 250° C., more preferably a liquid having a boiling point of 250° C. or more and being liquid at 25° C. or a solid having a melting point of 25 to 200° C.

In the case where the plasticizer is a liquid, the purification thereof is usually performed by distillation under reduced pressure, but a higher vacuum is more preferred and the plasticizer for use in the present invention preferably has a vapor pressure at 200° C. of 1,333 Pa or less, more preferably 667 Pa or less, still more preferably from 1 to 133 Pa.

The plasticizer for use in the present invention is preferably a phosphoric acid ester-based plasticizer or an aliphatic polyhydric alcohol ester-based plasticizer, more preferably a phosphoric acid ester-based plasticizer.

The cellulose acylate film for use in the present invention preferably has a moisture permeability of 20 to 300 (g/m²; 24 hours, 25° C., 90% RH), more preferably from 20 to 260 (g/m²; 24 hours, 25° C., 90% RH), and most preferably 20 to 200 (g/m²; 24 hours, 25° C., 90% RH).

The plasticizer for use in the present invention preferably has low bleed-out property. The bleed-out property means a property that an additive such as plasticizer precipitates or volatilizes out of the film under a high-temperature high-humidity environment to decrease the mass of the film. More specifically, when a sample is left standing at 23° C.-55% RH for one day and after measuring the mass, left standing at 80° C.-90% RH for two weeks and further at 23° C.-55% RH for one day and the mass is measured, the bleed-out property is a value calculated according to the following formula:
Bleed-out property=((mass of sample before treatment−mass of sample after treatment)/mass of sample before treatment}56×100(%)

The bleed-out property is preferably 2.0% or less, more preferably 1.0% or less, still more preferably 0.5% or less, yet still more preferably 0.1% or less.

The kind and amount used of the plasticizer are determined from the overall viewpoint such as flexibility, moisture permeability, bleed-out property and physical properties (e.g., adhesive property) of the film of the present invention, but in the present invention, it has been found that when an organic solvent is directly coated on the cellulose acylate film, this greatly affects also the coatability of the upper layer.

In the cellulose acylate film for use in the present invention, the plasticizer amount in the cellulose acylate is preferably from 3 to 20 mass %, more preferably from 5 to 15 mass %, still more preferably from 5 to 12 mass %, based on whole of the film.

In the case of coating a coating solution directly on the plasticizer-containing cellulose acylate film for use in the present invention, the plasticizer amount on the film surface to be coated is found to have great effect on the coatability and drying property at the coating of the coating solution. This is considered as follows. The organic solvent component in the coating solution permeates into the substrate, as a result, for example, the coatability of the substrate at the coating is changed, the drying of the coating solution is accelerated due to permeation of the organic solvent component, or the irregularity on the coating film surface or the aggregated state of the particle component in the coating film is changed due to permeation or the like of the components in the coating film occurred at the same time with the permeation of the solvent, and such a phenomenon affects the coating or drying unevenness. In any case, when the cellulose acylate film has a small surface plasticizer amount, this tends to be effective for the improvement of coating or drying unevenness in the present invention.

The plasticizer content in the cellulose acylate film can be determined by a method such as infrared spectroscopy (IR) or Fourier transform infrared spectroscopy (FT-IR). In this method, the plasticizer/cellulose acylate ratio is generally determined by measuring the intensities of IR absorption peak of plasticizer and IR absorption peak of cellulose acylate. For example, JP-A-8-57897 describes a method of measuring the intensities of absorption peak of plasticizer (1,390 cm⁻¹) and absorption peak of cellulose acylate (1,470 cm⁻¹), and determining the ratio of measured intensities. The plasticizer content can be determined by preparing a calibration curve from samples varied in the plasticizer/cellulose acylate ratio.

As for the surface plasticizer amount of the cellulose acylate, a plasticizer amount in the range of about 5 μm from the surface, particularly about 2 μm from the surface, is considered to have an effect on the coatability in the present invention. In the measurement of this surface plasticizer amount, a section of the film cross-sectional surface is prepared and the plasticizer amount in the vicinity of surface can be measured by laser-type transmission IR (the range from surface to about 10 μm) and by attenuated total reflection IR (ATR-IR) (the range from surface to about 2 μm). As for the measuring method of the surface plasticizer amount employed in the present invention, the surface plasticizer is shown by the ATR-IR measurement result, because this method is usually used for the surface composition analysis or can analyze the composition in the range of about 0.2 to 2 μm from the surface. However, other measuring methods may also be used if the plasticizer amount can be determined. The surface plasticizer amount as used in the present invention is not limited to the plasticizer amount of extreme surface (0.1 μm or less).

In the cellulose acylate film for use in the present invention, the surface plasticizer amount is preferably from 1 to 20 mass %, more preferably from 3 to 15 mass %, still more preferably from 3 to 12 mass %, yet still more preferably from 3 to 10 mass %. In the present invention, a smaller surface plasticizer amount tends to give a good effect on the coating unevenness or drying unevenness, but the addition of a plasticizer in the film is necessary in view of surface strength, flexibility and the like of the support and also for imparting surface properties, a plasticizer for giving a surface plasticizer amount of a certain level or more is contained.

The surface plasticizer amount can be varied by the amount of plasticizer added in whole of the film, the casting method of cellulose acylate film, the drying method at the casting, and the drying method after the casting. More specifically, these are, for example, the time from casting to stripping of cellulose acylate film, the drying method, and the heat-treatment after film formation. The methods therefor are described in the [Production Method of Cellulose Acylate Film] later.

In the present invention, the surface plasticizer amount is preferably smaller than the plasticizer amount in whole of the film, because the coatability can be improved while maintaining the film flexibility. This comparison of plasticizer amounts can be confirmed by comparing the measurement results of transmitted IR in the film thickness direction and surface IR. Such control of the plasticizer amount can be achieved by the above-described casting method and drying method.

The cellulose acylate film associated with the present invention preferably contains hydrophobic fine particles for the purpose of enhancing the mechanical strength and dimensional stability of the film, prevention of sticking at the front/rear surface of the film, imparting slipping property for the improvement of film handleability, and enhancing moisture resistance. The average particle diameter for the primary particles is preferably from 1 to 100 nm from the viewpoint of suppressing haze sufficiently low. The apparent specific gravity of the fine particles is preferably 70 g/liter or more. The addition level of the fine particles is preferably from 0.01 to 10 parts by mass, particularly from 0.05 to 7 parts by mass relative to 100 parts by mass of cellulose acylate. Moreover, in order to reduce the added amount of the hydrophilic fine particles to the film and sill impart the desired properties, it is also preferable to incorporate the particles only in the outer layer at the co-casting method to be described layer. In the incorporation of the particles to the outer later, it is also preferable to suitably control so that the added amount of the particles differs between the front and rear surfaces.

Specific preferred examples of the fine particle include, as the inorganic compound, a silicon-containing compound, silicon dioxide, titanium oxide, zinc oxide, aluminum oxide, barium oxide, zirconium oxide, strontium oxide, antimony oxide, tin oxide, tin antimony oxide, calcium carbonate, talc, clay, calcined kaolin, calcined calcium silicate, hydrated calcium silicate, aluminum silicate, magnesium silicate, calcium phosphate, ITO and zinc antimonate. Among these, a silicon-containing inorganic compound and zirconium oxide are more preferred, and silicon dioxide is still more preferred because increase in the haze of the cellulose acylate film can be suppressed.

The surface of the fine particle is preferably hydrophobed and the surface-treating agent is preferably an organic compound containing a polar group having affinity for the fine particle surface, or a coupling agent.

[Ultraviolet Absorbent]

The cellulose acylate film for use in the present invention contains an ultraviolet absorbent for enhancing the light fastness of the film itself or preventing deterioration of the polarizing plate or the image display member (e.g., liquid crystal compound, organic EL compound) of an image display device.

The ultraviolet absorbent preferably has excellent ability of absorbing ultraviolet light at a wavelength of 370 nm or less from the standpoint of preventing deterioration of the liquid crystal and preferably has absorption as little as possible for visible light at a wavelength of 400 nm or more in view of good image display property.

Examples of such an ultraviolet absorbent include, but are not limited to, an oxybenzophenone-based compound, a benzotriazole-based compound, a salicylic acid ester-based compound, a benzophenone-based compound, a cyanoacrylate-based compound and a nickel complex salt-based compound.

Specific examples of the ultraviolet absorbent are described below, but the present invention is not limited thereto.

Specific examples of the ultraviolet absorbent include 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimidomethyl)-5′-methylpheny)benzotriazole, 2,2-methylenebis(4-(1,1,3,3-tetramethylbutyl)-6-(2H-benzotriazol-2-yl)phenol), 2-(2′-hydroxy-3′-tert-butyl-5′-methylphenyl)-5-chlorobenzotriazole, 2,4-dihydroxybenzophenone, 2,2′-dihydroxy-4-methoxybenzophenone, 2-hydroxy-4-methoxy-5-sulfobenzophenone, bis(2-methoxy-4-hydroxy-5-benzoylphenylmethane), (2,4-bis-(n-octylthio)-6-(4-hydroxy-3,5-di-tert-butylanilino)-1,3,5-triazine, 2(2′-hydroxy-3′,5′-di-tert-butylphenyl)-5-chlorobenzotriazole, (2(2′-hydroxy-3′,5′-di-tert-amylphenyl)-5-chlorobenzotriazole, 2,6-di-tert-butyl-p-cresol, pentaerythrityl-tetrakis[3-(3,5-di-tert-butyl-4-hydroxyphenyl)propionate], triethylene glycol-bis[3-(3-tert-butyl-5-methyl-4-hydroxyphenyl)propionate], 1,6-hexanediol-bis[3-(3,5-di-tert-butyl-4-hydroxyphenyl)-propionate], 2,4-bis-(n-octylthio)-6-(4-hydroxy-3,5-di-tert-butylanilino)-1,3,5-triazine, 1-(2′-hydroxy-4′-hexyloxyphenyl)-4,6-diphenyltriazine, 2,2-thio-diethylenebis[3-(3,5-di-tert-butyl-4-hydroxyphenyl)propionate], octadecyl-3-(3,5-di-tert-butyl-4-hydroxyphenyl)propionate, N,N′-haxamethylenebis(3,5-di-tert-butyl-4-hydroxy-hydrocinnamide), 1,3,5-trimethyl-2,4,6-tris(3,5-di-tert-butyl-4-hydroxybenzyl)benzene, tris-(3,5-di-tert-butyl-4-hydroxybenzyl)-isocyanurate, phenyl salicylate, p-tert-butyl salicylate, 2,4-dihydroxybenzophenone, 2,2′-dihydroxy-4-methoxybenzophenone, 2,-hydroxy-4-methoxy-5-sulfobenzophenone, bis(2-methoxy-4-hydroxy-5-benzoylphenylmethane 2′-ethylhexyl-2-cyano-3,3-diphenylacrylate and ethyl-2-cyano-3-(3′,4′-methylenedioxyphenyl)-2-acrylate.

Also, the ultraviolet absorbents described in JP-A-6-148430 may be preferably used.

Furthermore, for example, a hydrazine-based metal deactivator such as N,N′-bis[3-(3,5-di-tert-butyl-4-hydroxyphenyl)propionyl]hydrazine, or a phosphorus-based processing stabilizer such as tris(2,4-di-tert-butylphenyl)phosphite, may be used in combination.

The amount of such a stabilizer compound added is preferably from 0.0001 to 1.0 part by mass, more preferably from 0.001 to 0.1 parts by mass, per 100 parts by mass of the cellulose acylate.

The ultraviolet absorbent for use in the present invention preferably has a transmittance at 370 nm of 20% or less, more preferably 10% or less, still more preferably 5% or less.

Two or more ultraviolet absorbents may be used. The ultraviolet absorbent may be added to the dope after dissolving it in an organic solvent such as alcohol, methylene chloride or dioxolane, or may be added directly to the dope composition. In the case of an inorganic powder which does not dissolve in an organic solvent, the ultraviolet absorbent is dispersed in a mixture of an organic solvent and a cellulose ester by using a dissolver or a sand mill and then added to the dope.

In the present invention, the ultraviolet absorbent is used in an amount of 0.1 to 15 parts by mass, preferably from 0.5 to 10 parts by mass, more preferably from 0.8 to 7 parts by mass, per 100 parts by mass of the cellulose acylate.

An ultraviolet absorbing polymer reduced in the adverse effect by the precipitation, such as adhesion failure and increase of haze, may be also preferably used as the ultraviolet absorbent for use in the present invention. The ultraviolet absorbing polymer is a copolymerized polymer and this is a copolymer of an ultraviolet absorbing monomer having a molar extinction coefficient at 380 nm of 4,000 or more and an ethylenically unsaturated monomer. Of these copolymers, an ultraviolet absorbing copolymerized polymer having a mass average molecular weight of 2,000 to 20,000 is preferred because of less precipitation of the polymer itself.

When the molar extinction coefficient at 380 nm is 4,000 or more, good ultraviolet absorbing performance is revealed, a satisfactory effect of cutting ultraviolet light is obtained and the transparency of the optical film is enhanced without causing yellow coloration of the optical film itself.

In the present invention, the ultraviolet absorbing monomer used for the ultraviolet absorbing copolymerized polymer preferably has a molar extinction coefficient at 380 nm of 4,000 or more, more preferably 8,000 or more, still more preferably 10,000 or more. If the molar extinction coefficient at 380 nm is less than 4,000, the monomer needs to be added in a large amount so as to obtain a desired UV absorbing performance and this incurs, for example, increase of haze or precipitation of ultraviolet absorbent, giving rise to extreme reduction in the transparency and great tendency to decrease the film strength.

Furthermore, the ultraviolet absorbing monomer used for the ultraviolet absorbing copolymerized polymer must satisfy the condition that the ratio of the molar extinction coefficient at 400 nm to the molar extinction coefficient at 380 nm is 20 or more. If this ratio is less than 20, serious coloration occurs and the film is not suitably used for the optical film.

That is, in the present invention, an ultraviolet absorbing monomer having high performance of absorbing ultraviolet light is preferably contained so as to suppress the absorption of light in the vicinity of 400 nm nearer to the visible region and obtain a desired UV absorbing performance.

a. Ultraviolet Absorbing Monomer

Known examples of the ultraviolet absorbing monomer include a salicylic acid-based ultraviolet absorbent (e.g., phenyl salicylate, p-tert-butylphenyl salicylate), a benzophenone-based ultraviolet absorbent (e.g., 2,4-dihydroxybenzophenone, 2,2′-dihydroxy-4,4′-dimethoxybenzophenone), a benzotriazole-based ultraviolet absorbent (e.g., 2-(2′-hydroxy-3′-tert-butyl-5′-methylphenyl)-5-chlorobenzotriazole, 2-(2′-hydroxy-3′,5′-di-tert-butylphenyl)-5-chlorobenzotriazole, 2-(2′-hydroxy-3′,5′-di-tert-amylphenyl)benzotriazole), a cyanoacrylate-based ultraviolet absorbent (e.g., 2′-ethylhexyl-2-cyano-3,3-diphenyl acrylate, ethyl-2-cyano-3-(3′,4′-methylenedioxyphenyl)-acrylate), a triazine-based ultraviolet absorbent (e.g., 2-(2′-hydroxy-4′-hexyloxyphenyl)-4,6-diphenyltriazine, and compounds described in JP-A-58-185677 and JP-A-59-149350.

As for the ultraviolet absorbing monomer for use in the present invention, a compound having a molar extinction coefficient at 380 nm of 4,000 or more, in which the basic skeleton is appropriately selected from various types of known ultraviolet absorbents described above and which is rendered polymerizable by introducing a substituent containing an ethylenically unsaturated bond, is preferably selected and used. In view of storage stability, the ultraviolet absorbing monomer for use in the present invention is preferably a benzotriazole-based compound.

A particularly preferred ultraviolet absorbing monomer is represented by the following formula b: 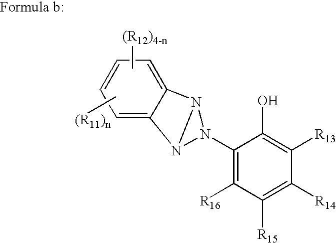
wherein R₁₁ represents a halogen atom or a group substituted on the benzene ring through an oxygen atom, a nitrogen atom or a sulfur atom, R₁₂ represents a hydrogen atom, an aliphatic group, an aromatic group or a heterocyclic group, R₁₃, R₁₅ and R₁₆ each independently represents a hydrogen atom, an aliphatic group, an aromatic group or a heterocyclic group, R₁₄ represents a group substituted on the benzene ring through an oxygen atom or a nitrogen atom, with the proviso that at least one of the groups represented by R₁₁ to R₁₆ has, as a partial structure, a group having the following structure, and n represents an integer of 1 to 4. 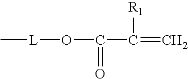
wherein L represents a divalent linking group, and R₁ represents a hydrogen atom or an alkyl group.

Preferred examples of the ultraviolet absorbing monomer for use in the present invention are set forth below, but the monomer is not limited thereto. 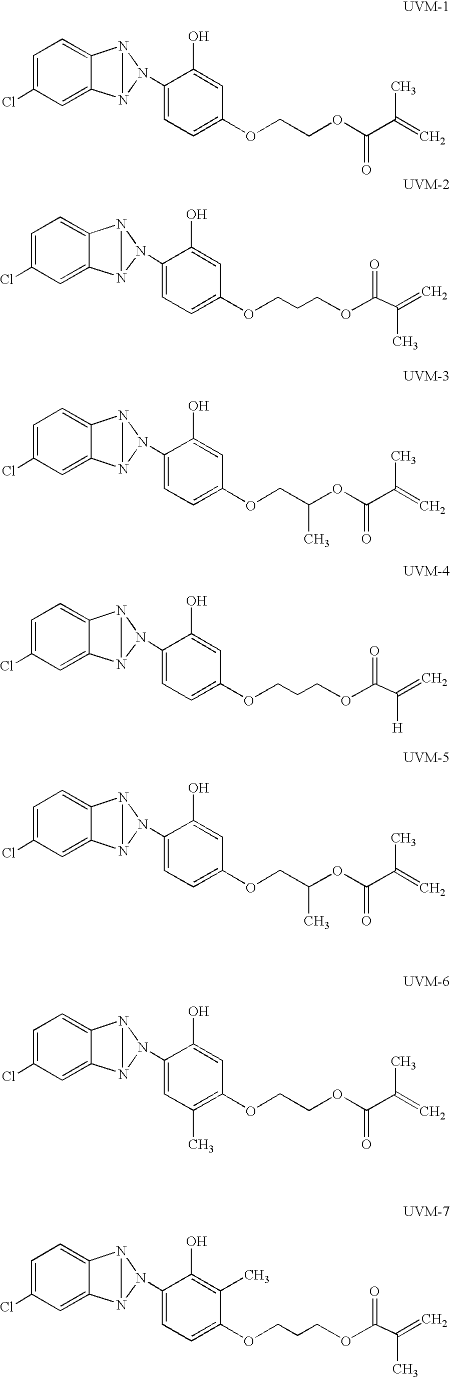 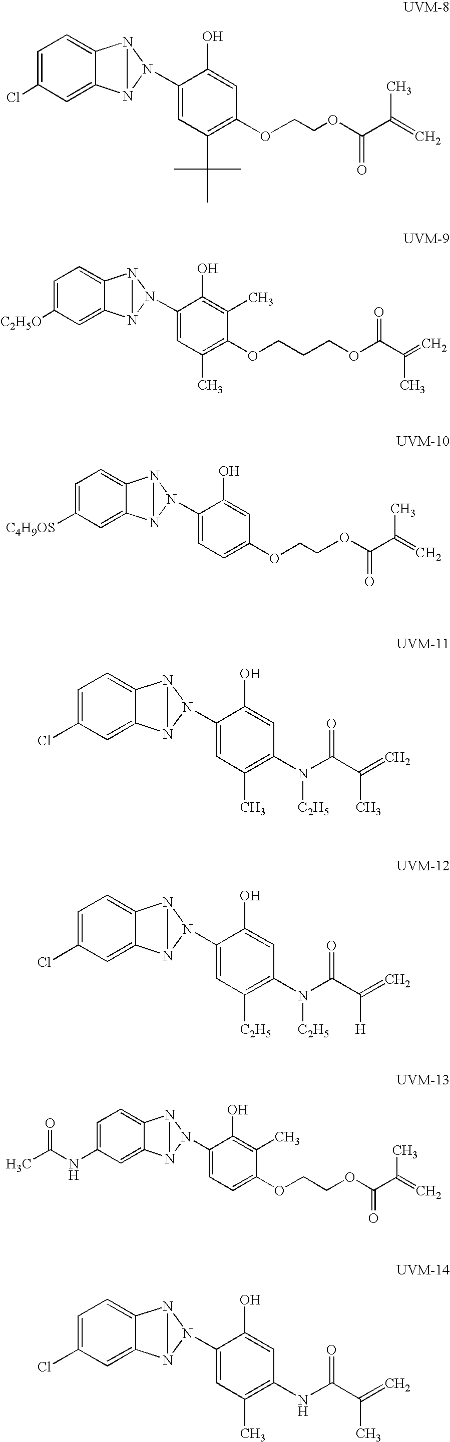 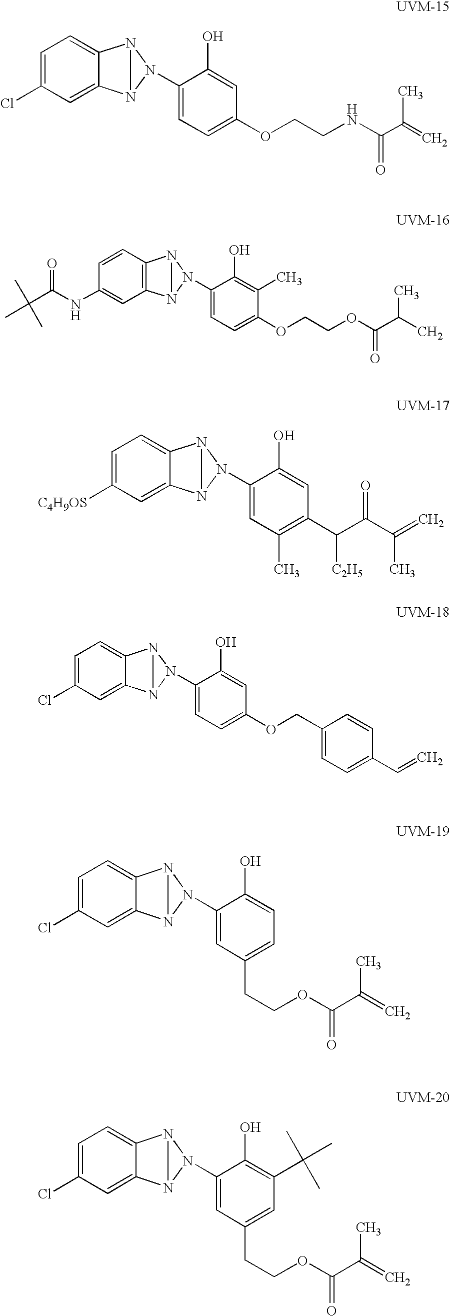
b. Polymer

The ultraviolet absorbing copolymerized polymer for use in the present invention is preferably a copolymer of the above-described ultraviolet absorbing monomer and an ethylenically unsaturated monomer, and the mass average molecular weight of the copolymer is preferably from 2,000 to 20,000, more preferably from 7,000 to 15,000.

In the case of a homopolymer of the ultraviolet absorbing monomer, the film is not suitably used for the optical film due to extreme increase of haze and great reduction of transparency. In addition, the homopolymer of the ultraviolet absorbing monomer has low solubility in a solvent and involves poor workability at the film formation. When the mass average molecular weight is in the above-described range, good compatibility with the resin is obtained and neither bleeding out to the film surface nor coloration occurs in aging.

Examples of the ethylenically unsaturated monomer copolymerizable with the ultraviolet absorbing monomer include a methacrylic acid and an ester derivative thereof (e.g., methyl methacrylate, ethyl methacrylate, propyl methacrylate, butyl methacrylate, i-butyl methacrylate, tert-butyl methacrylate, octyl methacrylate, cyclohexyl methacrylate, 2-hydroxyethyl methacrylate, 2-hydroxypropyl methacrylate, tetrahydrofurfuryl methacrylate, benzyl methacrylate, dimethylaminoethyl methacrylate, diethylaminoethyl methacrylate); an acrylic acid and an ester derivative thereof (e.g., methyl acrylate, ethyl acrylate, propyl acrylate, butyl acrylate, i-butyl acrylate, tert-butyl acrylate, octyl acrylate, cyclohexyl acrylate, 2-hydroxyethyl acrylate, 2-hydroxypropyl acrylate, tetrahydrofurfuryl acrylate, 2-ethoxyethyl acrylate, acrylic acid diethylene glycol ethoxylate, 3-methoxybutyl acrylate, benzyl acrylate, dimethylaminoethyl acrylate, diethylaminoethyl acrylate); an alkyl vinyl ether (e.g., methyl vinyl ether, ethyl vinyl ether, butyl vinyl ether); an alkyl vinyl ester (e.g., vinyl formate, vinyl acetate, vinyl butyrate, vinyl caproate, vinyl stearate); acrylonitrile; vinyl chloride; and styrene.

Among these ethylenically unsaturated monomers, an acrylic acid ester or methacrylic acid ester having a hydroxyl group or an ether bond (e.g., 2-hydroxyethyl methacrylate, 2-hydroxypropyl methacrylate, tetrahydrofurfuryl methacrylate, 2-hydroxyethyl acrylate, 2-hydroxypropyl acrylate, tetrahydrofurfuryl acrylate, 2-ethoxyethyl acrylate, acrylic acid diethylene glycol ethoxylate, 3-methoxybutyl acrylate) is preferred. One of these monomers alone or a mixture of two or more thereof may be copolymerized with the ultraviolet absorbing monomer.

The amount used of the ethylenically unsaturated monomer copolymerizable with the ultraviolet absorbing monomer is selected by taking account of, for example, the compatibility of the obtained ultraviolet absorbing copolymerized polymer with the transparent resin, the transparency, mechanical strength and desired ultraviolet absorbing performance of the optical film, the amount added of the copolymerized polymer, the increase of haze, and the solubility of the copolymerized polymer in a solvent. These two monomers are preferably blended such that the ultraviolet absorbing monomer is contained in the copolymer at a proportion of 20 to 70 mass %, more preferably from 30 to 60 mass %.

As for the method of polymerizing the ultraviolet absorbing copolymerized polymer in the present invention, conventionally known methods can be widely employed, and examples thereof include radical polymerization, anion polymerization and cation polymerization. Examples of the initiator for the radical polymerization include an azo compound and a peroxide, and specific examples thereof include azobisisobutyronitrile (AIBN), an azobisisobutyric acid diester derivative, and benzoyl peroxide. The solvent for the polymerization is not particularly limited but examples thereof include an aromatic hydrocarbon-based solvent such as toluene and chlorobenzene; a halogenated hydrocarbon-based solvent such as dichloroethane and chloroform; an ether-based solvent such as tetrahydrofuran and dioxane; an amide-based solvent such as dimethylformamide; an alcohol-based solvent such as methanol; an ester-based solvent such as methyl acetate and ethyl acetate; a ketone-based solvent such as acetone, cyclohexanone and methyl ethyl ketone; and a water solvent. By selecting the solvent, solution polymerization of performing the polymerization in a uniform system, precipitation polymerization of allowing for precipitation of the produced polymer, or emulsion polymerization of effecting the polymerization in a micelle state can also be performed.

The mass average molecular weight of the ultraviolet absorbing copolymerized polymer can be adjusted by a known molecular weight adjusting method. Examples of the molecular weight adjusting method include a method of adding a chain transfer agent such as carbon tetrachloride, lauryl mercaptan and octyl thioglycolate. The polymerization temperature is usually from room temperature to 130° C., preferably from 50 to 100° C.

The ultraviolet absorbing copolymerized polymer is preferably mixed at a ratio of 0.01 to 40 mass %, more preferably from 0.5 to 10 mass %, based on the cellulose acylate. At this time, when the haze of the optical film formed is 0.5 or less, there is no particular limitation, but the optical film formed preferably has a haze of 0.2 or less, more preferably a haze of 0.2 or less, and a transmittance at 380 nm of 10% or less.

At the time of mixing the ultraviolet absorbing copolymerized polymer with the transparent resin, if desired, the polymer may be used in combination with another low molecular compound, polymer compound, inorganic compound or the like. For example, the ultraviolet absorbing copolymerized polymer and another low molecular ultraviolet absorbent may be simultaneously mixed with the transparent resin. At the same time here, additives such as antioxidant, plasticizer and flame retardant are also preferably mixed.

(Other Additives)

Furthermore, in the cellulose acylate composition for use in the present invention, other various additives (for example, a deterioration inhibitor (e.g., antioxidant, peroxide decomposing agent, radical inhibitor, metal inactivating agent, acid scavenger, amine), an optical anisotropy controlling agent, a release agent, an antistatic agent and an infrared absorbent) according to usage may be added in each preparation step. Such an additive may be either a solid or an oily product. That is, the melting point or boiling point thereof is not particularly limited. As for the infrared absorbing dye, those described, for example, in JP-A-2001-194522 may be used.

These additives may be added at any stage in the dope preparation step, or a step of adding the additives may be provided as a final preparation step of the dope preparation process. The amount of each material added is not particularly limited as long as its function can be exerted. When the cellulose acylate film comprises multiple layers, the kind or amount added of the additive may be different among respective layers. This is a conventionally known technique described, for example, in JP-A-2001-151902. The materials described in detail in JIII Journal of Technical Disclosure, No. 2001-1745 (issued on Mar. 15, 2001 by Japan Institute of Invention and Innovation), pp. 16-22 are preferably used. Such an additive is preferably used in an appropriate amount within the range from 0.001 to 20 mass % based on the entire cellulose acylate composition.

The support comprising the cellulose acylate film of the present invention has a generally employed thickness of 20 to 200 μm, preferably a thickness of 20 to 120 μm, more preferably from 30 to 90 μm. With the film thickness in this range, not only breaking or wrinkling of the support at the production is suppressed but also the polarizing plate or display device can be made thin and excellent in various optical properties, cost, productivity, processing efficiency and the like.

The cellulose acylate film used as the support in the present invention preferably has a long roll form with a length of 100 to 5,000 m and a width of 0.7 to 2 m. With this form, the optical film of the present invention, the antireflection film, the polarizing plate protective film or the image display device can be made thin and lightweight, good optical properties such as elevated transmittance and in turn enhanced contrast or display brightness can be stably obtained, and the handling of the long and broad support is facilitated and causes no problem such as wrinkling.

The fluctuation width of the film thickness is preferably within ±3%, more preferably within ±2.5%, still more preferably within ±1.5%. Within this fluctuation, the coatability of the optical film is substantially not affected by the fluctuation of the support thickness and good coatability is ensured.

For suppressing the fluctuation width of the film thickness within ±3%, it is effective, for example, (1) to contain no low molecular form (oligomer form) of cellulose acylate, (2) to control the concentration and viscosity at the time of casting a solution (dope) for the formation of the polymer film, prepared by dissolving the composition mainly comprising a cellulose acylate in an organic solvent, and (3) to control the drying temperature on the film surface in the drying step and when a drying air is used, control the air flow, air direction and the like. The dissolution step, the casting step and the drying step are described later in [Production Method of Cellulose Acylate Film].

The curl value in the width direction of the cellulose acylate film for use in the present invention is preferably from −7/m to +7/m, more preferably −5/m to +5/m. When the curl value in the width direction of the film is in this range, good film handling is ensured at the time of providing a coat layer described later on the long and broad cellulose acylate film and breaking of the film does not occur. Furthermore, the film is prevented from intense contact with the transportation roll at the edge or center part of the film, as a result, dust emission or attachment of foreign matters on the film is not generated and the frequency of point defects or coating streaks on the antireflection film or polarizing plate can fall within the allowed value range. In addition, with the curl value in the above-described range, entering of bubbles can be prevented at the lamination of a polarizing film.

The curl value can be measured according to the measuring method (ANSI/ASCPH 1.29-1985) prescribed by the American National Standard Institute.

[Production Method of Cellulose Acylate Film]

The cellulose acylate film used as the support in the present invention is preferably produced by a solvent casting method. In the solvent casting method, the cellulose acylate film is produced by using a solution (dope) prepared by dissolving the cellulose acylate and the like in an organic solvent.

(Solution Preparation Step)

The organic solvent used in the solvent casting method is not particularly limited as long as it is an organic solvent usually used in the solvent casting method, and an organic solvent having a solubility parameter of 17 to 22 is preferred. Specific examples thereof include a chloride of lower aliphatic hydrocarbon, a lower aliphatic alcohol, a ketone having a carbon atom number of 3 to 12, an ester having a carbon atom number of 3 to 12, an ether having a carbon atom number of 3 to 12, aliphatic hydrocarbons having a carbon atom number of 5 to 8, and aromatic hydrocarbons having a carbon number of 6 to 12.

The ether, ketone and ester each may have a cyclic structure. A compound having any two or more functional groups of an ether, a ketone and an ester (that is, —O—, —CO— and —COO—) can also be used as the organic solvent. The organic solvent may further have another functional group such as alcoholic hydroxyl group. In the case where the organic solvent is an organic solvent having two or more kinds of functional groups, the carbon atom number thereof may be sufficient if a compound having any one of those functional groups has a carbon number falling within the preferred carbon number range above.

Specific examples of the compound include those described in detail in JIII Journal of Technical Disclosure, No. 2001-1745, pp. 12-16, supra.

Specific examples of the organic solvent in which the cellulose acylate is dissolved include a hydrocarbon (e.g., benzene, toluene), a halogenated hydrocarbon (e.g., methylene chloride, chlorobenzene), an alcohol (e.g., methanol, ethanol, diethylene glycol), a ketone (e.g., acetone), an ester (e.g., methyl acetate, ethyl acetate, propyl acetate) and an ether (e.g., tetrahydrofuran, methyl cellosolve).

Among these, a halogenated hydrocarbon having a carbon atom number of 1 to 7 is preferred, and methylene chloride is more preferred. In view of solubility of cellulose acylate, strippability from support and physical properties such as mechanical strength and optical property of film, at least one alcohol having a carbon atom number of 1 to 5 or a mixture of a plurality of such alcohols is (are) preferably mixed in addition to methylene chloride. The alcohol content is preferably from 2 to 25 mass %, more preferably from 5 to 20 mass %, based on the entire solvent. Specific examples of the alcohol include methanol, ethanol, n-propanol, isopropanol and n-butanol. In particular, methanol, ethanol, n-butanol or a mixture thereof is preferably used.

Use of a halogenated hydrocarbon such as methylene chloride has no problem from technical viewpoint but in view of global or working environment, the organic solvent preferably contains substantially no halogenated hydrocarbon. The term “contains substantially no” means that the ratio of the halogenated hydrocarbon in the organic solvent is less than 5 mass % (preferably less than 2 mass %). Also, it is preferred that a halogenated hydrocarbon such as methylene chloride is not detected at all from the produced cellulose acylate film.

Examples of such a non-chlorine type solvent include solvent systems described in JP-A-2002-146043 (paragraphs [0021] to [0025]) and JP-A-2002-146045 (paragraphs [0016] to [0021]).

The non-chlorine type solvent is preferably a mixed solvent of at least one organic solvent selected from an ether, a ketone and an ester each having a carbon atom number of 3 to 12, and an alcohol, in which the ratio of the alcohol content in the solvent is from 2 to 40 mass %.

In the mixed solvent, an aromatic or aliphatic hydrocarbon having a carbon atom number of 5 to 10 may be added at a proportion of 0 to 10 vol %. Examples of the hydrocarbon include cyclohexane, hexane, benzene, toluene and xylene.

In particular, the mixed solvent is preferably a mixed solvent of two or more kinds of organic solvents, more preferably a mixed solvent of three or more solvents different from each other, in which a first solvent is a ketone having a carbon atom number of 3 to 4, an ester having a carbon atom number of 3 to 4 or a mixed solution thereof, a second solvent is selected from ketones having a carbon atom number of 5 to 7 and an acetoacetic acid ester, and a third solvent is selected from alcohols having a boiling point of 30 to 170° C. and a hydrocarbon having a boiling point of 30 to 170° C.

In view of solubility of cellulose acylate, a mixed solvent of an acetic acid ester, ketones and alcohols, obtained by mixing these solvents at a ratio of 20 to 90 mass % of acetic acid ester, 5 to 60 mass % of ketones and 5 to 30 mass % of alcohols, is preferred.

The blending ratio of alcohols in this mixed solvent is preferably from 2 to 40 vol %, more preferably from 3 to 30 vol %, still more preferably from 5 to 20 vol %, based on all solvents.

Preferred examples of the alcohols include a monoalcohol or dialcohol having a carbon atom number of 1 to 8 and a fluoroalcohol having a carbon atom number of 2 to 10. Among these, more preferred are methanol, ethanol, 1-propanol, 2-propanol, 1-butanol, 2-butanol, tert-butanol, 1-pentanol, 2-methyl-2-butanol, cyclohexanol, ethylene glycol, 2-fluoroethanol, 2,2,2-trifluoroethanol and 2,2,3,3-tetrafluoro-1-propanol. One of these alcohols may be added alone, or a mixture of two or more thereof may be added.

In addition to the above-described organic solvent, a fluoroalcohol is preferably added to the dope in an amount of 10 mass % or less, more preferably 5 mass % or less, based on the entire organic solvent amount so as to enhance the transparency of film or promote the dissolution. Examples of the fluoroalcohol include the compounds described in JP-A-8-143709 (paragraph [0020]) and JP-A-11-60807 (paragraph [0037]). One of these alcohols may be used or two or more thereof may be used.

In the present invention, an inert gas such as nitrogen gas may be filled in the vessel at the preparation of the dope.

The viscosity of the dope immediately before film formation may be sufficient if the dope can be cast at the film formation, and the dope is usually prepared to have a viscosity of preferably from 10 to 2,000 ps·s, more preferably from 30 to 400 ps·s.

In the preparation of the dope, the dissolution method is not particularly limited, and the dope may be prepared by a room-temperature dissolution method, a cooling dissolution method, a high-temperature dissolution method or a combination thereof. Examples thereof include the dope preparation methods described in JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-4-259511, JP-A-2000-273184, JP-A-11-323017 and JP-A-11-302388. The techniques described in these patent publications regarding the method of dissolving the raw material polymer of the support in an organic solvent can be appropriately applied also to the present invention. In the case of a cellulose acylate dope solution using cellulose acylate as the polymer, concentration and filtration of the solution are usually performed and these are described in detail in JIII Journal of Technical Disclosure, No. 2001-1745 supra, page 25. Incidentally, when the dissolution is performed at a high temperature, the temperature is in most cases higher than the boiling point of the organic solvent used and in this case, the vessel is used in a pressurized state.

The dope further contains the above-described plasticizer and fine particles and if desired, contains other additives such as retardation adjusting agent and ultraviolet absorbent.

(Method of Adding and Mixing Fine Particles)

In the case of adding fine particles to the cellulose acylate solution, it is important that coarse particles described above are not present and the fine particles are stably dispersed without causing aggregation or precipitation. Insofar as these conditions are satisfied, a desired cellulose acylate solution can be obtained without any particular limitation in the method of adding and mixing fine particles. A method of preparing a liquid dispersion of the fine particles separately from the preparation of the dope, and mixing and dispersing it in the dope is preferred.

The additives except for the fine particles may be added, for example, at the sage of mixing the cellulose acylate and the solvent, or may be added after a mixed solution of the cellulose acylate and the solvent is prepared. Furthermore, the additives may be added by a so-called just-before addition method of adding and mixing the additives immediately before casting the dope and in this case, the mixing is performed by using a screw-type kneader disposed in the online position. These additives may be mixed by adding the additives themselves, but it is also a preferred embodiment that the additives are dissolved by using a solvent or a binder (preferably a cellulose acylate) or depending on the case, dispersed and used as a stabilized solution.

(Film-Forming Step)

The method of producing a film by using the dope in the present invention is described below. As for the method and equipment for producing a cellulose acylate film, a solvent casting film formation method called a drum or band method and a solvent casting film formation apparatus, which are conventionally known and used for the production of a cellulose acylate film, are used.

The film-forming step is described below. The dope (cellulose acylate solution) prepared in a dissolving machine (pot) is once stored in a storing pot and finalized by removing the bubbles contained in the dope. Here, it is important to eliminate aggregates and foreign matters from the prepared dope by microfiltration. More specifically, the filtration is preferably performed by using a filter having a pore size as small as possible within the range of not allowing for elimination of the components in the dope solution. The filter used for the filtration has an absolute filtration accuracy of 0.1 to 100 μm, preferably from 0.1 to 25 μm. The filter thickness is preferably from 0.1 to 10 mm, more preferably from 0.2 to 2 mm.

In this case, the filtration is preferably performed under a pressure of 15 kgf/cm² or less, more preferably 10 kgf/cm² or less, still more preferably 2 kgf/cm² or less.

For the purpose of precision filtration, it is also preferred to perform the filtration several times by sequentially decreasing the pore size of filter.

The filtering medium for the precision filtration is not particularly limited in its type as long as it has the above-describe performance, but examples thereof include a filament type, a felt type and a mesh type. The material of the filtering medium for the precision filtration of the dispersion is not particularly limited as long as it has the above-described performance and does not adversely affect the coating solution, but examples thereof include a stainless steel, a polyethylene, a polypropylene and a nylon.

The prepared dope is supplied to a pressure-type die from the dope discharge port through, for example, a pressure-type quantitative pump capable of feeding a constant amount of solution while keeping high precision by the number of rotations, and uniformly cast on a metal support in the casting part endlessly running from the mouth ring (slit) of the pressure-type die, and the damp-dry dope film (also called web) is stripped from the metal support at the release point after nearly one round of the metal support. The obtained web is nipped by clips at both ends, transported by a tenter while keeping the width, thereby dried, then transported by a roll group of a drying unit to complete the drying, and taken up to a predetermined length by a take-up machine. The combination of the tenter and the drying unit comprising a roll group varies depending on the purpose.

The surface of the metal support used in the casting step preferably has an arithmetic average roughness (Ra) of 0.015 μm or less and a ten-point average roughness (Rz) of 0.05 μm or less, more preferably an arithmetic average roughness (Ra) of 0.001 to 0.01 μm and a ten-point average roughness (Rz) of 0.001 to 0.02 μm, still more preferably an (Ra)/(Rz) ratio of 0.15 or more. When the metal support has a surface roughness in such a predetermined range, uniform stripping of the web from the metal support is facilitated and the surface profile of the film after film formation can be controlled to fall within the scope of the present invention.

With respect to these production steps (classified into casting (including co-casting), drying, stripping, stretching and the like), those set forth in pp. 25 to 30 of the aforementioned Journal of Technical Disclosure No. 2001-1745 in detail are preferred.

In the casting procedure, one kind of a dope may be single-layer cast, or two or more layers may be simultaneously and/or sequentially co-cast. As such casting procedures, single layer casting can be conducted by drum casting, band casting, etc. which are disclosed in JP-A-7-11055, etc. Further, in the step of co-casting, for co-casting the aforementioned cellulose acylate solution, simultaneous stacked layer-co-casting of two or more layers of cellulose acylate solutions or stacked layer-co-casting at remote positions are preferred. Among these methods, simultaneous co-casting is particularly preferred. As the simultaneous co-casting method, those disclosed in JP-A-61-94725 and JP-A-62-43846 can be adopted. In the cellulose acylate film obtained by stacked-layer co-casting of two or more layers using cellulose acylate solutions, the thickness of the layer lying at the air side and/or that of the layer lying at the metal support side preferably occupy (occupies) 0.5 to 30% of the total thickness. Further, when two or more layers of cellulose acylate solutions are simultaneously stacked-layer co-cast from the die slit onto the casting surface, a more viscous solution is preferably surrounded by a less viscous solution. Still further, when two or more layers of cellulose acylate solutions are simultaneously stacked-layer co-cast, it is preferred that the dope is surrounded by an outer solution whose alcohol content is higher than that of an inner solution when the dopes are pushed out from the die slit to the casting surface.

In this step of casting the cellulose acylate solution, the solution temperature is preferably from −10 to 57° C. Also, at the time of casting the aforementioned cellulose acylate solution, the temperature for the casting step is preferably kept at −10 to 57° C. Furthermore, the metal support on which the cellulose acylate solution is cast preferably has a surface temperature of from −20 to 40° C.

Particularly, in the step of film-forming the dope comprising the above-described composition, the drying step is important so as to prevent aggregation or uneven distribution of the compound added.

The dope on the support is generally dried, for example, by a method of blowing hot air from the surface side of the support (drum or belt), that is, from the surface of the web on the support; a method of blowing hot air from the back surface of the drum or belt; or a liquid heat transfer method of bringing a liquid at a controlled temperature into contact with the drum or belt from the back surface opposite the dope casting surface, and heating the drum or belt through heat transfer, thereby controlling the surface temperature. The back surface liquid heat transfer method is preferred. The support surface before casting may be at any temperature as long as it is lower than the boiling point of the solvent used for the dope. However, in order to accelerate the drying or deprive the solution of its fluidity on the support, the surface temperature is preferably set to a temperature 1 to 10° C. lower than the boiling point of the solvent having a lowest boiling point out of the solvents used.

In the drying step of drying the dope cast in the belt form and obtaining a cellulose acylate film, the drying temperature is preferably from 5 to 250° C., more preferably from 20 to 180° C. The film is further dried at 30 to 160° C. so as to remove the residual solvent and in this case, the residual solvent is preferably evaporated by drying the film with high-temperature air of which temperature is successively varied. This method is described in JP-B-5-17844. According to this method, the time from casting to stripping can be shortened. The drying temperature, the drying air flow and the drying time vary depending on the solvent used, and these may be appropriately selected according to the kind and combination of the solvents used.

In order to obtain a film with good dimensional stability, the residual solvent content of the finally finished film is preferably 2 mass % or less, more preferably 0.4 mass % or less. Incidentally, in the present invention, when a release agent is used, the stripping time can be more shortened and the resistance at the stripping decreases, so that a cellulose acylate film having a surface state free from worsening (for example, unevennessin the cross direction at the stripping or bumps ascribable to the unstripped gel-like grains) can be obtained.

More specifically, considering maintenance of good productivity and less generation of air unevenness, the average drying rate in the process from casting of the dope to stripping is preferably from more than 300 mass %/min to 1,000 mass %/min, more preferably from more than 400 mass %/min to 900 mass %/min, and most preferably from more than 500 mass %/min to 800 mass %/min.

The average drying rate is a value obtained by dividing the variation of the solvent content in the cast dope by the time.

The average drying rate can be adjusted by appropriately controlling, for example, the temperature and air flow of drying air, the concentration of solvent gas, the surface temperature of casting support, the temperature of dope cast, the wet thickness of dope cast, or the solvent composition of dope cast.

(Stripping Step)

This is a step of stripping the web at the release position after evaporation of the solvent on the metal support. The stripped web is fed to the next step. If the web at the stripping has an excessively large residual solvent amount (formula below), stripping becomes difficult, whereas if the web is thoroughly dried on the metal support and then stripped, a part of the web may come off halfway. As for the method of increasing the film-forming speed (where the web is stripped while having a residual solvent amount as large as possible and therefore, the film-forming speed can be increased), a gel casting method is known. Examples thereof include a method of adding a poor solvent for cellulose ester to a dope, casting the dope and gelling it, and a method of decreasing the temperature of a metal support and performing gelling. By gelling the dope on the metal support and thereby increasing the strength of the film at the stripping, the web can be stripped at a high rate and the film-forming speed can be elevated. The stripped residual solvent amount is determined by the strong or weak condition at the drying of web on the metal support, the length of metal support, or the like.

The web is preferably stripped when the residual solvent amount at the release position is from 5 to 400 mass %, more preferably from 10 to 350 mass %. In the case of stripping the web at a point having a larger residual solvent amount, if the web is too soft, the planarity may be lost at the stripping, or buckles or streaks are readily generated due to stripping tension.

In the present invention, the stripped residual solvent amount can be expressed by the following formula:
Residual solvent amount(mass %)={(M−N)/N}×100
wherein M represents a mass of the web at an arbitrary point, and N represents a mass after the web having a mass M is dried at 110° C. for 3 hours.

The time for stripping the web from the metal support is preferably from 1 to 120 seconds, more preferably from 2 to 100 seconds, still more preferably from 3 to 90 seconds. As the time is shorter, the casting rate and productivity are elevated, but the web becomes difficult to handle.

In the drying step after stripping from the support, the film shrinks in the width direction due to evaporation of the solvent. As the film is dried at a higher temperature, the shrinkage becomes larger. For finishing a film with good planarity, it is preferred to dry the film while suppressing this shrinkage as much as possible. From this viewpoint, a method described, for example, in JP-A-62-46625 where the web is dried while holding both ends in the width direction with clips to keep the width throughout the drying step or in a part of the drying step (tenter method) is preferred.

In the present invention, the casting rate is preferably from 10 to 200 m/min.

(Drying and Stretching Step)

After stripping, the web is generally dried by using a drying unit of passing the web alternately through zigzag disposed rolls, a tenter unit of transporting the web while clipping both ends of the web with clips, or both units. The means for drying is generally to blow hot air on both surfaces of the web, but a technique of heating the web by applying a microwave instead of air may also be used. Excessively abrupt drying is liable to impair the planarity of the finished film. The drying temperature is usually throughout from 40 to 250° C., preferably from 40 to 180° C. The drying temperature, the drying air flow and the drying time vary depending on the solvent used and the drying conditions may be appropriately selected according to the kind and combination of the solvents used.

The web is preferably dried under the conditions such that the residual solvent amount in the finished cellulose acylate film finally becomes from 0.01 to 1.5 mass %, more preferably from 0.01 to 1.0 mass %.

These casting and drying steps are fundamentally set by the casting method, casting rate, stripping method, surface quality or the like and by changing the conditions within their allowed ranges, the surface plasticizer amount can be varied. More specifically, the surface plasticizer amount may be decreased, for example, by a method of accelerating the drying on the metal support at the casting, a method of rapidly stripping the film from the metal support, or a method disclosed in JP-A-8-57879 of heat-treating the film at a temperature of 100 to 160° C. after the residual solvent in the film becomes 5 mass % or less. Also, the surface not in contact with the metal support at the casting is belatedly dried and therefore, has a large surface plasticizer amount, and the surface not in contact with the metal support tends to have a small surface plasticizer amount. Therefore, the surface not in contact with the metal support may be used for coating, but since this surface is not contacted with the metal support, the surface quality may change for the worse due to planarity of the film. Among those methods for changing the surface plasticizer amount, the method of heat-treating the film at 100 to 160° C. is preferred because the surface plasticizer amount can be decreased while maintaining the plasticizer amount in the entire film. In such a heat treatment, the temperature is preferably from 120 to 150° C., and the heat-treating time is preferably from 30 to 1,200 seconds, more preferably from 60 to 900 seconds, still more preferably from 120 to 600 seconds.

(Stretching Step)

The aforementioned cellulose acylate film is preferably stretched at a draw ratio of 0.5 to 300% at least during uniaxial casting or after casting.

In the casting step, for example, uniaxial stretching only in one direction such as the casting direction (longitudinal direction), or biaxial stretching in the casting direction and another direction (transverse direction) is preferably performed.

By stretching the produced cellulose acylate film, the mechanical strength and further optical property (retardation value) can be adjusted, whereby the stretching ratio is preferably from 3 to 100%.

In case where the stretching method(s) of the following (1), (2) or both is (are) adopted, film planarity, the strength as a membrane, the optical properties and the like can be adjusted so as to be within the predetermined range.

(1) The film is stretched in the width direction at a draw ratio of 3 to 40%, more preferably from 7 to 38%, still more preferably 15 to 35%. Subsequently thereto, the film is treated at a temperature of 20 to 160° C. under expansion of the film by 0.4 to 5%, more preferably 0.7 to 4%, more preferably 1% to 3.5% in the longitudinal direction.

(2) A temperature difference is provided between the front and rear surface during stretching. The temperature of the surface, which has been in contact with the support (band or drum) during casting, is set 2° C. to 20° C. more preferably 3° C. to 15° C., more preferably 4° C. to 12° C. higher than that of the opposite surface.

With these measures, the optical properties of the resulting film become homogeneous along with the improvement of the mechanical properties since the maldistribution of the additives (plasticizers, ultra-fine particles, UV agents, etc.), which have been incorporated in the film in the stretching step, is resolved.

(Winding, and Other Steps)

In one of the steps from the aforementioned casting step to film winding step, both ends of the aforementioned cellulose acylate film are preferably subjected to slitting. In addition, both of the slitted edges are preferably knurled, whereby the concavity-convexity difference of the knurled portion is preferably from 1 to 200 μm, more preferably from 3 to 50 μm, particularly preferably from 5 to 20 μm.

With respect to the winding step for the aforementioned film, the winding length is preferably at least 100 m in the longitudinal direction, and the width is preferably at least 60 cm. More preferably, the longitudinal length is from 1000 to 6000 m, particularly preferably from 2000 to 5000 m, while the length in the width direction is more preferably from 100 cm to 500 cm, particularly preferably from 120 cm to 300 cm.

Furthermore, the dope can be cast simultaneously with other layers (e.g., adhesive layer, dye layer, antistatic layer, antihalation layer, UV absorbing layer, polarizing layer).

As described above, in the present invention, the support is cellulose acylate film, and the cellulose acylate film is preferably a film produced through a solution preparation step of preparing a cellulose acylate solution by dissolving a cellulose acylate in a substantially non-chlorine type solvent, a film-forming step of film-forming a cellulose acylate film from the cellulose acylate solution, and a stretching step of stretching the cellulose acylate film.

For producing a cellulose acylate film with the fluctuation width in the thickness being within ±3%, it is effective to (1) control the concentration and viscosity at the time of casting a solution (dope) prepared by dissolving the cellulose acylate film in an organic solvent, or (2) control the drying temperature on the film surface in the drying step and when a drying air is used, control the air flow, air direction and the like.

[Properties (Surface Profile) of Cellulose Acylate Film]

The cellulose acylate film surface on the side where an antireflection layer is provided preferably has, in terms of the film surface irregularity based on JIS B0601-1994, an arithmetic average roughness (Ra) of 0.0005 to 0.1 μm, a ten-point average roughness (Rz) of 0.001 to 0.3 μm, a maximum height (Ry) of 0.5 μm or less, more preferably (Ra) of 0.0002 to 0.05 μm, (Rz) of 0.005 to 0.1 μm and (Ry) of 0.3 μm or less, still more preferably (Ra) of 0.001 to 0.02 μm, (Rz) of 0.002 to 0.05 μm and (Ry) of 0.1 μm.

Within these ranges, a uniform coated surface state without coating unevenness is obtained and an optical functional layer assured of good adhesion between the support and the coated film is advantageously provided.

Also, the fine surface irregularities preferably have a morphology such that the ratio (Ra/Rz) of the arithmetic average roughness (Ra) to the ten-point average roughness (Rz) is 0.1 or more and the average distance (Sm) of film surface irregularities based on JIS B0601-1994 is 2 μm or less. Here, the relationship between Ra and Rz indicates the uniformity of surface irregularities. The fine surface irregularities more preferably have an (Ra/Rz) ratio of 0.15 or more and an average distance (Sm) of 1 to 0.1, still more preferably an (Ra/Rz) ratio of 0.2 or more and an average distance (Sm) of 0.1 to 0.001 μm.

The shapes of recessions and protrusions on the surface can be evaluated by a transmission electron microscope (TEM), an atomic force microscope (AFM) or the like.

In the cellulose acylate film, the number of optical defects having a visual size of 100 μm or more is preferably 1 piece or less per m² in view of decrease in the visual defects and elevation of the yield.

The optical defect can be observed with use of a polarizing microscope by arranging the slow axis of the film in the cross-Nicol state to run in parallel to the absorption axis of the polarizer. A defect observed as a bright spot is approximated in terms of area to a circular form, and those having a diameter of 100 μm or more are counted. The bright spot of 100 μm or more can be easily observed with a naked eye.

That is, the cellulose acylate film preferably has a surface such that the arithmetic average roughness (Ra) of surface irregularities based on JIS B0601-1994 is from 0.0005 to 0.1 μm, the ten-point average roughness (Rz) is from 0.001 to 0.3 μm, the average distance (Sm) of surface irregularities is 2 μm or less, and the number of optical defects having a visual size of 100 μm or more is 2 pieces or less, more preferably 1 piece or less, per m².

[Optical Properties of Film]

The cellulose acylate film preferably has a light transmittance of 90% or more and a haze of 1% or less, more preferably a light transmittance of 92% or more and a haze of 0 to 0.5%.

The haze value can be measured according to JIS-K-7105 by using a haze meter (for example, Model 1001DP manufactured by Nippon Denshoku Industries Co., Ltd. or HR-100 manufactured by Murakami Color Research Laboratory).

[Dynamic Properties of Film]

(Tear Strength)

The tear strength of the cellulose acylate film, as measured based on the tear strength test (Ermendorf tear method) of JIS K7128-2:1998, is preferably 2 g or more because the film strength can be satisfactorily maintained even with the above-described film thickness. The tear strength is more preferably from 5 to 25 g, still more preferably from 6 to 25 g, and in terms of 60 μm, preferably 8 g or more, more preferably from 8 to 15 g.

More specifically, a sample piece of 50 mm×64 mm is subjected to moisture conditioning under the conditions of 25° C. and 65% RH for 2 hours and then, the tear strength can be measured by using a light-load tear strength tester.

(Scratch Strength)

The scratch strength is preferably 2 g or more, more preferably 5 g or more, still more preferably 10 g or more. Within this range, the scratch resistance and handleability on the film surface are maintained without problem.

The support surface is scratched with a sapphire needle having a conic apex angle of 90° and a tip radius of 0.25 m, and the scratch strength can be evaluated by the load (g) when the scratch mark is recognized with an eye.

[Residual Solvent Amount of Film]

The support for use in the present invention is set to have a residual solvent amount of 0 to 1.5%, whereby the curling can be prevented. The residual solvent amount is preferably from 0 to 1.0%.

It is considered that when the residual solvent amount is small at the film formation by the solvent casting method, the free volume becomes small and this acts as a main factor for the effect of preventing curling.

More specifically, the drying is preferably performed under the conditions of giving a residual solvent amount of 0.01 to 1.5 mass %, more preferably from 0.01 to 1.0 mass %, based on the cellulose acylate film.

[Moisture Permeability and Water Content of Film]

In the cellulose acylate film for use in the present invention, the moisture permeability (at a temperature of 25° C. and a humidity of 90% RH) according to the method prescribed in JIS Z0208 of the JIS Standard is preferably in the above-described range. With this range, the adhesion failure of antireflection layer is decreased and at the same time, when the film is integrated into a liquid crystal display device as an optical compensatory film or a protective film of the polarizing plate, change in the color tint or reduction of the viewing angle is not caused.

As for the method of measuring the moisture permeability, the method described in “Measurement of Amount of Water Vapor Permeated (weighing method, thermometer method, water vapor pressure method, adsorption amount method)” of Kobunshi Jikken Koza 4, Kobunshi no Bussei II (Polymer Experiment Lecture 4, Physical Properties II of Polymers), pp. 285-294, Kyoritsu Shuppan, can be applied.

The water content of the cellulose acylate film is, irrespective of the film thickness, preferably from 0.3 to 12 g/m² at 30° C. and 85% RH so as not to impair the adhesive property to a water-soluble polymer such as polyvinyl alcohol. The water content is more preferably from 0.5 to 5 g/m². If the water content exceeds 12 g/m², the dependency of retardation on the change of humidity disadvantageously becomes large.

At least one surface of the cellulose acylate film for use in the present invention may be surface-treated. Examples of the surface treatment include a vacuum glow discharge treatment, an atmospheric plasma discharge treatment, an ultraviolet irradiation treatment, a corona treatment, a flame treatment and an acid or alkali treatment.

<Coating Solution>

The coating solution coated on the cellulose acylate film in the present invention is described below.

In the present invention, a coating solution containing an organic solvent is directly coated on the cellulose acylate film. In the coating solution containing an organic solvent, components for forming a characteristic layer such as optical functional layer and physical functional layer are generally contained. The “directly coated on a support” as used herein means to coat the coating solution in the state that no layer is provided between the coating solution and the support surface, and the cellulose acylate film surface may be subjected to various surface treatments. However, a case of coating an organic solvent directly on the cellulose acylate film not subjected to a surface treatment is preferred.

In the coating solution for forming an optical or physical functional layer, the kind of the solvent is selected from the standpoint of solubility and stability of the components contained in the coating solution, dispersion stability of particle component, and the like. From these viewpoints, ketones, esters, hydrocarbons and halogenated hydrocarbons are suited. Also, in selecting the organic solvent used for the coating, it is necessary to consider the safety to human body and ecological system at the coating operation, the safety in terms of explosion prevention, the green house effect, the depletion of ozone layer, and the like. By taking account of these, ketones and esters are suitable as the solvent and most commonly used.

However, the solvent of ketones and esters has solubility and permeability for the cellulose acylate film of the present invention. Therefore, the coating sometimes encounters coating unevenness or drying unevenness as a result of, for example, change in the coatability or drying property due to dissolution or permeation, or change in the penetration degree due to drying conditions.

In order to control such solubility and permeability, a method of coating the coating solution after mixing a non-dissolving solvent in addition to the solvent of dissolving the cellulose acylate is disclosed in JP-A-2002-169001. In this method, change in the optical properties due to permeation of the component in the coating solution is suppressed and at the same time, the adhesive property is improved by the permeation.

The present inventors have studies to improve the coated surface state in the coating of an organic solvent on a cellulose acylate film and found that the surface plasticizer content in the cellulose acylate has great effect on the coating solution of the present invention. That is, it has been found that the permeability of the solvent species used into the cellulose acylate film working out to a substrate can be used as a guide for the control.

As for the solvent of ketones and esters used in the present invention, specific examples of the low boiling point solvent having a boiling point of 100° C. or less include ketones such as acetone (56.1° C.; hereinafter, “° C.” is omitted) and 2-butanone (=methyl ethyl ketone (MEK), 79.6); and esters such as ethyl formate (54.2), methyl acetate (57.8), ethyl acetate (77.1) and isopropyl acetate (89).

Specific examples of the high boiling point solvent having a boiling point of 100° C. or more include butyl acetate (126), isobutyl acetate (118), cyclohexanone (155.7), 2-methyl-4-pentanone (=methyl isobutyl ketone (IBK), 115.9), 2-octanone (173) and diacetone alcohol (168). Among these, acetone, methyl ethyl ketone, methyl acetate, ethyl acetate, cyclohexanone and methyl isobutyl ketone are preferred. However, the organic solvent for use in the present invention is not limited to those described above.

In addition to the ketone-based or ester-based solvent, a solvent having almost no permeability into the cellulose acylate film is also preferably mixed. As for such a solvent, a solvent having almost no permeability may be selected from the above-described ketones and esters or other than these, a solvent of various types such as alcohols, amides, ethers, ether esters, aliphatic hydrocarbons, aromatic hydrocarbons and halogenated hydrocarbons may be used. Also, a solvent except for the organic solvent, such as water and fluorine-based solvent, may be mixed. This solvent is appropriately selected by taking account of, for example, the solubility and reactivity of constituent components contained in the coating solution, the stability of particle or the like added, the drying property in the drying step, and the viscosity adjustment, and the mixing ratio and the like can also be selected from these viewpoints.

As for this solvent, in addition to the above-described ketones and esters, specific examples of the low boiling point solvent having a boiling point of 100° C. or less include hydrocarbons such as hexane (boiling point: 68.7), heptane (98.4), cyclohexane (80.7) and benzene (80.1); halogenated hydrocarbons such as dichloromethane (39.8), chloroform (61.2), carbon tetrachloride (76.8), 1,2-dichloroethane (83.5) and trichloroethylene (87.2); ethers such as diethyl ether (34.6), diisopropyl ether (68.5), dipropyl ether (90.5) and tetrahydrofuran (66); alcohols such as methanol (64.5), ethanol (78.3), 2-propanol (82.4), 1-propanol (97.2), 2-butanol (99.5) and tert-butanol (82.5); cyano compounds such as acetonitrile (81.6) and propionitrile (97.4); and carbon disulfide (46.2).

Specific examples of the solvent having a boiling point of 100° C. or more include octane (125.7), toluene (110.6), xylene (138), tetrachloroethylene (121.2), chlorobenzene (131.7), dioxane (101.3), dibutyl ether (142.4), 1-butanol (117.7), iso-butanol (107.9), propylene glycol monomethyl ether (120), N,N-dimethylformamide (153), N,N-dimethylacetamide (166) and dimethyl sulfoxide (189). However, the organic solvent for use in the present invention is not limited to those described above.

Appropriate solvent species and solvent composition of this solvent are preferably selected by using the permeability of the solvent into the cellulose acylate film as a guide. The permeability of various solvents can be judged, for example, by the curling when the coating solution containing the solvent is coated, or the permeation depth of the coated component, but as the method of quantitatively judging the permeability of the solvent into the film working out to the substrate, a method of mixing a dye or the like in the solvent, dipping the cellulose acylate film working out to the substrate in the solvent for a predetermined time, taking out the film from the solvent, drying it and observing the dye penetrated depth in the cross section of the film is known. For example, when a commercially available cellulose triacetate film TD-80U is dipped in the dye-containing solvent for 2 seconds and dried at 45° C. for 5 minutes, the permeability of various solvents is 0% for MIBK, 50% for MEK, 10% for cyclohexanone, 100% for acetone, 1% for ethyl acetate, 0% for toluene, 1% for methanol, or the like. The solvent which permeates into the cellulose acylate film is a solvent having a permeability of about 2% or more in the above-described method, and when the permeability is less than 2%, the solvent can be regarded as a non-permeating solvent. Specific examples of the solvent having permeability into the cellulose acylate film include, as ketones, acetone, MEK, cyclohexanone and diacetone alcohol; and as esters, methyl acetate. Specific examples of the non-permeating solvent include, as ketones, MIBK and 2-octanone; as esters, ethyl acetate; as other hydrocarbon-based solvents, hexane, cyclohexane, benzene, toluene and xylene; and as alcohols, methanol, ethanol, propanol and butanol. However, these permeating/non-permeating solvents each causes a difference depending on the composition of the cellulose acylate in the substrate, the plasticizer species and the like.

Out of these solvents, a non-permeating solvent is preferably mixed in addition to the solvent of ketones and esters of the present invention. Also, as for the ketones and esters for use in the present invention, a solvent having permeability is more preferred. Furthermore, both the permeating solvent and the non-permeating solvent are preferably selected from ketones and esters. From these viewpoints, a mixed solvent such as MEK/MIBK and MIBK/cyclohexanone is preferred. The mixing ratio of these solvents can be appropriately controlled by taking account of drying property, solubility of the coating solution components, permeability into the substrate, or the like.

In addition, several kinds of solvents differing in the properties may also be mixed and used for adjusting the drying property, viscosity, surface tension or the like of the solvent. Particularly, a high boiling point solvent is preferably mixed for imparting solubility or dispersion stability of the components contained in the coating solution, preventing the worsening of drying unevenness due to abrupt drying of the coating solution, or preventing increase in the water content of the coating solution.

The coat layer provided in the optical film of the present invention by coating the coating solution containing an organic solvent is described below. In the present invention, the coat layer has characteristics of an optical functional layer, a physical functional layer or the like. Examples of the optical functional layer include an antiglare layer, a light-diffusing layer, a low refractive index layer, a high refractive index layer and an optical compensatory layer. Examples of the physical functional layer include a hard coat layer. Of course, the layer sometimes serves as an optical functional layer and a physical functional layer and, for example, an antiglare hard coat layer comes under this type.

In the present invention, the layer directly coated on the cellulose acylate is preferably an antiglare (hard coat) layer, a light-diffusing (hard coat) layer, a hard coat layer or the like.

As one embodiment of the present invention, a fundamental structure of an antireflection film which is one suitable embodiment of the optical functional film of the present invention, is described by referring to the drawings.

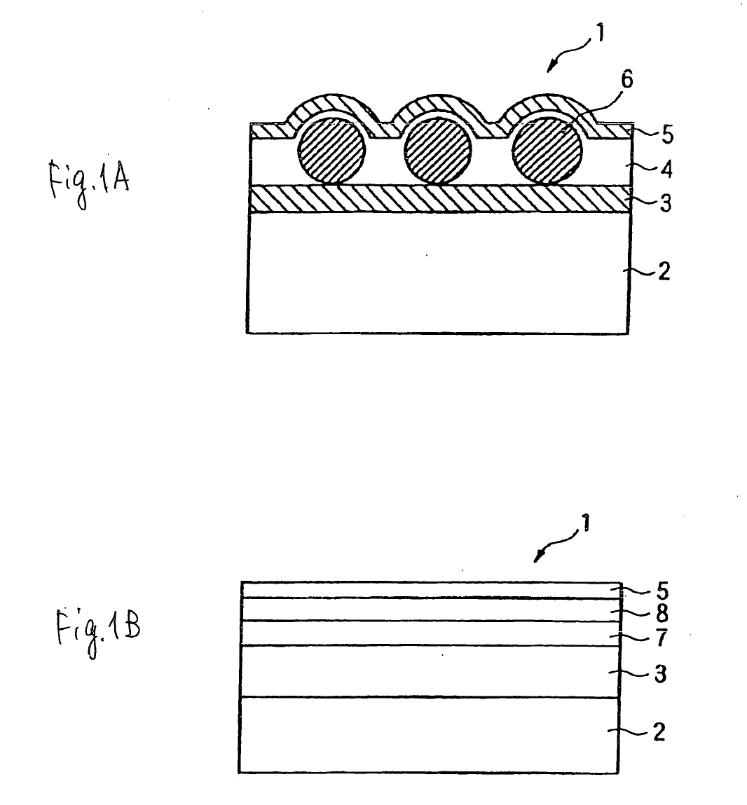

FIG. 1A is a cross-sectional view schematically showing one example of the antireflection film of the present invention. The antireflection film 1 has a layer structure comprising a transparent support 2 and three kinds of functional layers (hard coat layer 3, antiglare hard coat layer 4, low refractive index layer 5) in this order. In the antiglare hard coat layer 4, matting particles 6 are dispersed. The material in the portion except for the matting particles 6 in the antiglare hard coat layer 4 preferably has a refractive index of 1.50 to 2.00. The low refractive index layer 5 preferably has a refractive index of 1.35 to 1.49. In the present invention, the functional layer may be a hard coat layer having such an antiglare property, may be a hard coat layer not having an antiglare property or may be a light-diffusing layer. The functional layer may comprise one layer or a plurality of layers, for example, from two to four layers. The low refractive index layer which is a functional layer is provided as the outermost layer.

Furthermore, in view of reducing the reflectance, the low refractive index layer preferably satisfies the following mathematical formula (VII):
(m/4)×0.7<n₁d₁<(m/4)×1.3 Mathematical formula (VII)
wherein m is a positive odd number, n, is a refractive index of the low refractive index layer, d₁ is a film thickness (nm) of the low refractive index layer, and λ is a wavelength and a value in the range of 500 to 550 nm.

When mathematical formula (VII) is satisfied, this means that m (a positive odd number; usually 1) satisfying mathematical formula (VII) is present in the above-described wavelength range.

FIG. 1B is a cross-sectional view schematically showing one example of the antireflection film of the present invention. The antireflection film 1 has a layer structure comprising a transparent support 2, respective functional layers (hard coat layer 3, medium refractive index layer 7, high refractive index layer 8) and a low refractive index layer (outermost layer) 5 in this order. The transparent support 2, the medium refractive index layer 7, the high refractive index layer 8 and the low refractive index layer 6 each has a refractive index satisfying the following relationship:

refractive index of high refractive index layer>refractive index of medium refractive index layer>refractive index of transparent support>refractive index of low refractive index layer.

In the layer structure shown in FIG. 1B, as described in JP-A-59-50401, the medium refractive index layer, the high refractive index layer and the low refractive index layer preferably satisfy the following mathematical formulae (I), (I) and (III), respectively, because an antireflection film having more excellent antireflection performance can be produced.

Mathematical Formula (I):
(hλ/4)×0.7<n₁d₁<(hλ/4)×1.3
wherein h is a positive integer (generally 1, 2 or 3), n₁ is a refractive index of the medium refractive index layer, d₁ is a film thickness (nm) of the medium refractive index layer, and λ is a wavelength (nm) of visible light and a value in the range of 380 to 680 nm.
(iλ/4)×0.7<n₂d₂<(iλ/4)×1.3 Mathematical Formula (II)
wherein i is a positive integer (generally 1, 2 or 3), n₂ is a refractive index of the high refractive index layer, d₂ is a film thickness (nm) of the high refractive index layer, and λ is a wavelength (nm) of visible light and a value in the range of 380 to 680 nm.
(jλ/4)×0.7<n₃d₃(jλ/4)×1.3 Mathematical Formula (III)
wherein j is a positive odd number (generally 1), n₃ is a refractive index of the low refractive index layer, d₃ is a film thickness (nm) of the low refractive index layer, and λ is a wavelength (nm) of visible light and a value in the range of 380 to 680 nm.

In the layer structure shown in FIG. 1B, the medium refractive index layer, the high refractive index layer and the low refractive index layer more preferably satisfy the following mathematical formulae (IV), (V) and (VI). In formulae, λ is 500 nm, h is 1, i is 2 and j is 1.
(hλ/4)×0.80<n₁d₁<(hλ/4)×1.00 Mathematical Formula (IV)
(iλ/4)×0.75<n₂d₂<(iλ/4)×0.95 Mathematical Formula (V)
(jλ/4)×0.95<n₃d₃<(jλ/4)×1.05 Mathematical Formula (VI)

Incidentally, the high refractive index, the medium refractive index and the low refractive index each indicates a relative level of refractive index among layers. Also, in FIG. 1B, the high refractive index layer is used as a light interference layer and therefore, an anti-reflection film having very excellent antireflection performance can be produced.

Respective functional layers for use in the present invention are described below.

[Antiglare Hard Coat Layer]

The antiglare hard coat layer for use in the present invention is described below.

The antiglare hard coat layer comprises, as main components, a binder for imparting a hard coat property, a matting particle for imparting an antiglare property, and an inorganic filler for elevating the refractive index, preventing the crosslinking shrinkage and increasing the strength.

The binder is preferably a polymer having a saturated hydrocarbon chain or a polyether chain as the main chain, more preferably a polymer having a saturated hydrocarbon chain as the main chain. Also, the binder polymer preferably has a crosslinked structure.

The binder polymer having a saturated hydrocarbon chain as the main chain is preferably a polymer of an ethylenically unsaturated monomer (binder precursor). The binder polymer having a saturated hydrocarbon chain as the main chain and having a crosslinked structure is preferably a (co)polymer of a monomer having two or more ethylenically unsaturated groups.

In order to elevate the refractive index, the monomer preferably contains in the structure thereof an aromatic ring or at least one atom selected from the group consisting of a halogen atom (excluding fluorine), a sulfur atom, a phosphorus atom and a nitrogen atom.

Examples of the binder include a polyfunctional monomer or oligomer having a radical polymerizable or cation polymerizable group.

Examples of the radical polymerizable functional group include an ethylenically unsaturated group such as (meth)acryloyl group, vinyloxy group, styryl group and allyl group. Among these, a (meth)acryloyl group is preferred. A polyfunctional monomer containing two or more radical polymerizable groups within the molecule is preferably contained.

The radical polymerizable polyfunctional monomer is preferably selected from the compounds having at least two terminal ethylenically unsaturated bonds. A compound having from 2 to 6 terminal ethylenically unsaturated bonds within the molecule is preferred. Such a compound group is widely known in the polymer material field and these can be used without any particular limitation in the present invention. This compound may have a chemical mode such as monomer, prepolymer (namely, dimer, trimer or oligomer), or a mixture or a copolymer thereof.

The binder component is preferably a resin having an acrylate-based functional group and examples thereof include relatively low molecular weight polyester resin, polyether resin, acrylic resin, epoxy resin, urethane resin, alkyd resin, spiroacetal resin, polybutadiene resin and polythiolpolyene resin, and an oligomer or prepolymer of (meth)acrylate (hereinafter, acrylate and methacrylate are collectively referred to as (meth)acrylate) of a polyfunctional compound (e.g., polyhydric alcohol). Specific examples of the polyfunctional monomer include trimethylolpropane tri(meth)acrylate, EO-modified trimethylolpropane tri(meth)acrylate, di-trimethylolpropane tetra(meth)acrylate, hexanediol (meth)acrylate, tripropylene glycol di(meth)acrylate, diethylene glycol di(meth)acrylate, pentaerythritol tri(meth)acrylate, pentaerythritol tetra(meth)acrylate, dipentaerythritol hexa(meth)acrylate, a mixture of dipentaerythritol hexa(meth)acrylate and dipentaerythritol penta(meth)acrylate, 1,6-hexanediol di(meth)acrylate, and neopentyl glycol di(meth)acrylate. Also, this polyfunctional monomer is preferably mixed with a monofunctional monomer such as ethyl (meth)acrylate, ethylhexyl (meth)acrylate, styrene, vinyltoluene and N-vinylpyrrolidone.

Other than these, examples of the polymerizable ester compound (monoester or polyester) of an aliphatic polyhydric compound and an unsaturated carboxylic acid include the compounds described in JP-A-2001-139663 (paragraphs [0026] to [0027]). In addition, for example, a vinyl methacrylate, an allyl methacrylate, an allyl acrylate, aliphatic alcohol-based esters described in JP-B-46-27926, JP-B-51-47334 and JP-A-57-196231, those having an aromatic skeleton described in JP-A-2-226149, and those having an amino group described in JP-A-1-165613 are suitably used. Furthermore, a vinylurethane compound having two or more polymerizable vinyl groups within one molecule (described, for example, in JP-B-48-41708), urethane acrylates (described, for example, in JP-B-2-16765), a urethane compound having an ethylene oxide-based skeleton (described, for example, in JP-B-62-39418), polyester acrylates (described, for example, in JP-B-52-30490), and photo-curable monomers and oligomers described in Adhesion, Vol. 20 (7), pp. 300-308 (1984) can also be used.

As for such a binder, those generally available on the market from Nippon Kayaku Co., Ltd., Osaka Organic Chemical Industry Ltd., Dai-Nippon Ink & Chemicals, Inc., Toagosei Co., Ltd., Mitsubishi Chemical Corporation or the like can be used.

Two or more of these active radiation-durable resins may be used in combination. Among those described above, more preferred are pentaerythritol tri(meth)acrylate, pentaerythritol tetra(meth)acrylate, dipentaerythritol hexa(meth)acrylate, a mixture of dipentaerythritol hexa(meth)acrylate and dipentaerythritol penta(meth)acrylate, trimethylolpropane tri(meth)acrylate, EO-modified trimethylolpropane tri(meth)acrylate and di-trimethylolpropane tetra(meth)acrylate.

Specific examples of the high refractive index monomer include bis(4-methacryloylthiophenyl)sulfide, vinylnaphthalene, vinylphenylsulfide and 4-methacryloxyphenyl-4′-methoxyphenylthioether. These monomers may also be used in combination of two or more thereof.

The polymerization of such a monomer having an ethylenically unsaturated group may be performed under irradiation of ionizing radiation or under heat in the presence of a photo-radical initiator or a heat-radical initiator.

Accordingly, the antireflection film can be formed by preparing a coating solution containing a monomer having an ethylenically unsaturated group, a photo- or heat-radical initiator, a matting particle and an inorganic filler, applying the coating solution to a transparent support, and curing the coating solution through a polymerization reaction under ionizing radiation or heat.

Examples of the photo-radical polymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds and aromatic sulfoniums. Examples of the acetophenones include 2,2-ethoxyacetophenone, p-methylacetophenone, 1-hydroxydimethyl phenyl ketone, 1-hydroxycyclohexyl phenyl ketone, 2-methyl-4-methylthio-2-morpholinopropiophenone and 2-benzyl-2-dimethylamino-1-(4-morpholinophenyl)-butanone. Examples of the benzoins include benzoin benzenesulfonic acid ester, benzoin toluenesulfonic acid ester, benzoin methyl ether, benzoin ethyl ether and benzoin isopropyl ether. Examples of the benzophenones include benzophenone, 2,4-chlorobenzophenone, 4,4-dichlorobenzophenone and p-chlorobenzophenone. Examples of the phosphine oxides include 2,4,6-trimethylbenzoyldiphenylphosphine oxide.

Also, various examples are described in Saishin UV Koka Gijutsu (Latest UV Curing Technology), page 159, Kazuhiro Takausu (publisher), Gijutsu Joho Kyokai (publishing company) (1991) and these are useful in the present invention.

Preferred examples of the commercially available photocleavable photo-radical polymerization initiator include Irgacure (651, 184 and 907) produced by Nippon Ciba Geigy.

The photopolymerization initiator is preferably used in an amount of 0.1 to 15 parts by mass, more preferably from 1 to 10 parts by mass, per 100 parts by mass of the polyfunctional monomer.

In addition to the photopolymerization initiator, a photosensitizer may be used. Specific examples of the photosensitizer include n-butylamine, triethylamine, tri-n-butylphosphine, Michler's ketone and thioxanthone.

Examples of the heat-radical initiator which can be used include an organic or inorganic peroxide and an organic azo or diazo compound.

Specific examples of the organic peroxide include benzoyl peroxide, halogen benzoyl peroxide, lauroyl peroxide, acetyl peroxide, dibutyl peroxide, cumene hydroperoxide and butyl hydroperoxide. Specific examples of the inorganic peroxide include hydrogen peroxide, ammonium persulfate and potassium persulfate. Specific examples of the azo compound include 2-azo-bis-isobutyronitrile, 2-azo-bis-propionitrile and 2-azo-bis-cyclohexanedinitrile. Specific examples of the diazo compound include diazoaminobenzene and p-nitrobenzenediazonium.

The polymer having a polyether as the main chain is preferably a ring-opening polymer of a polyfunctional epoxy compound. The ring-opening polymerization of a polyfunctional epoxy compound can be performed under irradiation of ionizing radiation or under heat in the presence of a photoacid generator or a heat-acid generator.

Accordingly, the antireflection film can be formed by preparing a coating solution containing a polyfunctional epoxy compound, a photoacid or heat-acid generator, a matting particle and an inorganic filler, applying the coating solution to a transparent support and curing the coating solution through a polymerization reaction under ionizing radiation or heat.

In place of or in addition to the monomer having two or more ethylenically unsaturated groups, a monomer having a crosslinking functional group may be used to introduce a crosslinking functional group into the polymer, so that a crosslinked structure can be introduced into the binder polymer by the reaction of this crosslinking functional group.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. Also, a vinylsulfonic acid, an acid anhydride, a cyanoacrylate derivative, a melamine, an etherified methylol, an ester, a urethane or a metal alkoxide such as tetramethoxysilane can be used as a monomer for introducing a crosslinked structure.

A functional group which exhibits crosslinking property as a result of the decomposition reaction, such as block isocyanate group, may also be used. In other words, the crosslinking functional group for use in the present invention may be a group which does not directly cause a reaction but exhibits reactivity as a result of the decomposition.

The binder polymer having this crosslinking functional group is coated and then heated, whereby a crosslinked structure can be formed.

The binder in the antiglare hard coat layer is added in an amount of 20 to 95 mass % based on the solid content in the coating composition for the layer.

For the purpose of imparting an antiglare property, the antiglare hard coat layer contains a matting agent larger than the filler particle and having an average particle diameter of 1 to 10 μm, preferably from 1.5 to 7.0 μm, for example, an inorganic compound particle or a resin particle.

Specific preferred examples of the matting particle include an inorganic compound particle such as silica particle and TiO₂ particle; and a resin particle such as acryl particle, crosslinked acryl particle, polystyrene particle, crosslinked styrene particle, melamine resin particle and benzoguanamine resin particle. Among these, crosslinked styrene particle, crosslinked acryl particle and silica particle are more preferred.

The shape of the matting particle may be either true spherical or amorphous.

Also, two or more kinds of matting particles differing in the particle diameter may be used in combination. The matting agent having a larger particle diameter can impart an antiglare property and the matting particle having a smaller particle diameter can impart a different optical property. For example, when an antireflection film is attached to a high-definition display of 133 dpi or more, it is required to cause no trouble called glare in the optical performance. The glare is attributable to a phenomenon that the picture element is enlarged or reduced due to irregularities (contributing to the antiglare property) present on the film surface and the uniformity of brightness is lost. This glare can be greatly improved by using in combination a matting particle having a particle diameter smaller than that of the matting particle for imparting an antiglare property and having a refractive index different from that of the binder.

The particle diameter distribution of this matting particle is most preferably monodisperse. Individual particles preferably have the same particle diameter as much as possible. For example, when a particle having a particle diameter 20% or more larger than the average particle diameter is defined as a coarse particle, the percentage of the coarse particle occupying in the total number of particles is preferably 1% or less, more preferably 0.1% or less, still more preferably 0.01% or less. The matting particle having such a particle diameter distribution is obtained by performing the classification after the normal synthesis reaction. By increasing the number of classification operations or intensifying the classification degree, a matting agent having a more preferred distribution can be obtained.

This matting particle is preferably contained in the antiglare hard coat layer such that the amount of the matting particle in the formed antiglare hard coat layer is from 10 to 2,000 mg/m², more preferably from 100 to 1,400 mg/m².

The particle size distribution of the matting particle is measured by a Coulter counter method and the measured distribution is converted into the particle number distribution.

In addition to the above-described matting particle, the antiglare hard coat layer preferably contains an inorganic filler comprising an oxide of at least one metal selected from the group consisting of titanium, zirconium, aluminum, indium, zinc, tin and antimony and having an average particle diameter of 0.2 μm or less, preferably 0.1 μm or less, more preferably 0.06 μm or less, so as to elevate the refractive index of the layer.

Conversely, for increasing the difference in the refractive index from the matting particle, it is also preferred to use an oxide of silicon in the antiglare hard coat layer using a high refractive index matting particle and thereby keep a lower refractive index of the layer. The preferred particle diameter is same as that of the inorganic filler.

Specific examples of the inorganic filler for use in the antiglare hard coat layer include TiO₂, ZrO₂, Al₂O₃, In₂O₃, ZnO, SnO₂, Sb₂O₃, ITO and SiO₂. Among these, TiO₂ and ZrO₂ are preferred from the standpoint of elevating the refractive index. The surface of the inorganic filler may be preferably subjected to a silane coupling treatment or a titanium coupling treatment. A surface treating agent having a functional group capable of reacting with the binder species is preferably used on the filler surface.

The amount of the inorganic filler added is preferably from 10 to 90%, more preferably from 20 to 80%, still more preferably from 30 to 75%, based on the entire mass of the antiglare hard coat layer.

This filler has a particle diameter sufficiently smaller than the wavelength of light and therefore, causes no scattering and the dispersion obtained by dispersing the filler in the binder polymer behaves as an optically uniform substance.

The bulk refractive index of the binder and inorganic filler mixture in the antiglare hard coat layer of the present invention is preferably from 1.48 to 2.00, more preferably from 1.50 to 1.80. The refractive index in this range can be attained by appropriately selecting the kind and amount ratio of binder and inorganic filler. The kind and amount ratio to be selected can be easily known in advance by an experiment.

The antiglare hard coat layer of the present invention may preferably contain an organic silicon compound (generally known as a silane coupling) represented by the following formula 1 or a hydrolysate or partial condensate thereof. Incidentally, as is well known, the organic silicon compound represented by formula 1 is readily hydrolyzed and subsequently causes a dehydration condensation reaction.
RₘSi(X)ₙ Formula 1
(wherein X represents —OH, a halogen atom, an —OR¹ group or an OCOR¹ group, R represents a substituted or unsubstituted alkyl or aryl group having a carbon number of 1 to 30, R¹ represents a substituted or unsubstituted alkyl group having a carbon number of 1 to 10, m+n is 4, m and n each represents an integer of 0 or more, and m is preferably 0, 1 or 2, more preferably 1).

In formula 1, R represents a substituted or unsubstituted alkyl group or a substituted or unsubstituted aryl group. The alkyl group is preferably an alkyl group having a carbon number of 1 to 30, more preferably from 1 to 16, still more preferably 1 to 6, and examples thereof include methyl, ethyl, propyl, isopropyl, hexyl, decyl and hexadecyl. Examples of the aryl group include phenyl and naphthyl, with a phenyl group being preferred.

The substituent contained in R is not particularly limited but examples thereof include a halogen (e.g., fluorine, chlorine, bromine), a hydroxyl group, a mercapto group, a carboxyl group, an epoxy group, an alkyl group (e.g., methyl, ethyl, i-propyl, propyl, tert-butyl), an aryl group (e.g., phenyl, naphthyl), an aromatic heterocyclic group (e.g., furyl, pyrazolyl, pyridyl), an acyloxy group (e.g., acetoxy, acryloyloxy, methacryloyloxy), an alkoxycarbonyl group (e.g., methoxycarbonyl, ethoxycarbonyl), an aryloxycarbonyl group (e.g., phenoxycarbonyl), a carbamoyl group (e.g., carbamoyl, N-methylcarbamoyl, N,N-dimethylcarbamoyl, N-methyl-N-octylcarbamoyl) and an acylamino group (e.g., acetylamino, benzoylamino, acrylamino, methacrylamino). These substituents each may be further substituted. When a plurality of Rs are present, at least one R is preferably a substituted alkyl group or a substituted aryl group.

X represents a hydroxyl group or a hydrolyzable group. Examples of the hydrolyzable group include an alkoxy group (preferably an alkoxy group having a carbon number of 1 to 5, such as methoxy group and ethoxy group), a halogen atom (e.g., Cl, Br, I) and a group represented by R²COO (wherein R² is preferably a hydrogen atom or an alkyl group having a carbon number of 1 to 5, such as CH₃COO and C₂H₅COO). Among these, an alkoxy group is preferred, and a methoxy group and an ethoxy group are more preferred.

When a plurality of Rs or Xs are present, these Rs or Xs may be the same or different.

Out of the organosilane compounds represented by formula 1, an organosilane compound having a vinyl polymerizable substituent such as methacryloyloxy group or acryloyloxy group is preferred. Specific examples thereof include those described in JP-A-2004-42278 (paragraphs [0026] to [0028]).

The hydrolysate and/or partial condensate of the organosilane compound may be produced due to hydration or progress of a reaction in the coating solution or may be produced by previously treating the organosilane compound in the presence of a catalyst. Examples of the catalyst for use in the hydrolysis or condensation include acids, bases and organic metal compounds.

Incidentally, it is particularly preferred that the antiglare hard coat layer of the present invention contains an active radiation resin, an organic silicon compound and/or a hydrolysate or partial condensate thereof.

In the coating solution of the present invention, either one of a fluorine-containing compound and a silicone-containing compound each having surface activity or both thereof is (are) preferably added to the coating composition so as to improve coatability, achieve uniform drying and impart suitability for high-speed coating. These surface active components are sometimes added also for imparting surface wettability, antifouling property or dust protection or adjusting the electrostatic property.

Preferred examples of the silicone-based compound include those containing a plurality of dimethylsilyloxy units as the repeating unit and having a substituent at the terminal of compound chain and/or on the side chain. The compound chain containing dimethylsilyloxy as the repeating unit may contain a structure unit other than dimethylsilyloxy. A plurality of substituents, which may be the same or different, are preferably present. Preferred examples of the substituent include a group containing an acryloyl group, a methacryloyl group, a vinyl group, an aryl group, a cinnamoyl group, an epoxy group, an oxetanyl group, a hydroxyl group, a fluoroalkyl group, a polyoxyalkylene group, a carboxyl group or an amino group.

The molecular weight of the silicone-based compound is not particularly limited but is preferably 100,000 or less, more preferably 50,000 or less, and most preferably from 3,000 to 30,000. The silicon atom content in the silicone compound is also not particularly limited and is preferably 18.0 mass % or more, more preferably from 25.0 to 37.8 mass %, and most preferably from 30.0 to 37.0 mass %.

Preferred examples of the silicone-based compound include, but are not limited to, those described in JP-A-2004-42278 (paragraph [0068]).

A compound containing a fluoroalkyl group is also a preferred additive. The fluoroalkyl group preferably has a carbon number of 1 to 20, more preferably from 1 to 10, and may be linear [e.g., —CF₂CF₃, —CH₂(CF₂)₄H, —CH₂(CF₂)₈CF₃, —CH₂CH₂(CF₂)₄—H], may have a branched structure [e.g., —CH(CF₃)₂, —CH₂CF(CF₃)₂, —CH(CH₃)CF₂CF₃, —CH(CH₃)(CF₂)₅CF₂H] or an alicyclic structure (preferably a 5- or 6-membered ring, for example, a perfluorocyclohexyl group, a perfluorocyclopentyl group or an alkyl group substituted with such a group), or may have an ether bond (e.g., —CH₂OCH₂CF₂CF₃, —CH₂CH₂OCH₂C₄F₈H, —CH₂CH₂OCH₂CH₂C₈F₁₇, —CH₂CH₂OCF₂CF₂OCF₂CF₂H). A plurality of the fluoroalkyl groups may be contained in the same molecule.

The fluorine-based compound may be a polymer or oligomer with a compound not containing a fluorine atom, and this compound is used without any particular limitation in the molecular weight. The fluorine atom content of the fluorine-based compound is not particularly limited but is preferably 20 mass % or more, more preferably from 30 to 70 mass %, and most preferably from 40 to 70 mass %. Preferred examples of the fluorine-based compound include, but are not limited to, “R-2020”, “M-2020”, “R-3833” and “M-3833” [trade names, all produced by Daikin Industries, Ltd.], and Megafac F-171, F-172 and F-179A and DYFENSA MCF-300 [trade names, all produced by Dai-Nippon Ink & Chemicals, Inc.].

Out of these additives, a fluoroalkyl group-containing copolymer is preferably contained in the coating composition. The fluoroalkyl group-containing copolymer is preferred because an effect of improving the surface state failure of the optical film, such as coating unevenness, drying unevenness and point defect, is exerted with a smaller amount added.

In the case where a film of low refractive index layer is further formed on the coat layer, the additive preferably has a substituent which contributes to the bond formation or compatibility. A plurality of substituents, which may be the same or different, are preferably present. Preferred examples of the substituent include an acryloyl group, a methacryloyl group, a vinyl group, an aryl group, a cinnamoyl group, an epoxy group, an oxetanyl group, a hydroxyl group, a polyoxyalkylene group, a carboxyl group and an amino group.

Furthermore, a fluoroalkyl group-containing copolymer having a structure described below may also be preferably selected so that the copolymer unevenly distributed on the functional layer surface can be extracted in the solvent of the upper layer (for example, a low refractive index layer) at the time of coating the upper layer and prevented from being present on the functional layer surface (interface with the functional layer) when the antireflection film of the present invention is formed.

Control of the amount added of the fluoroaliphatic group-containing copolymer is also effective in enhancing the above-described effect.

This is specifically a method where a fluoroaliphatic group-containing copolymer containing 10 mass % or more of a fluoroaliphatic group-containing monomer as the polymerization unit is added to the coating solution and in order to cause segregation (same as uneven distribution) of the fluoroaliphatic group-containing copolymer and attain adhesion to the upper layer, the solvent of the coating solution for forming the upper layer on the functional layer containing the fluoroaliphatic group-containing copolymer is coated and dried to give a change of 1 mN/m or more, preferably 3 mN/m or more, in the surface free energy of the functional layer.

The fluoroalkyl group-containing copolymer (sometimes simply referred to as a “fluorine-based polymer”) is preferably a copolymer containing a fluoroalkyl group in which a perfluoroalkyl group having a carbon number of 4 or more or a CF₂H— group having a carbon number of 4 or more is present on the side chain.

In particular, an acryl or methacryl resin containing a repeating unit (polymerization unit) corresponding to the monomer of (i) below and a repeating unit (polymerization unit) corresponding to the monomer of (ii) below, or a copolymer with a vinyl-based monomer copolymerizable therewith is useful. As for such a monomer, those described in J. Brandrup, Polymer Handbook, 2nd ed., Chapter 2, pp. 1-483, Wiley Interscience (1975) can be used.

Examples thereof include a compound having one addition-polymerizable unsaturated bond selected from an acrylic acid, a methacrylic acid, acrylic acid esters, methacrylic acid esters, acrylamides, methacrylamides, an allyl compound, vinyl ethers and vinyl esters.

This compound includes the following compounds.
(i) Fluoroaliphatic Group-Containing Monomer Represented by the Following Formula 2:

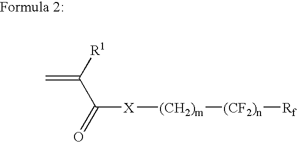

In formula 2, R¹ represents a hydrogen atom, a halogen atom or a methyl group, preferably a hydrogen atom or a methyl group. X represents an oxygen atom, a sulfur atom or —N(R₁₂)—, preferably an oxygen atom or —N(R¹²)—, more preferably an oxygen atom. R¹² represents a hydrogen atom or an alkyl group having a carbon number of 1 to 8, which may have a substituent, and preferably represents a hydrogen atom or an alkyl group having a carbon number of 1 to 4, more preferably a hydrogen atom or a methyl group. R_{f} represents —CF₃ or —CF₂H.

In formula 2, m represents an integer of 1 to 6, preferably 1 to 3, more preferably 1.

In formula 2, n represents an integer of 1 to 17, preferably 4 to 11, more preferably 6 to 7. R_{f} is preferably —CF₂H.

In the fluorine-based polymer, two or more kinds of polymerization units derived from the fluoroalkyl group-containing monomer represented by formula 2 may be contained as the constituent component.
(ii) Monomer Represented by the Following Formula 3, Which is Copolymerizable with Monomer of (i)

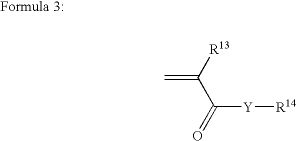

In formula 3, R¹³ represents a hydrogen atom, a halogen atom or a methyl group, preferably a hydrogen atom or a methyl group. Y represents an oxygen atom, a sulfur atom or —N(R¹⁵)—, preferably an oxygen atom or —N(R¹⁵)—, more preferably an oxygen atom. R¹⁵ represents a hydrogen atom or an alkyl group having a carbon number of 1 to 8, preferably a hydrogen atom or an alkyl group having a carbon number of 1 to 4, more preferably a hydrogen atom or a methyl group.

R¹⁴ represents a linear, branched or cyclic alkyl group having a carbon number of 1 to 60, which may have a substituent, or an aromatic group (e.g., phenyl naphthyl) which may have a substituent. The alkyl may contain a poly(alkyleneoxy) group. R¹⁴ is preferably a linear, branched or cyclic alkyl group having a carbon number of 1 to 12, a poly(alkyleneoxy) group-containing alkyl group having a carbon number of 5 to 40, or an aromatic group having a total carbon number of 6 to 18, more preferably a linear, branched or cyclic alkyl group having a carbon number of 1 to 8, or a poly(alkyleneoxy) group-containing alkyl group having a carbon number of 5 to 30. The poly(alkyleneoxy) group is described below.

The poly(alkyleneoxy) group can be represented by (OR)ₓ, wherein R is preferably an alkylene group having from 2 to 4 carbon atoms, such as —CH₂CH₂—, —CH₂CH₂CH₂—, —CH(CH₃)CH₂— or —CH(CH₃)CH(CH₃)—, and x represents a number of 2 to 30, preferably 2 to 20, more preferably 4 to 15.

The oxyalkylene unit in the poly(oxyalkylene) group may be the same as in poly(oxypropylene), or two or more kinds of oxyalkylenes differing from each other may be irregularly distributed. Also, the oxyalkylene unit may be a linear or branched oxypropylene or oxyethylene unit or may be present as a block of linear or branched oxypropylene unit or a block of oxyethylene unit.

The poly(oxyalkylene) chain may contain a chain linked through one or more linking bonds (e.g., —CONH-Ph-NHCO—, —S—; Ph represents a phenylene group). In the case where the linking bond has three or more atomic valences, these provides means for obtaining a branched oxyalkylene unit. When this copolymer is used in the present invention, the poly(oxyalkylene) group suitably has a molecular weight of 250 to 3,000. The poly(oxyalkylene) acrylate or methacrylate can be produced by reacting a commercially available hydroxypoly(oxyalkylene) material, for example, a material available on the market under the trade name of “Pluronic” (produced by Asahi Denka Kogyo K.K.), “Adeka Polyether” (produced by Asahi Denka Kogyo K.K.), “Carbowax” (produced by Glico Products), “Toriton” (produced by Rohm and Haas) or PEG (produced by Dai-ichi Kogyo Seiyaku Co., Ltd.), with an acrylic acid, a methacrylic acid, an acryl chloride, a methacryl chloride, an acrylic anhydride or the like according to a known method. A poly(oxyalkylene) diacrylate or the like produced by a different known method may also be used.

The amount of the fluoroaliphatic group-containing monomer represented by formula 2, which is used for the production of the fluorine-based polymer for use in the present invention, is 10 mass % or more, preferably 50 mass % or more, more preferably from 70 to 100 mass %, still more preferably from 80 to 100 mass %, based on the entire amount of monomers of the fluorine-based polymer.

The mass average molecular weight of the fluorine-based polymer for use in the present invention is preferably from 3,000 to 100,000, more preferably from 6,000 to 80,000, still more preferably from 8,000 to 60,000.

Here, the mass average molecular weight and the molecular weight each is a molecular weight determined by differential refractometer detection with a solvent THF in a GPC analyzer using a column, TSKgel GMHXL, TSKgel G4000HXL or TSKgel G2000HXL (trade names, all produced by Tosoh Corp.), and expressed in terms of polystyrene. The molecular weight is calculated from the peak areas of components having a molecular weight of 300 or more.

From the standpoint of exerting the effect by the addition or preventing generation of the drying or surface state failure, the fluorine-based polymer for use in the present invention is preferably added in an amount of 0.001 to 5 mass %, more preferably from 0.005 to 3 mass %, still more preferably from 0.01 to 1 mass %, based on the mass of the coating solution.

Specific structure examples of the fluorine-based polymer for use in the present invention are set forth below, but the present invention is not limited thereto. The numerals in each formula represent a molar ratio of respective monomer components. Mw represents a mass average molecular weight.

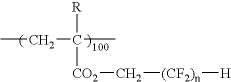

| | R | n | Mw |
|---|---|---|---|
| FP-1 | H | 4 | 8000 |
| FP-2 | H | 4 | 16000 |
| FP-3 | H | 4 | 33000 |
| FP-4 | CH₃ | 4 | 12000 |
| FP-5 | CH₃ | 4 | 28000 |
| FP-6 | H | 6 | 8000 |
| FP-7 | H | 6 | 14000 |
| FP-8 | H | 6 | 29000 |
| FP-9 | CH₃ | 6 | 10000 |
| FP-10 | CH₃ | 6 | 21000 |
| FP-11 | H | 8 | 4000 |
| FP-12 | H | 8 | 16000 |
| FP-13 | H | 8 | 31000 |
| FP-14 | CH₃ | 8 | 3000 |
| FP-15 | CH₃ | 8 | 10000 |
| FP-16 | CH₃ | 8 | 27000 |
| FP-17 | H | 10 | 5000 |
| FP-18 | H | 10 | 11000 |
| FP-19 | CH₃ | 10 | 4500 |
| FP-20 | CH₃ | 10 | 12000 |
| FP-21 | H | 12 | 5000 |
| FP-22 | H | 12 | 10000 |
| FP-23 | CH₃ | 12 | 5500 |
| FP-24 | CH₃ | 12 | 12000 |

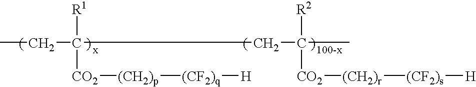

| | x | R¹ | p | q | R² | r | S | Mw |
|---|---|---|---|---|---|---|---|---|
| FP-25 | 50 | H | 1 | 4 | CH₃ | 1 | 4 | 10000 |
| FP-26 | 40 | H | 1 | 4 | H | 1 | 6 | 14000 |
| FP-27 | 60 | H | 1 | 4 | CH₃ | 1 | 6 | 21000 |
| FP-28 | 10 | H | 1 | 4 | H | 1 | 8 | 11000 |
| FP-29 | 40 | H | 1 | 4 | H | 1 | 8 | 16000 |
| FP-30 | 20 | H | 1 | 4 | CH₃ | 1 | 8 | 8000 |
| FP-31 | 10 | CH₃ | 1 | 4 | CH₃ | 1 | 8 | 7000 |
| FP-32 | 50 | H | 1 | 6 | CH₃ | 1 | 6 | 12000 |
| FP-33 | 50 | H | 1 | 6 | CH₃ | 1 | 6 | 22000 |
| FP-34 | 30 | H | 1 | 6 | CH₃ | 1 | 6 | 5000 |
| FP-35 | 40 | CH₃ | 1 | 6 | H | 3 | 6 | 3000 |
| FP-36 | 10 | H | 1 | 6 | H | 1 | 8 | 7000 |
| FP-37 | 30 | H | 1 | 6 | H | 1 | 8 | 17000 |
| FP-38 | 50 | H | 1 | 6 | H | 1 | 8 | 16000 |
| FP-39 | 50 | CH₃ | 1 | 6 | H | 3 | 8 | 19000 |
| FP-40 | 50 | H | 1 | 8 | CH₃ | 1 | 8 | 5000 |
| FP-41 | 80 | H | 1 | 8 | CH₃ | 1 | 8 | 10000 |
| FP-42 | 50 | CH₃ | 1 | 8 | H | 3 | 8 | 14000 |
| FP-43 | 90 | H | 1 | 8 | CH₃ | 3 | 8 | 9000 |
| FP-44 | 70 | H | 1 | 8 | H | 1 | 10 | 7000 |
| FP-45 | 90 | H | 1 | 8 | H | 3 | 10 | 12000 |
| FP-46 | 50 | H | 1 | 8 | H | 1 | 12 | 10000 |
| FP-47 | 70 | H | 1 | 8 | CH₃ | 3 | 12 | 8000 |

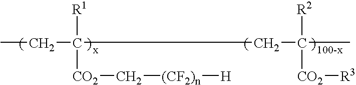

| | x | R¹ | n | R² | R³ | Mw |
|---|---|---|---|---|---|---|
| FP-48 | 80 | H | 4 | CH₃ | CH₃ | 11000 |
| FP-49 | 90 | H | 4 | H | C₄H₉(n) | 7000 |
| FP-50 | 95 | H | 4 | H | C₆H₁₃(n) | 5000 |
| FP-51 | 90 | CH₃ | 4 | H | CH₂CH(C₂H₅)C₄H₉(n) | 15000 |
| FP-52 | 70 | H | 6 | CH₃ | C₂H₅ | 18000 |
| FP-53 | 90 | H | 6 | CH₃ | 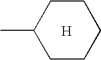 | 12000 |
| FP-54 | 80 | H | 6 | H | C₄H₉(sec) | 9000 |
| FP-55 | 90 | H | 6 | H | C₁₂H₂₅(n) | 21000 |
| FP-56 | 60 | CH₃ | 6 | H | CH₃ | 15000 |
| FP-57 | 60 | H | 8 | H | CH₃ | 10000 |
| FP-58 | 70 | H | 8 | H | C₂H₅ | 24000 |
| FP-59 | 70 | H | 8 | H | C₄H₉(n) | 5000 |
| FP-60 | 50 | H | 8 | H | C₄H₉(n) | 16000 |
| FP-61 | 80 | H | 8 | CH₃ | C₄H₉(iso) | 13000 |
| FP-62 | 80 | H | 8 | CH₃ | C₄H₉(t) | 9000 |
| FP-63 | 60 | H | 8 | H | 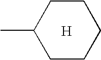 | 7000 |
| FP-64 | 80 | H | 8 | H | CH₂CH(C₂H₅)C₄H₉(n) | 8000 |
| FP-65 | 90 | H | 8 | H | C₁₂H₂₅(n) | 6000 |
| FP-66 | 80 | CH₃ | 8 | CH₃ | C₄H₉(sec) | 18000 |
| FP-67 | 70 | CH₃ | 8 | CH₃ | CH₃ | 22000 |
| FP-68 | 70 | H | 10 | CH₃ | H | 17000 |
| FP-69 | 90 | H | 10 | H | H | 9000 |
| FP-70 | 95 | H | 4 | CH₃ | —(CH₂CH₂O)₂—H | 18000 |
| FP-71 | 80 | H | 4 | H | —(CH₂CH₂O)₂—CH₃ | 16000 |
| FP-72 | 80 | H | 4 | H | —(C₃H₆O)₇—H | 24000 |
| FP-73 | 70 | CH₃ | 4 | H | —(C₃H₆O)₁₃—H | 18000 |
| FP-74 | 90 | H | 6 | H | —(CH₂CH₂O)₂—H | 21000 |
| FP-75 | 90 | H | 6 | CH₃ | —(CH₂CH₂O)₈—H | 9000 |
| FP-76 | 80 | H | 6 | H | —(CH₂CH₂O)₂—C₄H₉(n) | 12000 |
| FP-77 | 80 | H | 6 | H | —(C₃H₆O)₇—H | 34000 |
| FP-78 | 75 | F | 6 | H | —(C₃H₆O)₁₃—H | 11000 |
| FP-79 | 85 | CH₃ | 6 | CH₃ | —(C₃H₆O)₂₀—H | 18000 |
| FP-80 | 95 | CH₃ | 6 | CH₃ | —CH₂CH₂OH | 27000 |
| FP-81 | 80 | H | 8 | CH₃ | —(CH₂CH₂O)₈—H | 12000 |
| FP-82 | 95 | H | 8 | H | —(CH₂CH₂O)₉—CH₃ | 20000 |
| FP-83 | 90 | H | 8 | H | —(C₃H₆O)₇—H | 8000 |
| FP-84 | 95 | H | 8 | H | —(C₃H₆O)₂₀—H | 15000 |
| FP-85 | 90 | F | 8 | H | —(C₃H₆O)₁₃—H | 12000 |
| FP-86 | 80 | H | 8 | CH₃ | —(CH₂CH₂O)₂—H | 20000 |
| FP-87 | 95 | CH₃ | 8 | H | —(CH₂CH₂O)₉—CH₃ | 17000 |
| FP-88 | 90 | CH₃ | 8 | H | —(C₃H₆O)₇—H | 34000 |
| FP-89 | 80 | H | 10 | H | —(CH₂CH₂O)₈—H | 19000 |
| FP-90 | 90 | H | 10 | H | —(C₃H₆O)₇—H | 8000 |
| FP-91 | 80 | H | 12 | H | —(CH₂CH₂O)₇—CH₃ | 7000 |
| FP-92 | 95 | CH₃ | 12 | H | —(C₃H₆O)₇—H | 10000 |

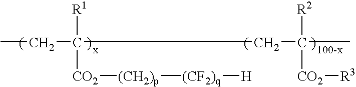

| | x | R¹ | p | q | R² | R³ | Mw |
|---|---|---|---|---|---|---|---|
| FP-93 | 80 | H | 2 | 4 | H | C₄H₉(n) | 18000 |
| FP-94 | 90 | H | 2 | 4 | H | —(CH₂CH₂O)₉—CH₃ | 16000 |
| FP-95 | 90 | CH₃ | 2 | 4 | F | C₆H₁₃(n) | 24000 |
| FP-96 | 80 | CH₃ | 1 | 6 | F | C₄H₉(n) | 18000 |
| FP-97 | 95 | H | 2 | 6 | H | —(C₃H₆O)₇—H | 21000 |
| FP-98 | 90 | CH₃ | 3 | 6 | H | —CH₂CH₂OH | 9000 |
| FP-99 | 75 | H | 1 | 8 | F | CH₃ | 12000 |
| FP-100 | 80 | H | 2 | 8 | H | CH₂CH(C₂H₅)C₄H₉(n) | 34000 |
| FP-101 | 90 | CH₃ | 2 | 8 | H | —(C₃H₆O)₇—H | 11000 |
| FP-102 | 80 | H | 3 | 8 | CH₃ | CH₃ | 18000 |
| FP-103 | 90 | H | 1 | 10 | F | C₄H₉(n) | 27000 |
| FP-104 | 95 | H | 2 | 10 | H | —(CH₂CH₂O)₉—CH₃ | 12000 |
| FP-105 | 85 | CH₃ | 2 | 10 | CH₃ | C₄H₉(n) | 20000 |
| FP-106 | 80 | H | 1 | 12 | H | C₆H₁₃(n) | 8000 |
| FP-107 | 90 | H | 1 | 12 | H | —(CH₃H₆O)₁₃—H | 15000 |
| FP-108 | 60 | CH₃ | 3 | 12 | CH₃ | C₂H₅ | 12000 |
| FP-109 | 60 | H | 1 | 16 | H | CH₂CH(C₂H₅)C₄H₉(n) | 20000 |
| FP-110 | 80 | CH₃ | 1 | 16 | H | —(CH₂CH₂O)₂—C₄H₉(n) | 17000 |
| FP-111 | 90 | H | 1 | 18 | H | —CH₂CH₂OH | 34000 |
| FP-112 | 60 | H | 3 | 18 | CH₃ | CH₃ | 19000 |

| | | |
|---|---|---|
| 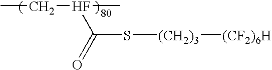 | 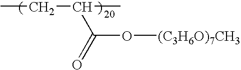 | FP-113 Mw 39,000 |
| 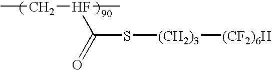 | 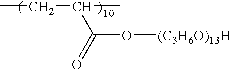 | FP-114 Mw 45,000 |
| 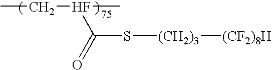 | 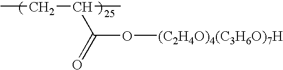 | FP-115 Mw 46,000 |
| 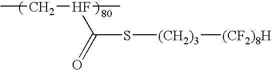 | 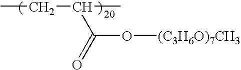 | FP-116 Mw 28,000 |
| 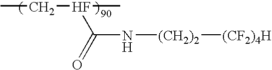 | 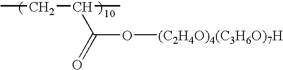 | FP-117 Mw 56,000 |
| 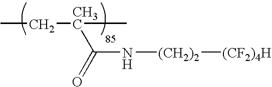 | 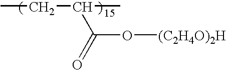 | FP-118 Mw 32,000 |
| 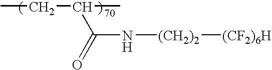 | 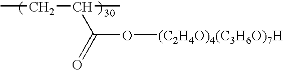 | FP-119 Mw 29,000 |
| 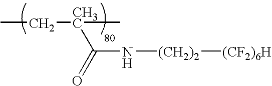 | 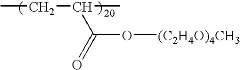 | FP-120 Mw 45,000 |
| 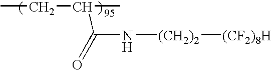 | 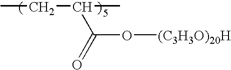 | FP-121 Mw 30,000 |
| 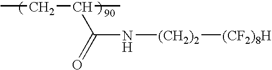 | 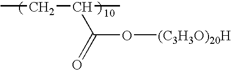 | FP-122 Mw 32,000 |
| 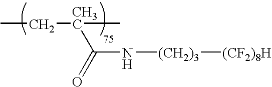 | 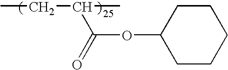 | FP-123 Mw 48,000 |
| 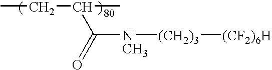 | 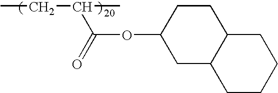 | FP-124 Mw 39,000 |
| 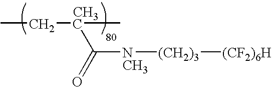 | 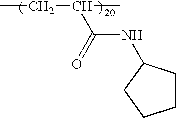 | FP-125 Mw 45,000 |
| 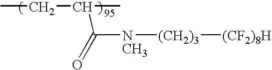 | 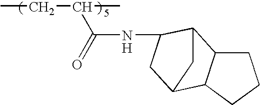 | FP-126 Mw 28,000 |
| 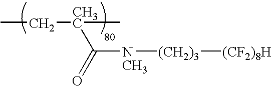 | 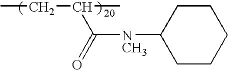 | FP-127 Mw 29,000 |

| | | | |
|---|---|---|---|
| 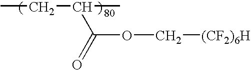 | 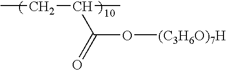 | 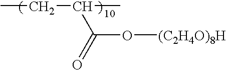 | FP-128 Mw 30,000 |
| 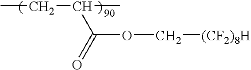 | 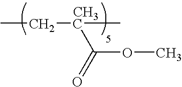 | 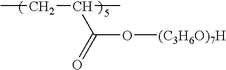 | FP-129 Mw 31,000 |
| 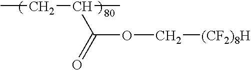 | 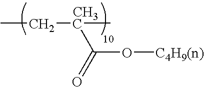 | 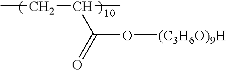 | FP-130 Mw 40,000 |

| | | |
|---|---|---|
| 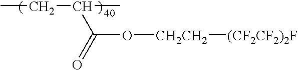 | 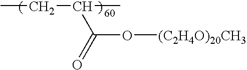 | FP-131 Mw 15,000 |
| 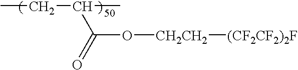 | 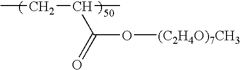 | FP-132 Mw 15,000 |
| 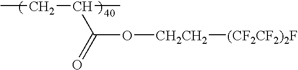 | 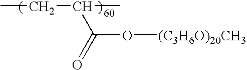 | FP-133 Mw 30,000 |
| 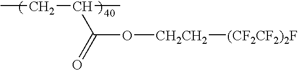 | 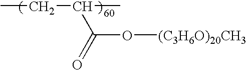 | FP-134 Mw 50,000 |
| 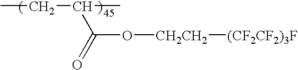 | 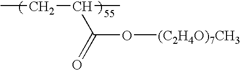 | FP-135 Mw 15,000 |
| 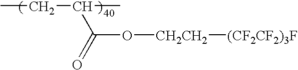 | 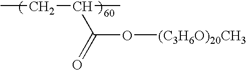 | FP-136 Mw 7,000 |
| 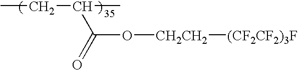 | 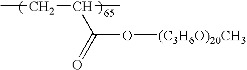 | FP-137 Mw 20,000 |
| 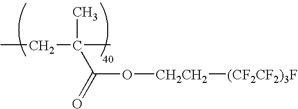 | 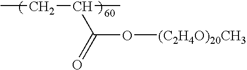 | FP-138 Mw 15,000 |
| 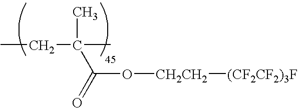 | 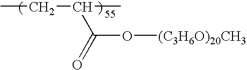 | FP-139 Mw 40,000 |
| 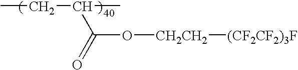 | 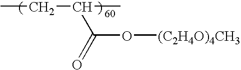 | FP-140 Mw 15,000 |
| 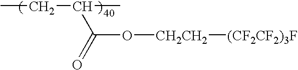 | 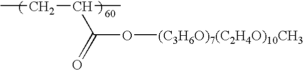 | FP-141 Mw 20,000 |
| 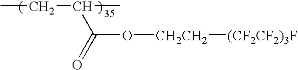 | 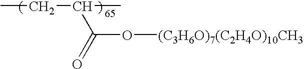 | FP-142 Mw 25,000 |

Other than these, additives for controlling the antistatic property, electrical conductivity, hardness and the like may also be used in the antiglare hard coat layer of the present invention.

In order to impart physical strength and antiglare property, the thickness of the antiglare hard coat layer of the present invention is preferably from 0.5 to 20 μm, more preferably from 0.7 to 15 μm, still more preferably from 1 to 10 μm. Also, the thickness of the coating film at the time of providing this layer is set by taking account of the concentration, viscosity, drying property and the like of the coating solution but is preferably from 1 to 40 ml/m², more preferably from 2 to 30 ml/m², still more preferably from 5 to 25 ml/m². The improvement effect by the selection of the cellulose acylate film of the present invention and the solvent composition is obtained even in the region of small coated amount, but the effect is large particularly in the region of large coated amount and the thickness of the coating film is yet still more preferably from 10 to 25 ml/m².

[Light-Diffusing Layer]

In the optical functional film of the present invention, the light-diffusing layer has a purpose of enlarging the viewing angle (particularly viewing angle in the downward direction) and prevent reduction in the contrast, reversal of gradation or black-and-white, and change in the color hue even when the viewing angle in the observation direction is changed.

The present inventors have confirmed that the intensity distribution of scattered light as measured by a goniophotometer is correlated with the effect of improving the viewing angle. That is, as the light ejected from backlight is more diffused by the effect of internal scattering of translucent fine particles contained in the light-diffusing film disposed on the polarizing plate surface on the viewing side, the viewing angle properties are more enhanced. However, if the light is excessively scattered, backward scattering becomes large and the front brightness decreases. Also, excessively large scattering causes a problem such as deterioration of image sharpness. Accordingly, the intensity distribution of scattered light needs to be controlled to a certain range. As a result of intensive investigations, it has been found that in order to achieve desired viewing properties, the intensity of scattered light at 30° having correlation with the effect of improving the viewing angle is preferably from 0.01 to 0.2%, more preferably from 0.02 to 0.15%, still more preferably from 0.03 to 0.1%, based on the intensity of light ejected at an angle of 0° in the scattered light profile.

The scattered light profile can be obtained by measuring the prepared light-scattering film with use of an automatic goniophotometer, Model GP-5, manufactured by Murakami Color Research Laboratory.

The light-diffusing layer for use in the present invention comprises a binder, an inorganic filler and translucent fine particles. The binder and inorganic filler used may be the same as those used in the antiglare hard coat layer, and the translucent fine particle used may be the same as the above-described matting particle.

The binder of the light-diffusing layer is added in an amount of 5 to 80 mass % based on the solid content of the coating composition for the layer.

The light-diffusing layer for use in the present invention preferably has also a hard coat function. In the light-diffusing layer, the binder, initiator, particle and other additives described above with respect to the antiglare hard coat layer can be similarly used.

[Hard Coat Layer]

As for the hard coat layer, a so-called smooth hard coat layer having not antiglare property is also preferably used so as to impart physical strength to the antireflection film. This hard coat layer is provided on the surface of the transparent support, preferably between the transparent support and the antiglare hard coat layer, between the transparent support and the light-diffusing layer, or between the transparent support and the high refractive index layer.

The hard coat layer is preferably formed by the crosslinking reaction or polymerization reaction of an ionizing radiation-curable compound. For example, the hard coat layer can be formed by coating a coating composition containing an ionizing radiation-curable polyfunctional monomer or oligomer on the transparent support, and causing a crosslinking reaction or polymerization reaction of the polyfunctional monomer or oligomer.

The functional group in the ionizing radiation-curable polyfunctional monomer or oligomer is preferably a photopolymerizable functional group, an electron beam-polymerizable functional group or a radiation-polymerizable functional group. Among these, a photopolymerizable functional group is more preferred.

Examples of the photopolymerizable functional group include an unsaturated polymerizable functional group such as (meth)acryloyl group, vinyl group, styryl group and allyl group, with a (meth)acryloyl group being preferred.

Specific examples of the ionizing radiation-curable polyfunctional monomer or oligomer are the same as those described for the antiglare hard coat layer.

Specific examples of the photopolymerizable polyfunctional monomer having a photopolymerizable functional group include those described for the high refractive index layer, and this monomer is preferably polymerized by using a photopolymerization initiator or a photosensitizer. The photopolymerization reaction is preferably performed by irradiating ultraviolet light after coating and drying the hard coat layer.

The binder of the hard coat layer is added in an amount of 30 to 95 mass % based on the solid content of the coating composition for the layer.

The hard coat layer preferably contains inorganic fine particles having an average primary particle diameter of 200 nm or less. The average particle diameter as used herein is a mass average diameter. With an average primary particle diameter of 200 nm or less, a hard coat layer of not impairing the transparency can be formed.

The inorganic fine particle has a function of not only increasing the hardness of the hard coat layer but also suppressing cure shrinkage of the coat layer. The inorganic fine particle is added also for the purpose of controlling the refractive index of the hard coat layer.

Examples of the inorganic fine particle include, in addition to the inorganic fine particles described for the high refractive index layer, fine particles of silicon dioxide, aluminum oxide, calcium carbonate, barium sulfate, talc, kaolin, calcium sulfate, titanium dioxide, zirconium dioxide, tin oxide, ITO and zinc oxide.

The average primary particle diameter of the inorganic fine particles is preferably from 5 to 200 nm, more preferably from 10 to 150 nm, still more preferably from 20 to 100 nm, yet still more preferably from 20 to 50 nm.

In the hard coat layer, the inorganic fine particles are preferably dispersed to have a particle diameter as small as possible.

The particle size of the inorganic fine particles in the hard coat layer is, in terms of the average particle diameter, preferably from 5 to 300 nm, more preferably from 10 to 200 nm, still more preferably from 20 to 150 nm, yet still more preferably from 20 to 80 nm.

The content of the inorganic fine particle in the hard coat layer is preferably from 10 to 90 mass %, more preferably from 15 to 80 mass %, still more preferably from 15 to 75 mass %, based on the entire mass of the hard coat layer.

The thickness of the hard coat layer can be appropriately designed according to usage. The thickness of the hard coat layer is preferably from 0.2 to 10 μm, more preferably from 0.5 to 7 μm, still more preferably from 0.7 to 5 μm.

The hardness of the hard coat layer is preferably H or more, more preferably 2H or more, and most preferably 3H or more, in the pencil hardness test according to JIS K5400.

Furthermore, in the Taber test according to JIS K5400, the abrasion loss of the specimen between before and after the test is preferably smaller.

In forming the hard coat layer, when the hard coat layer is formed by a crosslinking or polymerization reaction of an ionizing radiation-curable compound, the crosslinking or polymerization reaction is preferably performed in an atmosphere having an oxygen concentration of 10 vol % or less. By forming the hard coat layer in an atmosphere having an oxygen concentration of 10 vol % or less, a hard coat layer having excellent physical strength and chemical resistance can be formed.

The hard coat layer is preferably formed by a crosslinking or polymerization reaction of an ionizing radiation-curable compound in an atmosphere having an oxygen concentration of 6 vol % or less, more preferably 4 vol % or less, still more preferably 2 vol % or less, and most preferably 1 vol % or less.

For adjusting the oxygen concentration to 10 vol % or less, this is preferably achieved by displacing the air (nitrogen concentration: about 79 vol %, oxygen concentration: about 21 vol %) with another gas, more preferably with nitrogen (nitrogen purging).

The hard coat layer is preferably formed on the transparent support surface by coating a coating composition for the formation of the hard coat layer.

[High Refractive Index Layer]

In the antireflection film of the present invention, a high refractive index layer may be preferably used so as to impart higher antireflection ability.

<Inorganic Fine Particle Mainly Comprising Titanium Dioxide>

The high refractive index layer for use in the present invention contains an inorganic fine particle mainly comprising a titanium dioxide containing at least one element selected from cobalt, aluminum and zirconium. The “mainly comprising a certain component” means that the content (mass %) of the component is highest among the components constituting the particle.

The refractive index of the high refractive index layer for use in the present invention is from 1.55 to 2.40 and this is a layer called a high refractive index layer or a medium refractive index layer, but in the present invention, these layers are sometimes collectively called a high refractive index layer.

The inorganic fine particle mainly comprising titanium dioxide for use in the present invention preferably has a refractive index of 1.90 to 2.80, more preferably from 2.10 to 2.80, and most preferably from 2.20 to 2.80.

The mass average primary particle diameter of the inorganic fine particle mainly comprising titanium dioxide is preferably from 1 to 200 nm, more preferably from 1 to 150 nm, still more preferably from 1 to 100 nm, yet still more preferably from 1 to 80 nm.

The particle diameter of the inorganic fine particle can be measured by a light scattering method or an electron microphotograph. The specific surface area of the inorganic fine particle is preferably from 10 to 400 m²/g, more preferably from 20 to 200 m²/g, and most preferably from 30 to 150 m²/g.

As for the crystal structure of the inorganic fine particle mainly comprising titanium dioxide, the main component is preferably a rutile structure, a rutile/anatase mixed crystal, an anatase structure or an amorphous structure, more preferably a rutile structure. The main component means a component of which content (mass %) is highest among the components constituting the particle.

By incorporating at least one element selected from Co, Al and Zr into the inorganic fine particle mainly comprising titanium dioxide, the photocatalytic activity of the titanium dioxide can be suppressed and the weather resistance of the high refractive index layer for use in the present invention can be improved.

The element is preferably Co. A combination use of two or more elements is also preferred.

The content of Co, Al or Zr is preferably from 0.05 to 30 mass %, more preferably from 0.1 to 10 mass %, still more preferably from 0.2 to 7 mass %, yet still more preferably from 0.3 to 5 mass %, and most preferably from 0.5 to 3 mass %, based on Ti.

Co, Al or Zr can be present at least in either the inside or the surface of the inorganic fine particle mainly comprising titanium dioxide, but the element is preferably present in the inside of the inorganic fine particle mainly comprising titanium dioxide, and most preferably in both the inside and the surface.

Co, Al or Zr can be made to exist (for example, doped) in the inside of the inorganic fine particle mainly comprising titanium dioxide by various methods. Examples of the method include an ion injection method (see, Yasushi Aoki, Journal of the Surface Science Society of Japan, Vol. 18, No. 5, pp. 262-268 (1998)) and methods described in JP-A-11-263620, JP-T-11-512336 (the term (the term “JP-T” as used herein means a “published Japanese translation of a PCT patent application”), EP-A-0335773 and JP-A-5-330825.

A method of introducing Co, Al or Zr in the process of forming the inorganic fine particle mainly comprising titanium dioxide (see, for example, JP-T-11-512336, EP-A-0335773 and JP-A-5-330825) is particularly preferred.

Co, Al or Zr is also preferably present in the form of an oxide.

The inorganic fine particle mainly comprising titanium dioxide may further contain other elements according to the purpose. Other elements may be contained as impurities. Examples of other elements include Sn, Sb, Cu, Fe, Mn, Pb, Cd, As, Cr, Hg, Zn, Mg, Si, P and S.

The inorganic fine particle mainly comprising titanium dioxide for use in the present invention may be surface-treated. The surface treatment is performed by using an inorganic compound or an organic compound. Examples of the inorganic compound for use in the surface treatment include a cobalt-containing inorganic compound (e.g., CoO₂, CO₂O₃, CO₃O₄), an aluminum-containing inorganic compound (e.g., Al₂O₃, Al(OH)₃), a zirconium-containing inorganic compound (e.g., ZrO₂, Zr(OH)₄), a silicon-containing inorganic compound (e.g., SiO₂) and an iron-containing inorganic compound (e.g., Fe₂O₃).

Among these, a cobalt-containing inorganic compound, an aluminum-containing inorganic compound and a zirconium-containing inorganic compound are preferred, and a cobalt-containing inorganic compound, Al(OH)₃ and Zr(OH)₄ are most preferred. Examples of the organic compound for use in the surface treatment include a polyol, an alkanolamine, a stearic acid, a silane coupling agent and a titanate coupling agent. Among these, a silane coupling agent is most preferred. In particular, the surface treatment is preferably performed with at least one member selected from a silane coupling agent represented by formula 5 which is shown later (organosilane compound), and a partially hydrolyzed product or condensate thereof. The silane coupling agent represented by formula 5 is described in detail later.

Examples of the titanate coupling agent include a metal alkoxide such as tetramethoxy titanium, tetraethoxy titanium and tetraisorpopoxy titanium, and Preneact (e.g., KR-TTS, KR-46B, KR-55 and KR-41B, produced by Ajinomoto Co., Inc.).

Preferred examples of the organic compound for use in the surface treatment include a polyol, an alkanolamine and other organic compounds having an anionic group. Among these, more preferred is an organic compound having a carboxyl group, a sulfonic acid group or a phosphoric acid group.

A stearic acid, a lauric acid, an oleic acid, a linoleic acid and a linolenic acid are preferably used.

The organic compound for use in the surface treatment preferably further has a crosslinking or polymerizable functional group. Examples of the crosslinking or polymerizable functional group include an ethylenically unsaturated group (e.g., (meth)acryl, allyl, styryl, vinyloxy) capable of an addition reaction/polymerization reaction by the effect of a radical species; a cationic polymerizable group (e.g., epoxy, oxatanyl, vinyloxy); and a polycondensation reactive group (e.g., hydrolyzable silyl group, N-methylol). Among these, preferred is a functional group having an ethylenically unsaturated group.

Tow or more of these surface treatments may also be used in combination. A combination use of an aluminum-containing inorganic compound and a zirconium-containing inorganic compound is particularly preferred.

The inorganic fine particle mainly comprising titanium dioxide for use in the present invention may be rendered to have a core/shell structure by the surface treatment as described in JP-A-2001-166104.

The shape of the inorganic fine particle mainly comprising titanium dioxide, which is contained in the high refractive index layer, is preferably a pebble form, a spherical form, a cubic form, a spindle form or an amorphous form, more preferably an amorphous form or a spindle form.

<Dispersant>

For dispersing the inorganic fine particle mainly comprising titanium dioxide, which is used in the high refractive index layer of the present invention, a dispersant can be used.

For the dispersion of the inorganic fine particle mainly comprising titanium dioxide used in the present invention, a dispersant having an anionic group is preferably used.

As the anionic group, a group having an acidic proton, such as carboxyl group, sulfonic acid group (and sulfo group), phosphoric acid group (and phosphono group) and sulfonamide group, or a salt thereof is effective. In particular, a carboxyl group, a sulfonic acid group, a phosphonic acid group, and a salt thereof are preferred, and a carboxyl group and a phosphoric acid group are more preferred. As for the number of anionic groups contained per one molecule of the dispersant, it is sufficient if 1 or more anionic group is contained.

For the purpose of more improving the dispersibility of the inorganic fine particle, a plural number of anionic groups may be contained. The average number of anionic groups is preferably 2 or more, more preferably 5 or more, still more preferably 10 or more. Also, plural kinds of anionic groups may be contained in one molecule of the dispersant.

The dispersant preferably further contains a crosslinking or polymerizable functional group. Examples of the crosslinking or polymerizable functional group include an ethylenically unsaturated group (e.g., (meth)acryloyl, allyl, styryl, vinyloxy) capable of an addition reaction/polymerization reaction by the effect of a radical species; a cationic polymerizable group (e.g., epoxy, oxatanyl, vinyloxy); and a polycondensation reactive group (e.g., hydrolyzable silyl, N-methylol). Among these, a functional group having an ethylenically unsaturated group is preferred.

The dispersant used for dispersing the inorganic fine particle mainly comprising titanium dioxide, which is used in the high refractive index layer of the present invention, is preferably a dispersant having an anionic group and a crosslinking or polymerizable functional group and at the same time, having the crosslinking or polymerizable functional group on the side chain.

The mass average molecular weight (Mw) of the dispersant having an anionic group and a crosslinking or polymerizable functional group and at the same time, having the crosslinking or polymerizable functional group on the side chain is not particularly limited but is preferably 1,000 or more, more preferably from 2,000 to 1,000,000, still more preferably from 5,000 to 200,000, yet still more preferably from 10,000 to 100,000.

As the anionic group, a group having an acidic proton, such as carboxyl group, sulfonic acid group (and sulfo group), phosphoric acid group (and phosphono group) and sulfonamide group, or a salt thereof is effective. In particular, a carboxyl group, a sulfonic acid group, a phosphonic acid group, and a salt thereof are preferred, and a carboxyl group and a phosphoric acid group are more preferred. The number of anionic groups contained per one molecule of the dispersant is, on average, preferably 2 or more, more preferably 5 or more, still more preferably 10 or more. Also, plural kinds of anionic groups may be contained in one molecule of the dispersant.

The dispersant having an anionic group and a crosslinking or polymerizable functional group and at the same time, having the crosslinking or polymerizable functional group on the side chain has the anionic group on the side chain or at the terminal.

A dispersant having the anionic group on the side chain is particularly preferred. In the dispersant having an anionic group on the side chain, the proportion of the anionic group-containing repeating unit is from 10 to 100 mol %, preferably from 1 to 50 mol %, still more preferably from 5 to 20 mol %, based on all repeating units.

Examples of the crosslinking or polymerizable functional group include an ethylenically unsaturated group (e.g., (meth)acryl, allyl, styryl, vinyloxy) capable of an addition reaction/polymerization reaction by the effect of a radical species; a cationic polymerizable group (e.g., epoxy, oxatanyl, vinyloxy); and a polycondensation reactive group (e.g., hydrolyzable silyl, N-methylol). Among these, a functional group having an ethylenically unsaturated group is preferred.

The number of crosslinking or polymerizable functional groups contained per one molecule of the dispersant is, on average, preferably 2 or more, more preferably 5 or more, still more preferably 10 or more. Also, plural kinds of crosslinking or polymerizable functional groups may be contained in one molecule of the dispersant.

Examples of the repeating unit having an ethylenically unsaturated group on the side chain, which can be used in the preferred dispersant for use in the present invention, include a poly-1,2-butadiene structure, a poly-1,2-isoprene structure, and a (meth)acrylic acid ester or amide repeating unit which is bonded with a specific residue (the R group of —COOR or —CONHR). Examples of the specific residue (R group) include —(CH₂), —CR²¹═CR²²R²³, —(CH₂O)ₙ—CH₂CR²¹═CR²²R²³, —(CH₂CH₂O)ₙ—OCH₂CR²¹═CR²²R²³, —(CH₂)ₙ—NH—CO—O—CH₂CR²¹═CR²²R²³, —(CH₂)ₙ—O—CO—CR²¹═CR²²R²³ and —(CH₂CH₂O)₂—X (wherein R²¹ to R²³ each is a hydrogen atom, a halogen atom, an alkyl group having a carbon atom number of 1 to 20, an aryl group, an alkoxy group or an aryloxy group, R²¹ may combine with R²² or R²³ to form a ring, n is an integer of 1 to 10, and X is a dicyclopentadienyl residue). Specific examples of the ester residue R include —CH₂CH═CH₂ (corresponding to the polymer of allyl (meth)acrylate described in JP-A-64-17047), —CH₂CH₂O—CH₂CH═CH₂, —CH₂CH₂OCOCH═CH₂, CH₂CH₂OCOC(CH₃)═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂ and —CH₂CH₂O—X (wherein X is a dicyclopentadienyl residue). Specific examples of the amide residue R include —CH₂CH═CH₂, —CH₂CH₂—Y (wherein Y is a 1-cyclohexenyl residue), —CH₂CH₂—OCO—CH═CH₂ and —CH₂CH₂—OCO—C(CH₃)═CH₂.

In the dispersant having an ethylenically unsaturated group, a free radical (a polymerization initiation radical or a radical grown in the polymerization process of a polymerizable compound) is added to the unsaturated bond group to cause an addition polymerization between molecules directly or through polymerization chain of a polymerizable compound, as a result, a crosslink is formed between molecules, thereby completing the curing. Alternatively, an atom in the molecule (for example, a hydrogen atom on a carbon atom adjacent to the unsaturated bond group) is withdrawn by a free radical to produce a polymer radical and the polymer radicals are bonded with each other to form a crosslink between molecules, thereby completing the curing.

The crosslinking or polymerizable functional group-containing unit may constitute all repeating units except for the anionic group-containing repeating unit, but preferably occupies from 5 to 50 mol %, more preferably from 5 to 30 mol %, in all crosslinking or repeating units.

The preferred dispersant of the present invention may be a copolymer with an appropriate monomer other than the monomer having a crosslinking or polymerizable functional group and an anionic group. The copolymerization component is not particularly limited but is selected by taking account of various points such as dispersion stability, compatibility with other monomer component, and strength of film formed. Preferred examples thereof include methyl (meth)acrylate, n-butyl (meth)acrylate, tert-butyl (meth)acrylate, cyclohexyl (meth)acrylate and styrene.

The preferred dispersant of the present invention is not particularly limited in its form but is preferably a block copolymer or a random copolymer and in view of cost and easy synthesis, more preferably a random copolymer.

As for the dispersant preferably used in the present invention, the compounds described in (Chem. 1) to (Chem. 6) of JP-A-2004-29705 can be used.

The amount of the dispersant used is preferably from 1 to 50 mass %, more preferably from 5 to 30 mass %, and most preferably from 5 to 20 mass %, based on the inorganic fine particle. Also, two or more kinds of dispersants may be used in combination.

<High Refractive Index Layer and Formation Method Thereof>

The inorganic fine particle mainly comprising titanium dioxide, for use in the high refractive index layer, is used in the dispersion state for the formation of high refractive index layer.

The inorganic fine particles are dispersed in a dispersion medium in the presence of a dispersant described above.

The dispersion medium is preferably a liquid having a boiling point of 60 to 170° C. Examples of the dispersion medium include water, an alcohol (e.g., methanol, ethanol, isopropanol, butanol, benzyl alcohol), a ketone (e.g., acetone, methyl ethyl ketone, methyl isobutyl ketone, cyclohexanone), an ester (e.g., methyl acetate, ethyl acetate, propyl acetate, butyl acetate, methyl formate, ethyl formate, propyl formate, butyl formate), an aliphatic hydrocarbon (e.g., hexane, cyclohexane), a halogenated hydrocarbon (e.g., methylene chloride, chloroform, carbon tetrachloride), an aromatic hydrocarbon (e.g., benzene, toluene, xylene), an amide (e.g., dimethylformamide, dimethylacetamide, n-methylpyrrolidone), an ether (e.g., diethyl ether, dioxane, tetrahydrofuran) and an ether alcohol (e.g., 1-methoxy-2-propanol). Among these, preferred are toluene, xylene, methyl ethyl ketone, methyl isobutyl ketone, cyclohexanone and butanol.

The dispersion medium is more preferably methyl ethyl ketone, methyl isobutyl ketone, cyclohexanone or toluene.

The inorganic fine particles are dispersed by using a disperser. Examples of the disperser include a sand grinder mill (e.g., bead mill with pin), a high-speed impeller, a pebble mill, a roller mill, an attritor and a colloid mill. Among these, a sand grinder mill and a high-speed impeller are preferred. Also, a preliminary dispersion treatment may be performed. Examples of the disperser for use in the preliminary dispersion treatment include a ball mill, a three-roll mill, a kneader and an extruder.

The inorganic fine particles are preferably dispersed in the dispersion medium to have a particle diameter as small as possible. The mass average particle diameter is from 1 to 200 nm, preferably from 5 to 150 nm, more preferably from 10 to 100 nm, still more preferably from 10 to 80 nm.

By dispersing the inorganic fine particles to have a small particle diameter of 200 nm or less, a high refractive index layer not impairing the transparency can be formed.

The high refractive index layer for use in the present invention is preferably formed as follows. A coating composition for the formation of the high refractive index layer is prepared by further adding a binder precursor (the same as the binder precursor for the antiglare hard coat layer) necessary for the matrix formation, a photopolymerization initiator and the like to the liquid dispersion obtained as above by dispersing the inorganic fine particles in a dispersion medium, and the coating composition for the formation of the high refractive index layer is coated on a transparent support and cured through a crosslinking or polymerization reaction of the ionizing radiation-curable compound (for example, a polyfunctional monomer or oligomer).

Simultaneously with or after the coating of the high refractive index layer, the binder of the layer is preferably crosslinked or polymerized with the dispersant.

The binder of the thus-produced high refractive index layer takes a form such that the anionic group of the dispersant is taken into the binder as a result of crosslinking or polymerization reaction between the above-described preferred dispersant and the ionizing radiation-curable polyfunctional monomer or oligomer. The anionic group taken into the binder of the high refractive index layer has a function of maintaining the dispersed state of inorganic fine particles and the crosslinked or polymerized structure imparts a film-forming ability to the binder, whereby the high refractive index layer containing inorganic fine particles is improved in the physical strength and the resistance against chemicals and weather.

For the polymerization reaction of the photopolymerizable polyfunctional monomer, a photopolymerization is preferably used. The photopolymerization initiator is preferably a photo-radical polymerization initiator or a photo-cationic polymerization initiator, more preferably a photo-radical polymerization initiator.

As for the photo-radical polymerization initiator, a photo-radical polymerization initiator the same as described above for the antiglare hard coat layer can be used.

In the high refractive index layer, the binder preferably further has a silanol group. By further having a silanol group in the binder, the high refractive index layer is more improved in the physical strength and the resistance against chemicals and weather.

The silanol group can be introduced into the binder, for example, by adding a silane coupling agent having a crosslinking or polymerizable functional group, represented by formula A, or its partially hydrolyzed product or condensate to the coating composition for the formation of the high refractive index layer, coating the coating composition on a transparent support, and crosslinking or polymerizing the dispersant, the polyfunctional monomer or oligomer and the silane coupling agent represented by formula A or its partially hydrolyzed product or condensate.

In the high refractive index layer, the binder also preferably has an amino group or a quaternary ammonium group.

The binder having an amino group or a quaternary ammonium group of the high refractive index layer can be formed, for example, by adding a monomer having a crosslinking or polymerizable functional group and an amino group or a quaternary ammonium group to the coating composition for the formation of the high refractive index layer, coating the coating composition on a transparent support, and crosslinking or polymerizing the monomer with the dispersant and polyfunctional monomer or oligomer.

The monomer having an amino group or a quaternary ammonium group functions as a dispersion aid for the inorganic fine particles in the coating composition. Furthermore, after the coating, this monomer is crosslinked or polymerized with the dispersant and polyfunctional monomer or oligomer to form a binder, whereby good dispersibility of inorganic fine particles in the high refractive index layer can be maintained and a high refractive index layer excellent in the physical strength and the resistance against chemicals and weather can be produced.

Preferred examples of the monomer having an amino group or a quaternary ammonium group include N,N-dimethylaminoethyl (meth)acrylate, N,N-dimethylaminopropyl (meth)acrylate, hydroxypropyltrimethylammonium chloride (meth)acrylate and dimethylallylammonium chloride.

The amount used of the monomer having an amino group or a quaternary ammonium group is preferably from 1 to 40 mass %, more preferably from 3 to 30 mass %, still more preferably from 3 to 20 mass %, based on the dispersant. When the binder is formed by the crosslinking or polymerization reaction simultaneously with or after the coating of the high refractive index layer, the function of this monomer can be effectively brought out before the coating of the high refractive index layer.

The crosslinked or polymerized binder has a structure that the polymer main chain is crosslinked or polymerized. Examples of the polymer main chain include a polyolefin (saturated hydrocarbon), a polyether, a polyurea, a polyurethane, a polyester, a polyamine, a polyamide and a melamine resin. Among these, preferred are a polyolefin main chain, a polyether main chain and a polyurea main chain, more preferred are a polyolefin main chain and a polyether main chain, and most preferred is a polyolefin main chain.

The polyolefin main chain comprises a saturated hydrocarbon. The polyolefin main chain is obtained, for example, by the addition polymerization of an unsaturated polymerizable group. In the polyether main chain, repeating units are bonded through an ether bond (—O—). The polyether main chain is obtained, for example, by the ring-opening polymerization reaction of an epoxy group. In the polyurea main chain, repeating units are bonded through a urea bond (—NH—CO—NH—). The polyurea main chain is obtained, for example, by the condensation polymerization reaction of an isocyanate group and an amino group. In the polyurethane main chain, repeating units are bonded through a urethane bond (—NH—CO—O—). The polyurethane main chain is obtained, for example, by the condensation polymerization reaction of an isocyanate group and a hydroxyl group (including an N-methylol group). In the polyester main chain, repeating units are bonded through an ester bond (—CO—O—). The polyester main chain is obtained, for example, by the condensation polymerization reaction of a carboxyl group (including an acid halide group) and a hydroxyl group (including an N-methylol group). In the polyamine main chain, repeating units are bonded through an imino bond (—NH—). The polyamine main chain is obtained, for example, by the ring-opening polymerization reaction of an ethyleneimine group. In the polyamide main chain, repeating units are bonded through an amido bond (—NH—CO—). The polyamide main chain is obtained, for example, by the reaction of an isocyanate group and a carboxyl group (including an acid halide group). The melamine resin main chain is obtained, for example, by the condensation polymerization reaction of a triazine group (e.g., melamine) and an aldehyde (e.g., formaldehyde). Incidentally, in the melamine resin, the main chain itself has a crosslinked or polymerized structure.

The anionic group is preferably bonded as a side chain of the binder to the main chain through a linking group.

The linking group connecting the anionic group and the binder main chain is preferably a divalent group selected from —CO—, —O—, an alkylene group, an arylene group and a combination thereof. The crosslinked or polymerized structure forms chemical bonding (preferably covalent bonding) of two or more main chains, preferably forms covalent bonding of three or more main chains. The crosslinked or polymerized structure preferably comprises a divalent or greater valence group selected from —CO—, —O—, —S—, a nitrogen atom, a phosphorus atom, an aliphatic residue, an aromatic residue and a combination thereof.

The binder is preferably a copolymer comprising a repeating unit having an anionic group and a repeating unit having a crosslinked or polymerized structure. In the copolymer, the proportion of the repeating unit having an anionic group is preferably from 2 to 96 mol %, more preferably from 4 to 94 mol %, and most preferably from 6 to 92 mol %. The repeating unit may have two or more anionic groups. In the copolymer, the proportion of the repeating unit having a crosslinked or polymerized structure is preferably from 4 to 98 mol %, more preferably from 6 to 96 mol %, and most preferably from 8 to 94 mol %.

The repeating unit of the binder may have both an anionic group and a crosslinked or polymerized structure. Also, the binder may contain other repeating unit (a repeating unit having neither an anionic group nor a crosslinked or polymerized unit).

This other repeating unit is preferably a repeating unit having a silanol group, an amino group or a quaternary ammonium group.

In the repeating unit having a silanol group, the silanol group is bonded directly to the binder main chain or bonded to the main chain through a linking group. The silanol group is preferably bonded as a side chain to the main chain through a linking group. The linking group connecting the silanol group and the binder main chain is preferably a divalent group selected from —CO—, —O—, an alkylene group, an arylene group and a combination thereof. In the case where the binder contains a repeating unit having a silanol group, the proportion of the repeating unit is preferably from 2 to 98 mol %, more preferably from 4 to 96 mol %, and most preferably from 6 to 94 mol %.

In the repeating unit having an amino group or a quaternary ammonium group, the amino group or quaternary ammonium group is bonded directly to the binder main chain or bonded to the main chain through a linking group. The amino group or quaternary ammonium group is preferably bonded as a side chain to the main chain through a linking group. The amino group or quaternary ammonium group is preferably a secondary amino group, a tertiary amino group or a quaternary ammonium group, more preferably a tertiary amino group or a quaternary ammonium group. The group bonded to the nitrogen atom of the secondary or tertiary amino group or quaternary ammonium group is preferably an alkyl group, more preferably an alkyl group having a carbon atom number of 1 to 12, still more preferably an alkyl group having a carbon atom number of 1 to 6. The counter ion of the quaternary ammonium group is preferably a halide ion. The linking group connecting the amino group or quaternary ammonium group and the binder main chain is preferably a divalent group selected from —CO—, —NH—, —O—, an alkylene group, an arylene group and a combination thereof. In the case where the binder contains a repeating unit having an amino group or a quaternary ammonium group, the proportion of the repeating unit is preferably from 0.1 to 32 mol %, more preferably from 0.5 to 30 mol %, and most preferably from 1 to 28 mol %.

Incidentally, the same effects can be obtained even when the silanol group, amino group or quaternary ammonium group is contained in the repeating unit having an anion group or in the repeating unit having a crosslinked or polymerized structure.

The crosslinked or polymerized binder is preferably formed by coating a coating composition for the formation of the high refractive index layer on a transparent support and simultaneously with or after the coating, causing a crosslinking or polymerization reaction.

The binder of the high refractive index layer is added in an amount of 5 to 80 mass % based on the solid content of the coating composition for the layer.

The inorganic fine particle has an effect of controlling the refractive index of the high refractive index layer and also has a function of suppressing cure shrinkage.

The inorganic fine particle is preferably dispersed in the high refractive index layer to have a particle diameter as small as possible. The mass average particle diameter is from 1 to 200 nm, preferably from 5 to 150 nm, more preferably from 10 to 100 nm, and most preferably from 10 to 80 nm.

By dispersing the inorganic fine particles to have a small particle diameter of 200 nm or less, a high refractive index layer not impairing the transparency can be formed.

The content of the inorganic fine particle in the high refractive index layer is preferably from 10 to 90 mass %, more preferably from 15 to 80 mass %, still more preferably from 15 to 75 mass %, based on the mass of the high refractive index layer. In the high refractive index layer, two or more kinds of inorganic fine particles may used in combination.

In the case of having a low refractive index layer on the high refractive index layer, the refractive index of the high refractive index layer is preferably higher than the refractive index of the transparent support.

In the high refractive index layer, a binder obtained by a crosslinking or polymerization reaction of an ionizing radiation-curable compound containing an aromatic ring, an ionizing radiation-curable compound containing a halogen element (e.g., Br, I, Cl) except for fluorine, or an ionizing radiation-curable compound containing an atom such as S, N and P, is also preferably used.

For producing an antireflection film by forming a low refractive index layer on the high refractive index layer, the refractive index of the high refractive index layer is preferably from 1.55 to 2.40, more preferably from 1.60 to 2.20, still more preferably from 1.65 to 2.10, and most preferably from 1.80 to 2.00.

The high refractive index layer may contain, in addition to the above-described components (e.g., inorganic fine particle, polymerization initiator, photosensitizer), a resin, a surfactant, an antistatic agent, a coupling agent, a thickening agent, a coloration inhibitor, a colorant (e.g., pigment, dye), a defoaming agent, a leveling agent, a flame retardant, an ultraviolet absorbent, an infrared absorbent, a tackifier, a polymerization inhibitor, an antioxidant, a surface modifier, an electrically conducting metal fine particle and the like.

The thickness of the high refractive index layer can be appropriately designed according to usage. When the high refractive index layer is used as an optical interference layer which is described later, the thickness is preferably from 30 to 200 nm, more preferably from 50 to 170 nm, still more preferably from 60 to 150 nm.

In the present invention, the crosslinking or polymerization reaction of the ionizing radiation-curable compound is preferably performed in an atmosphere having an oxygen concentration of 10 vol % or less. This is not limited to the formation of the high refractive index layer but commonly applies to the antiglare hard coat layer and the light-diffusing layer.

By forming the high refractive index layer in an atmosphere having an oxygen concentration of 10 vol % or less, the high refractive index layer can be improved in the physical strength and resistance against chemicals and weather and furthermore, in the adhesion between the high refractive index layer and a layer adjacent to the high refractive index layer.

The high refractive index layer is preferably formed by performing the crosslinking or polymerization reaction of the ionizing radiation-curable compound in an atmosphere having an oxygen concentration of 6 vol % or less, more preferably 4 vol % or less, still more preferably 2 vol % or less, and most preferably 1 vol % or less.

For adjusting the oxygen concentration to 10 vol % or less, this is preferably achieved by displacing the air (nitrogen concentration: about 79 vol %, oxygen concentration: about 21 vol %) with another gas, more preferably with nitrogen (nitrogen purging).

The strength of the high refractive index layer is preferably H or more, more preferably 2H or more, and most preferably 3H or more, in the pencil hardness test according to JIS K5400.

Furthermore, in the Taber test according to JIS K5400, the abrasion loss of the specimen between before and after the test is preferably smaller.

In the case where the high refractive index layer does not contain a particle of imparting an antiglare function, the haze of the layer is preferably lower, specifically, 5% or less, more preferably 3% or less, still more preferably 1% or less.

The high refractive index layer is preferably formed on the transparent support directly or through another layer.

The low refractive index layer for use in the present invention is described below.

The low refractive index layer of the antireflection film of the present invention has a refractive index of 1.20 to 1.49, preferably from 1.30 to 1.44.

The materials constituting the low refractive index layer of the present invention are described below.

The low refractive index layer of the present invention preferably contains a fluorine-containing polymer as a low refractive index binder. The fluorine polymer is preferably a fluorine-containing polymer having a kinetic friction coefficient of 0.03 to 0.15 and a contact angle to water of 90 to 120° and being capable of crosslinking by the effect of heat or ionizing radiation. In the low refractive index layer of the present invention, as described above, an inorganic filler may also be used so as to enhance the film strength.

Examples of the fluorine-containing polymer preferably used in the low refractive index layer include a hydrolysate and a dehydration-condensate of perfluoroalkyl group-containing silane compound (e.g., (heptadecafluoro-1,1,2,2-tetrahydrodecyl)triethoxysilane), and also include a fluorine-containing copolymer having, as constituent components, a fluorine-containing monomer unit and a constituent unit for imparting crosslinking reactivity.

Specific examples of the fluorine-containing monomer unit include fluoroolefins (e.g., fluoroethylene, vinylidene fluoride, tetrafluoroethylene, perfluorooctyl ethylene, hexafluoropropylene, perfluoro-2,2-dimethyl-1,3-dioxol), partially or completely fluorinated alkyl ester derivatives of (meth)acrylic acid (e.g., BISCOTE 6FM (produced by Osaka Yuki Kagaku), M-2020 (produced by Daikin)), and completely or partially fluorinated vinyl ethers. Among these, perfluoroolefins are preferred and in view of refractive index, solubility, transparency and easy availability, hexafluoropropylene is more preferred.

Examples of the constituent unit for imparting crosslinking reactivity include a constituent unit obtained by the polymerization of a monomer previously having a self-crosslinking functional group within the molecule, such as glycidyl (meth)acrylate and glycidyl vinyl ether; a constituent unit obtained by the polymerization of a monomer having a carboxyl group, a hydroxy group, an amino group or a sulfo group, such as (meth)acrylic acid, methylol (meth)acrylate, hydroxyalkyl (meth)acrylate, allyl acrylate, hydroxyethyl vinyl ether, hydroxybutyl vinyl ether, maleic acid and crotonic acid; and a constituent unit obtained by introducing a crosslinking reactive group such as (meth)acryloyl group into the above-described constituent unit by a polymer reaction (the crosslinking reactive group can be introduced, for example, by causing an acrylic acid chloride to act on a hydroxy group).

In addition to the fluorine-containing monomer unit and the constituent unit for imparting the crosslinking reactivity, a monomer not containing a fluorine atom may also be appropriately copolymerized in view of solubility in solvent, transparency of film or the like. The monomer unit which can be used in combination is not particularly limited and examples thereof include olefins (e.g., ethylene, propylene, isoprene, vinyl chloride, vinylidene chloride), acrylic acid esters (e.g., methyl acrylate, methyl acrylate, ethyl acrylate, 2-ethylhexyl acrylate), methacrylic acid esters (e.g., methyl methacrylate, ethyl methacrylate, butyl methacrylate, ethylene glycol dimethacrylate), styrene derivatives (e.g., styrene, divinylbenzene, vinyltoluene, α-methylstyrene), vinyl ethers (e.g., methyl vinyl ether, ethyl vinyl ether, cyclohexyl vinyl ether), vinyl esters (e.g., vinyl acetate, vinyl propionate, vinyl cinnamate), acrylamides (e.g., N-tert-butylacrylamide, N-cyclohexylacrylamide), methacryl-amides and acrylonitrile derivatives.

With this polymer, a curing agent may be appropriately used in combination as described in JP-A-10-25388 and JP-A-10-147739.

The particularly useful fluorine-containing polymer for use in the low refractive index layer is a random copolymer of a perfluoroolefin and a vinyl ether or ester. In particular, the fluorine-containing polymer preferably has a group capable of undergoing a crosslinking reaction by itself (for example, a radical reactive group such as (meth)acryloyl group, or a ring-opening polymerizable group such as epoxy group and oxetanyl group). The crosslinking reactive group-containing polymerization unit preferably occupies from 5 to 70 mol %, more preferably from 30 to 60 mol %, in all polymerization units of the polymer.

In a preferred embodiment, the copolymer for use in the low refractive index layer includes the compound represented by the following formula 4a:

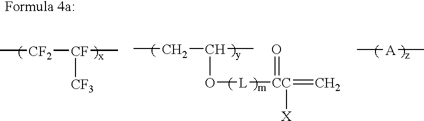

In formula 4a, L represents a linking group having a carbon number of 1 to 10, preferably a linking group having a carbon number of 1 to 6, more preferably a linking group having a carbon number of 2 to 4, which may be linear or may have a branched or cyclic structure and which may have a heteroatom selected from O, N and S.

Preferred examples thereof include *-(CH₂)₂—β-**, *-(CH₂)₂—NH-**, *-(CH₂)₄—O**, *-(CH₂)₆—β-**, —(CH₂)₂—(CH₂)₂—**, *-CONH—(CH₂)₃—β-**, *-CH₂CH(OH)CH₂—β-**, *-CH₂CH₂OCONH(CH₂)₃—β-** (wherein * denotes a linking site on the polymer main chain side and ** denotes a linking site on the (meth)acryloyl group side). m represents 0 or 1.

In formula 4a, X represents a hydrogen atom or a methyl group and in view of curing reactivity, preferably a hydrogen atom.

In formula 4a, A represents a repeating unit derived from an arbitrary vinyl monomer. The repeating unit is not particularly limited as long as it is a constituent component of a monomer copolymerizable with hexafluoropropylene, and may be appropriately selected by taking account of various points such as adhesion to substrate, Tg of polymer (contributing to film hardness), solubility in solvent, transparency, slipperiness, dust protection and antifouling property. The repeating unit may comprise a single vinyl monomer or multiple vinyl monomers according to the purpose.

Preferred examples thereof include vinyl ethers such as methyl vinyl ether, ethyl vinyl ether, tert-butyl vinyl ether, cyclohexyl vinyl ether, isopropyl vinyl ether, hydroxyethyl vinyl ether, hydroxybutyl vinyl ether, glycidyl vinyl ether and allyl vinyl ether; vinyl esters such as vinyl acetate, vinyl propionate and vinyl butyrate; (meth)acrylates such as methyl (meth)acrylate, ethyl (meth)acrylate, hydroxyethyl (meth)acrylate, glycidyl methacrylate, allyl (meth)acrylate and (meth)acryloyloxypropyltrimethoxysilane; styrene derivatives such as styrene and p-hydroxymethylstyrene; an unsaturated carboxylic acid such as crotonic acid, maleic acid and itaconic acid; and a derivative thereof. Among these, more preferred are a vinyl ether derivative and a vinyl ester derivative, still more preferred is a vinyl ether derivative.

x, y and z represent mol % of respective constituent components and each represents a value satisfying 30≦x≦60, 5≦y≦70 and 0≦7≦65, preferably 35≦x≦55, 30≦y≦60 and 0≦z≦20, more preferably 40≦x≦55, 40≦y≦55 and 0≦z≦10.

In a more preferred embodiment, the copolymer for use in the low refractive index layer includes the compound represented by formula 4b:

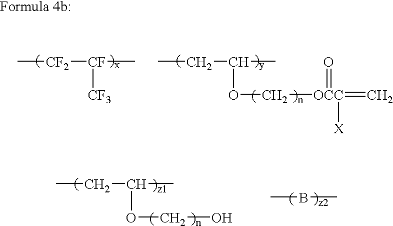

In formula 4b, X, x and y have the same meanings as in formula 4a and preferred ranges are also the same.

n represents an integer of 2≦n≦10, preferably 2≦n≦6, more preferably 2≦n≦4.

B represents a repeating unit derived from an arbitrary vinyl monomer and may comprise a single composition or multiple compositions. Examples thereof include those described above as examples of A in formula 4a.

z1 and z2 represent mol % of respective units and each represents a value satisfying 0≦z1≦65 and 0≦z2≦65, preferably 0≦z1≦30 and 0≦z2z≦10, more preferably 0≦z1≦10 and 0≦z2≦5.

The copolymer represented by formula 4a or 4b can be synthesized, for example, by introducing a (meth)acryloyl group into a copolymer comprising a hexafluoropropylene component and a hydroxyalkyl vinyl ether component, according to any method described above.

Preferred examples of the copolymer useful in the present invention are set forth below, but the present invention is not limited thereto.

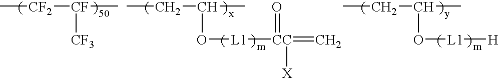

| | | | | | | Number Average |
|---|---|---|---|---|---|---|
| | | | | | | Molecular Weight |
| | x | y | m | L1 | X | Mn (×10⁴) |
| P-1 | 50 | 0 | 1 | *—CH₂CH₂O— | H | 3.1 |
| P-2 | 50 | 0 | 1 | *—CH₂CH₂O— | CH₃ | 4.0 |
| P-3 | 45 | 5 | 1 | *—CH₂CH₂O— | H | 2.8 |
| P-4 | 40 | 10 | 1 | *—CH₂CH₂O— | H | 3.8 |
| P-5 | 30 | 20 | 1 | *—CH₂CH₂O— | H | 5.0 |
| P-6 | 20 | 30 | 1 | *—CH₂CH₂O— | H | 4.0 |
| P-7 | 50 | 0 | 0 | — | H | 11.0 |
| P-8 | 50 | 0 | 1 | *—C₄H₈O— | H | 0.8 |
| P-9 | 50 | 0 | 1 | 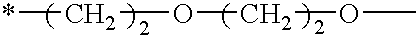 | H | 1.0 |
| P-10 | 50 | 0 | 1 | 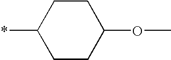 | H | 7.0 |
| P-11 | 50 | 0 | 1 | *—CH₂CH₂NH— | H | 4.0 |
| P-12 | 50 | 0 | 1 | 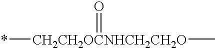 | H | 4.5 |
| P-13 | 50 | 0 | 1 | 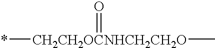 | CH₃ | 4.5 |
| P-14 | 50 | 0 | 1 | 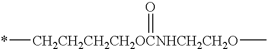 | CH₃ | 5.0 |
| P-15 | 50 | 0 | 1 | 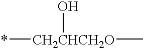 | H | 3.5 |
| P-16 | 50 | 0 | 1 | 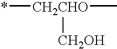 | H | 3.0 |
| P-17 | 50 | 0 | 1 | 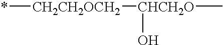 | H | 3.0 |
| P-18 | 50 | 0 | 1 | 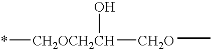 | CH₃ | 3.0 |
| P-19 | 50 | 0 | 1 | 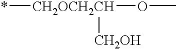 | CH₃ | 3.0 |
| P-20 | 40 | 10 | 1 | *—CH₂CH₂O— | CH₃ | 0.6 |

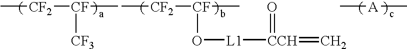

| | | | | | | Number Average |
|---|---|---|---|---|---|---|
| | | | | | | Molecular Weight |
| | a | b | c | L1 | A | Mn (×10⁴) |
| P-21 | 55 | 45 | 0 | *—CH₂CH₂O—** | — | 1.8 |
| P-22 | 45 | 55 | 0 | *—CH₂CH₂O—** | — | 0.8 |
| P-23 | 50 | 45 | 5 | 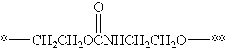 | 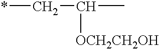 | 0.7 |
| P-24 | 50 | 45 | 5 | 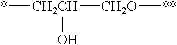 | 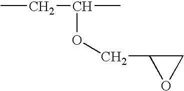 | 4.0 |
| P-25 | 50 | 45 | 5 | 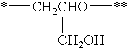 | 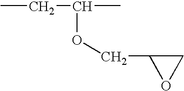 | 4.0 |
| P-26 | 50 | 40 | 10 | *—CH₂CH₂O—** | 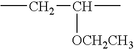 | 4.0 |
| P-27 | 50 | 40 | 10 | *—CH₂CH₂O—** | 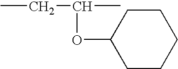 | 4.0 |
| P-28 | 50 | 40 | 10 | *—CH₂CH₂O—** | 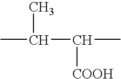 | 5.0 |

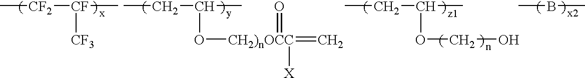

| | | | | | | | | Number Average |
|---|---|---|---|---|---|---|---|---|
| | | | | | | | | Molecular Weight |
| | x | y | Z1 | Z2 | n | X | B | Mn (×10⁴) |
| P-29 | 50 | 40 | 5 | 5 | 2 | H | 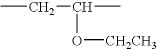 | 5.0 |
| P-30 | 50 | 35 | 5 | 10 | 2 | H | 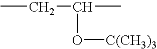 | 5.0 |
| P-31 | 40 | 40 | 10 | 10 | 4 | CH₃ | 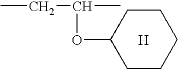 | 4.0 |

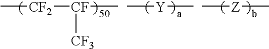

| | | | | | Number Average |
|---|---|---|---|---|---|
| | | | | | Molecular Weight |
| | a | b | Y | Z | Mn (×10⁴) |
| P-32 | 45 | 5 | 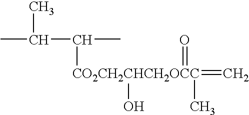 | 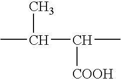 | 4.0 |
| P-33 | 40 | 10 | 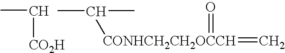 | 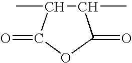 | 4.0 |

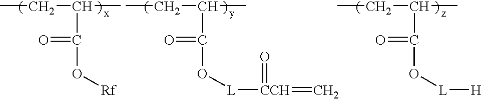

| | | | | | | Number Average |
|---|---|---|---|---|---|---|
| | | | | | | Molecular Weight |
| | x | y | Z | Rf | L | Mn (×10⁴) |
| P-34 | 60 | 40 | 0 | —CH₂CH₂C₈F₁₇-n | *—CH₂CH₂O— | 11 |
| P-35 | 60 | 30 | 10 | —CH₂CH₂C₄F₈H-n | *—CH₂CH₂O— | 30 |
| P-36 | 40 | 60 | 0 | —CH₂CH₂C₆F₁₂H | *—CH₂CH₂CH₂CH₂O— | 4.0 |

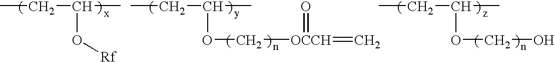

| | | | | | | Number Average |
|---|---|---|---|---|---|---|
| | | | | | | Molecular Weight |
| | x | y | z | n | Rf | Mn (×10⁴) |
| P-37 | 50 | 50 | 0 | 2 | —CH₂C₄F₈H-n | 5.0 |
| P-38 | 40 | 55 | 5 | 2 | —CH₂C₄F₈H-n | 4.0 |
| P-39 | 30 | 70 | 0 | 4 | —CH₂C₈F₁₇-n | 10 |
| P-40 | 60 | 40 | 0 | 2 | —CH₂CH₂C₈F₁₈H-n | 5.0 |

*denotes the polymer main chain side.
**denotes the acryoyl group side.

The synthesis of the copolymer for use in the low refractive index layer can be performed by synthesizing a precursor such as hydroxyl group-containing polymer according to various polymerization methods (e.g., solution polymerization, precipitation polymerization, suspension polymerization, precipitation polymerization, block polymerization, emulsion polymerization), and then introducing a (meth)acryloyl group through the above-described polymer reaction. The polymerization reaction can be performed by a known operation such as batch system, semi-continuous system or continuous system.

The polymerization initiating method includes a method of using a radical initiator, a method of irradiating light or radiation, and the like. These polymerization methods and polymerization initiating methods are described, for example, in Teiji Tsuruta, Kobunshi Gosei Hoho (Polymer Synthesis Method), revised edition, Nikkan Kogyo Shinbun Sha (1971), and Takayuki Ohtsu and Masaetsu Kinoshita, Kobunshi Gosei no Jikken Ho (Test Method of Polymer Synthesis), pp. 124-154, Kagaku Dojin (1972).

Among those polymerization methods, a solution polymerization method using a radical initiator is preferred. Examples of the solvent for use in the solution polymerization include various organic solvents such as ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol and 1-butanol. One of these solvents may be used alone, or a mixture of two or more thereof may be used. A mixed solvent with water may also be used.

The polymerization temperature needs to be set according to the molecular weight of polymer, the kind of initiator, and the like and a polymerization temperature from 0° C. or less to 100° C. or more can be used, but the polymerization is preferably performed in the range from 50 to 100° C.

The reaction pressure can be appropriately selected but is usually from 1 to 100 kg/cm², preferably on the order of 1 to 30 kg/cm². The reaction time is approximately from 5 to 30 hours.

The reprecipitation solvent for the polymer obtained is preferably isopropanol, hexane, methanol or the like.

The fluorine-containing polymer for use in the low refractive index layer is added in an amount of 20 to 95 mass % based on the solid content of the coating composition for the low refractive index layer.

The inorganic fine particle which can be contained in the low refractive index layer of the present invention is described below.

The amount of the inorganic fine particle blended is preferably from 1 to 100 mg/m², more preferably from 5 to 80 mg/m², still more preferably from 10 to 60 mg/m². When the amount blended is in the above-described range, this ensures excellent scratch resistance, reduction in the generation of fine irregularities on the low refractive index layer surface, and enhancement of the appearance such as real black and the integrated reflectance.

The inorganic fine particle is contained in the low refractive index layer and therefore, this particle preferably has a low reflective index.

Examples thereof include fine particles of magnesium fluoride and silica. Particularly, in view of refractive index, dispersion stability and cost, a silica fine particle is preferred. The average particle diameter of the silica fine particle is preferably from 30 to 150%, more preferably from 35 to 80%, still more preferably from 40 to 60%, of the thickness of the low refractive index layer. In other words, when the thickness of the low refractive index layer is 100 nm, the particle diameter of the silica fine particle is preferably from 30 to 150 nm, more preferably from 35 to 80 nm, still more preferably from 40 to 60 nm.

If the particle diameter of the silica fine particle is too small, the effect of improving the scratch resistance decreases, whereas if it is excessively large, fine irregularities are formed on the low refractive index layer surface and this deteriorates the appearance such as real black or the integrated reflectance.

The silica fine particle may be crystalline or amorphous, may be a monodisperse particle, or may be even an aggregated particle as long as the predetermined particle diameter is satisfied. The shape is most preferably spherical but even if amorphous, there arises no problem.

The average particle diameter of the inorganic fine particle is measured by a Coulter counter.

In order to more reduce the increase in refractive index of the low refractive index layer, a hollow silica fine particle is preferably used. The refractive index of the hollow silica fine particle is from 1.17 to 1.40, preferably from 1.17 to 1.35, more preferably 1.17 to 1.30. The refractive index used here indicates a refractive index of the particle as a whole and does not represent a refractive index of only silica as an outer shell forming the hollow silica particle. At this time, assuming that the radius of the vacancy inside the particle is a and the radius of the outer shell of the particle is b, the porosity x calculated according the following mathematical formula (VIII) is preferably from 10 to 60%, more preferably from 20 to 60%, and most preferably from 30 to 60%.
x=(4πa³/3)/(4πb³/3)×100 Formula (VIII)

If the hollow silica particle is rendered to have a lower refractive index and a higher porosity, the thickness of the outer shell becomes small and the strength as a particle decreases. Therefore, in view of scratch resistance, a particle having a refractive index as low as less than 1.17 cannot be used.

Here, the refractive index of the hollow silica particle was measured by an Abbe's refractometer (manufactured by ATAGO K.K.).

Also, at least one silica fine particle having an average particle diameter of less than 25% of the thickness of the low refractive index layer (this particle is referred to as a “small particle-size silica fine particle”) is preferably used in combination with the silica fine particle having the above-described particle diameter (this particle is referred to as a “large particle-size silica fine particle”).

The small particle-size silica fine particle can be present in a space between large particle-size silica fine particles and therefore, can contribute as a holding agent for the large particle-size silica fine particle.

When the thickness of the low refractive index layer is 100 nm, the average particle diameter of the small particle-size silica fine particle is preferably from 1 to 20 nm, more preferably from 5 to 15 nm, still more preferably from 10 to 15 nm. Use of such a silica fine particle is preferred in view of the raw material cost and the holding agent effect.

The silica fine particle may be subjected to a physical surface treatment such as plasma discharge treatment and corona discharge treatment, or a chemical surface treatment with a surfactant, a coupling agent or the like, so as to stabilize the dispersion in a liquid dispersion or a coating solution or to enhance the affinity for or binding property with binder components. Use of a coupling agent is particularly preferred. As the coupling agent, an alkoxy metal compound (e.g., titanium coupling agent, silane coupling agent) is preferably used. In particular, a treatment with a silane coupling agent is effective.

The coupling agent is used as a surface treating agent for previously applying a surface treatment to the inorganic filler of the low refractive index layer before a coating solution for the layer is prepared, but the coupling agent is preferably further added as an additive at the preparation of the coating solution for the low refractive index layer and incorporated into the layer.

The silica fine particle is preferably dispersed in a medium in advance of the surface treatment so as to reduce the load of the surface treatment.

The matters described above in regard to the silica fine particle also apply to other inorganic fine particles.

In view of scratch resistance, at least one functional layer constituting the antireflection film of the present invention preferably contains a so-called sol component, that is, an organosilane compound or a hydrolysate and/or partial condensate thereof (hereinafter sometimes referred to as a “sol component”), in the coating solution for forming the functional layer. Particularly, the low refractive index layer preferably contains a sol component for obtaining both the antireflection ability and the scratch resistance, and the hard coat layer also preferably contains a sol component. This sol component is condensed to form a cured product during drying and heating after the coating of the coating solution, and works out to a binder of the layer. When the cured product has a polymerizable unsaturated bond, a binder having a three-dimensional structure is formed by the irradiation of actinic rays.

The organosilane compound is preferably represented by the following formula 5:
(R¹⁰)ₘ—Si(X)₄₋ₘ Formula 5

In formula 5, R¹⁰ represents a substituted or unsubstituted alkyl group or a substituted or unsubstituted aryl group. The alkyl group is preferably an alkyl group having a carbon number of 1 to 30, more preferably from 1 to 16, still more preferably from 1 to 6. Specific examples of the alkyl group include methyl, ethyl, propyl, isopropyl, hexyl, decyl and hexadecyl. Examples of the aryl group include phenyl and naphthyl, with a phenyl group being preferred.

X represents a hydroxyl group or a hydrolyzable group such as an alkoxy group (preferably an alkoxy group having a carbon number of 1 to 5, e.g., methoxy, ethoxy), a halogen atom (e.g., Cl, Br, I) and a group represented by R²COO (wherein R² is preferably a hydrogen atom or an alkyl group having a carbon number of 1 to 5, e.g., CH₃COO, C₂H₅COO), preferably an alkoxy group, more preferably a methoxy group or an ethoxy group.

m represents an integer of 1 to 3, preferably 1 or 2, more preferably 1.

When a plurality of R¹⁰s or Xs are present, multiple R¹⁰s or Xs may be the same or different.

The substituent contained in R¹⁰ is not particularly limited, but examples thereof include a halogen atom (e.g., fluorine, chlorine, bromine), a hydroxyl group, a mercapto group, a carboxyl group, an epoxy group, an alkyl group (e.g., methyl, ethyl, i-propyl, propyl, tert-butyl), an aryl group (e.g., phenyl, naphthyl), an aromatic heterocyclic group (e.g., furyl, pyrazolyl, pyridyl), an alkoxy group (e.g., methoxy, ethoxy, i-propoxy, hexyloxy), an aryloxy group (e.g., phenoxy), an alkylthio group (e.g., methylthio, ethylthio), an arylthio group (e.g., phenylthio), an alkenyl group (e.g., vinyl, 1-propenyl), an acyloxy group (e.g., acetoxy, acryloyloxy, methacryloyloxy), an alkoxycarbonyl group (e.g., methoxycarbonyl, ethoxycarbonyl), an aryloxycarbonyl group (e.g., phenoxycarbonyl), a carbamoyl group (e.g., carbamoyl, N-methylcarbamoyl, N,N-dimethylcarbamoyl, N-methyl-N-octylcarbamoyl) and an acylamino group (e.g., acetylamino, benzoylamino, acrylamino, methacrylamino). These substituents each may be further substituted.

When a plurality of R¹⁰s are present, at least one is preferably a substituted alkyl group or a substituted aryl group. In particular, an organosilane compound having a vinyl polymerizable substituent represented by the following formula 6 is preferred.

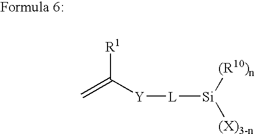

In formula 6, R¹ represents a hydrogen atom, a methyl group, a methoxy group, an alkoxycarbonyl group, a cyano group, a fluorine atom or a chlorine atom. Examples of the alkoxycarbonyl group include a methoxycarbonyl group and an ethoxycarbonyl group. R¹ is preferably a hydrogen atom, a methyl group, a methoxy group, a methoxycarbonyl group, a cyano group, a fluorine atom or a chlorine atom, more preferably a hydrogen atom, a methyl group, a methoxycarbonyl group, a fluorine atom or a chlorine atom, still more preferably a hydrogen atom or a methyl group.

Y represents a single bond, *-COO-**, *-CONH-** or *-O-**, preferably a single bond, *-COO-** or *-CONH-**, more preferably a single bond or *-COO-**, still more preferably *-COO-**. * denotes the position bonded to ═C(R¹) and ** denotes the position bonded to L.

L represents a divalent linking chain. Specific examples thereof include a substituted or unsubstituted alkylene group, a substituted or unsubstituted arylene group, a substituted or unsubstituted alkylene group having inside a linking group (e.g., ether, ester, amido), and a substituted or unsubstituted arylene group having inside a linking group. L is preferably a substituted or unsubstituted alkylene group, a substituted or unsubstituted arylene group or an alkylene group having inside a linking group, more preferably an unsubstituted alkylene group, an unsubstituted arylene group or an alkylene group having inside an ether or ester linking group, still more preferably an unsubstituted alkylene group or an alkylene group having inside an ether or ester linking group. Examples of the substituent include a halogen, a hydroxyl group, a mercapto group, a carboxyl group, an epoxy group, an alkyl group and an aryl group. These substituents each may be further substituted.

n represents 0 or 1. When a plurality of Xs are present, multiple Xs may be the same or different. n is preferably 0.

R¹⁰ has the same meaning as in formula 5 and is preferably a substituted or unsubstituted alkyl group or an unsubstituted aryl group, more preferably an unsubstituted alkyl group or an unsubstituted aryl group.

X has the same meaning as in formula 5 and is preferably a halogen atom, a hydroxyl group or an unsubstituted alkoxy group, more preferably a chlorine atom, a hydroxyl group or an unsubstituted alkoxy group having a carbon number of 1 to 6, still more preferably a hydroxyl group or an alkoxy having a carbon number of 1 to 3, and yet still more preferably a methoxy group.

The compounds represented by formulae 5 and 6 may be used in combination of two or more thereof. Specific examples of the compounds represented by formulae 5 and 6 are set forth below, but the present invention is not limited thereto.

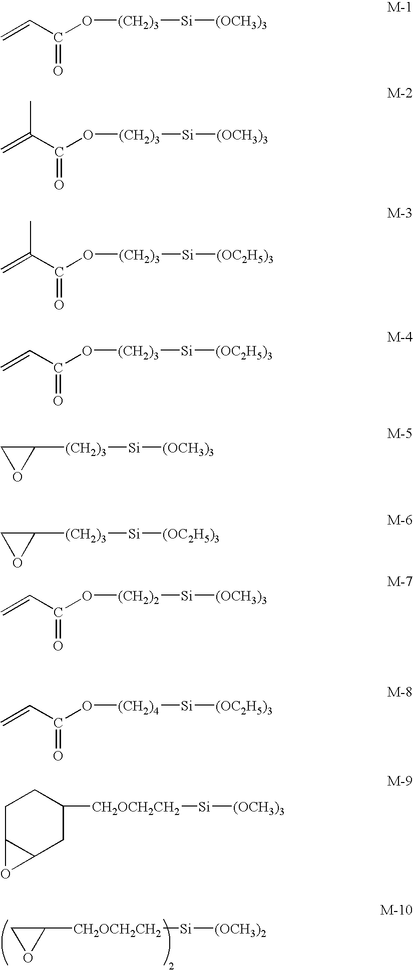

Among these compounds, (M-1), (M-2) and (M-5) are preferred.

The hydrolysate and/or partial condensate of the organosilane compound for use in the present invention are described in detail below.

The hydrolysis and subsequent condensation reaction of organosilane are generally performed in the presence of a catalyst. Examples of the catalyst include inorganic acids such as hydrochloric acid, sulfuric acid and nitric acid; organic acids such as oxalic acid, acetic acid, formic acid, methanesulfonic acid and toluenesulfonic acid; inorganic bases such as sodium hydroxide, potassium hydroxide and ammonia; organic bases such as triethylamine and pyridine; metal alkoxides such as triisopropoxyaluminum and tetrabutoxyzirconium; and metal chelate compounds with the center metal being a metal such as Zr, Ti or Al. Among the inorganic acids, a hydrochloric acid and a sulfuric acid are preferred. Among the organic acids, those having an acid dissociation constant (pKa value (25° C.)) of 4.5 or less in water are preferred, a hydrochloric acid, a sulfuric acid and an organic acid having an acid dissociation constant of 3.0 or less in water are more preferred, a hydrochloric acid, a sulfuric acid and an organic acid having an acid dissociation constant of 2.5 or less in water are still more preferred, an organic acid having an acid dissociation constant of 2.5 or less in water is yet still more preferred, with a methanesulfonic acid, an oxalic acid, a phthalic acid and a malonic acid being more preferred, and an oxalic acid being still more preferred.

The hydrolysis•condensation reaction of organosilane may be performed with or without a solvent but in order to uniformly mix the components, an organic solvent is preferably used. Suitable examples thereof include alcohols, aromatic hydrocarbons, ethers, ketones and esters.

The solvent is preferably a solvent capable of dissolving organosilane and a catalyst. The organic solvent is preferably used as a coating solution or a part of a coating solution in view of process, and those of not impairing the solubility or dispersibility when mixed with other materials such as fluorine-containing polymer are preferred.

Among these organic solvents, examples of the alcohols include a monohydric alcohol and a dihydric alcohol. The monohydric alcohol is preferably a saturated aliphatic alcohol having a carbon number of 1 to 8.

Specific examples of the alcohols include methanol, ethanol, n-propyl alcohol, i-propyl alcohol, n-butyl alcohol, sec-butyl alcohol, tert-butyl alcohol, ethylene glycol, diethylene glycol, triethylene glycol, ethylene glycol monobutyl ether and ethylene glycol acetate monoethyl ether.

Specific examples of the aromatic hydrocarbons include benzene, toluene and xylene. Specific examples of the ethers include tetrahydrofuran and dioxane. Specific examples of the ketones include acetone, methyl ethyl ketone, methyl isobutyl ketone and diisobutyl ketone. Specific examples of the esters include ethyl acetate, propyl acetate, butyl acetate and propylene carbonate.

One of these organic solvents may be used alone, or a mixture of two or more thereof may be used. The solid content concentration in the reaction is not particularly limited but is usually from 1 to 90%, preferably from 20 to 70%.

The reaction is performed by adding water in an amount of 0.3 to 2 mol, preferably 0.5 to 1 mol, per mol of the hydrolyzable group of organosilane, and stirring the resulting solution at 25 to 100° C. in the presence or absence of the above-described solvent and in the presence of a catalyst.

In the present invention, the hydrolysis is preferably performed by stirring the solution at 25 to 100° C. in the presence of at least one metal chelate compound where an alcohol represented by the formula: R³OH (wherein R³ represents an alkyl group having a carbon number of 1 to 10) and a compound represented by the formula: R⁴COCH₂COR⁵ (wherein R⁴ represents an alkyl group having a carbon number of 1 to 10 and R⁵ represents an alkyl group having a carbon number of 1 to 10 or an alkoxy group having a carbon number of 1 to 10) are present as ligands and the center metal is a metal selected from Zr, Ti and Al.

Any metal chelate compound can be suitably used without particular limitation as long as it is a metal chelate compound where an alcohol represented by the formula: R³OH (wherein R³ represents an alkyl group having a carbon number of 1 to 10) and a compound represented by the formula: R⁴COCH₂COR⁵ (wherein R⁴ represents an alkyl group having a carbon number of 1 to 10 and R⁵ represents an alkyl group having a carbon number of 1 to 10 or an alkoxy group having a carbon number of 1 to 10) are present as ligands and the center metal is a metal selected from Zr, Ti and Al. Within this category, two or more kinds of metal chelate compounds may be used in combination. The metal chelate compound for use in the present invention is preferably a compound selected from the compounds represented by the formulae: Zr(OR³)ₚ₁(R⁴COCHCOR⁵)ₚ₂, Ti(OR³)_{q1}(R⁴COCHCOR⁵)_{q2} and Al(OR³)ᵣ₁(R⁴COCHCOR⁵)ᵣ₂, and these compounds have an activity of accelerating the condensation reaction of a hydrolysate and/or partial condensate of the organosilane compound.

In the metal chelate compounds, R³ and R⁴ may be the same or different and each represents an alkyl group having a carbon number of 1 to 10, such as ethyl group, n-propyl group, i-propyl group, n-butyl group, sec-butyl group, tert-butyl group, n-pentyl group or phenyl group. R⁵ represents the same alkyl group having a carbon number of 1 to 10 as above or an alkoxy group having a carbon number of 1 to 10, such as methoxy group, ethoxy group, n-propoxy group, i-propoxy group, n-butoxy group, sec-butoxy group or tert-butoxy group. In the metal chelate compounds, p1, p2, q1, q2, r1 and r2 each represents an integer determined to satisfy the relationships of p1+p2=4, q1+q2=4 and r1+r2=3.

Specific examples of the metal chelate compound include a zirconium chelate compound such as zirconium tri-n-butoxyethylacetoacetate, zirconium di-n-butoxy-bis-(ethylacetoacetate), zirconium n-butoxy-tris(ethylacetoacetate), zirconium tetrakis(n-propylacetoacetate), zirconium tetrakis(acetylacetoacetate) and zirconium tetrakis(ethylacetoacetate); a titanium chelate compound such as titanium diisopropoxybis(ethylacetoacetate), titanium diisopropoxybis(acetylacetate) and titanium diisopropoxybis(acetylacetone); and an aluminum chelate compound such as aluminum diisopropoxyethylacetoacetate, aluminum diisopropoxyacetylacetonate, aluminum isopropoxybis(ethylacetoacetate), aluminum isopropoxybis(acetylacetonate), aluminum tris(ethylacetoacetate), aluminum tris(acetylacetonate) and aluminum monoacetylacetonatobis(ethylacetoacetate).

Among these metal chelate compounds, preferred are zirconium tri-n-butoxyethylacetoacetate, titanium diisopropoxybis(acetylacetonate), aluminum diisopropoxyethylacetoacetate and aluminum tris(ethylacetoacetate). One of these meal chelate compounds may be used alone, or a mixture of two or more thereof may be used. A partial hydrolysate of such a metal chelate compound may also be used.

The metal chelate compound is preferably used in an amount of 0.01 to 50 mass %, more preferably from 0.1 to 50 mass %, still more preferably from 0.5 to 10 mass %, based on the organosilane compound. If the amount added is less than 0.01 mass %, the condensation reaction of the organosilane compounds proceeds slowly and the durability of the coating film may be worsened, whereas if it exceeds 50 mass %, the composition comprising a hydrolysate and/or partial condensate of organosilane compound and a metal chelate compound may be deteriorated in the storage stability and this is not preferred.

In the coating solution for forming the hard coat layer or low refractive index layer for use in the present invention, a β-diketone compound and/or a β-ketoester compound is preferably added in addition to the composition containing the above-described sol component and metal chelate compound. This is further described below.

The compound used in the present invention is a β-diketone compound and/or β-ketoester compound represented by the formula: R⁴COCH₂COR⁵, and this compound functions as a stability enhancer for the composition used in the present invention. That is, this compound is considered to coordinate to a metal atom in the metal chelate compound (zirconium, titanium and/or aluminum compound) and inhibit the metal chelate compound from exerting the activity of accelerating the condensation reaction of hydrolysate and/or partial condensate of the organosilane compound, thereby improving the storage stability of the composition obtained. R⁴ and R⁵ constituting the β-diketone compound and/or β-ketoester compound have the same meanings as R⁴ and R⁵ constituting the metal chelate compound.

Specific examples of the β-diketone compound and/or β-ketoester compound include acetylacetone, methyl acetoacetate, ethyl acetoacetate, n-propyl acetoacetate, i-propyl acetoacetate, n-butyl acetoacetate, sec-butyl acetoacetate, tert-butyl acetoacetate, 2,4-hexane-dione, 2,4-heptane-dione, 3,5-heptane-dione, 2,4-octane-dione, 2,4-nonane-dione and 5-methyl-hexane-dione. Among these, ethyl acetoacetate and acetylacetone are preferred, and acetylacetone is more preferred. One of these β-diketone compounds and/or β-ketoester compounds may be used alone, or a mixture of two or more thereof may be used. In the present invention, the β-diketone compound and/or β-ketoester compound is preferably used in an amount of 2 mol or more, more preferably from 3 to 20 mol, per mol of the metal chelate compound. If the amount added is less than 2 mol, the composition obtained may have poor storage stability and this is not preferred.

The content of the hydrolysate and/or partial condensate of organosilane compound is preferably small in a surface layer which is a relatively thin film, and large in a lower layer which is a thick film. In the case of a surface layer such as low refractive index layer, the content is preferably from 0.1 to 50 mass %, more preferably from 0.5 to 20 mass %, still more preferably from 1 to 10 mass %, based on the entire solid content of the layer containing it (layer to which added).

The amount added to a layer other than the low refractive index layer is preferably from 0.001 to 50 mass %, more preferably from 0.01 to 20 mass %, still more preferably from 0.05 to 10 mass %, yet still more preferably from 0.1 to 5 mass %, based on the entire solid content of the layer containing it (layer to which added).

In the present invention, it is preferred to first prepare a composition containing the hydrolysate and/or partial condensate of organosilane compound and the metal chelate compound, add a β-diketone compound and/or β-ketoester compound thereto, incorporate the resulting solution into a coating solution for at least one layer of the hard coat layer and the low refractive index layer, and coat the coating solution.

When the expression of effect, the refractive index, the shape/surface state of film, and the like are considered, the amount of the sol component of organosilane used in the low refractive index layer is preferably from 5 to 100 mass %, more preferably from 5 to 40 mass %, still more preferably from 8 to 35 mass %, yet still more preferably from 10 to 30 mass %, based on the fluorine-containing polymer.

In the present invention, a dispersion stabilizer is preferably used in combination in the coating solution for forming each layer so as to prevent aggregation and precipitation of the inorganic filler. Examples of the dispersion stabilizer which can be used include a polyvinyl alcohol, a polyvinylpyrrolidone, a cellulose derivative, a polyamide, a phosphoric acid ester, a polyether, a surfactant, a silane coupling agent and a titanium coupling agent. Among these, a silane coupling agent is preferred because the film after curing is strong.

The composition for forming the low refractive index layer of the present invention usually takes a liquid form and is produced by using the above-described copolymer as a preferred constituent component and dissolving it together with various additives as needed and a radical polymerization initiator in an appropriate solvent. At this time, the solid content concentration is appropriately selected according to use but is generally on the order of 0.01 to 60 mass %, preferably from 0.5 to 50 mass %, more preferably from 1 to 20 mass %.

As described above, the addition of additives such as curing agent is not necessarily advantageous in view of the film hardness of the low refractive index layer, but in the light of interface adhesion to the high refractive index layer or the like, a curing agent such as polyfunctional (meth)acrylate compound, polyfunctional epoxy compound, polyisocyanate compound, aminoplast, polybasic acid and anhydrate thereof, or an inorganic fine particle such as silica, may be added in a small amount. In the case of adding such an additive, the amount added thereof is preferably from 0 to 30 mass %, more preferably from 0 to 20 mass %, still more preferably from 0 to 10 mass %, based on the entire solid content of the low refractive index layer film.

For the purpose of imparting properties such as slipperiness and resistance against contamination, water and chemicals, for example, a known silicon-based or fluorine-based antifouling agent and a slipping agent may also be appropriately added. In the case of adding such an additive, the additive is preferably added in the range from 0.01 to 20 mass %, more preferably from 0.05 to 10 mass %, still more preferably from 0.1 to 5 mass %, based on the entire solid content of the low refractive index layer.

Preferred examples of the silicone-based compound include those containing a plurality of dimethylsilyloxy units as the repeating unit and having a substituent at the chain terminal and/or on the side chain. In the chain of the compound containing dimethylsilyloxy as the repeating unit, a structural unit other than dimethylsilyloxy may be contained. A plurality of substituents, which may be the same or different, are preferably present. Preferred examples of the substituent include a group containing an acryloyl group, a methacryloyl group, a vinyl group, an aryl group, a cinnamoyl group, an epoxy group, an oxetanyl group, a hydroxyl group, a fluoroalkyl group, a polyoxyalkylene group, a carboxyl group or an amino group. The molecular weight is not particularly limited but is preferably 100,000 or less, more preferably 50,000 or less, and most preferably from 3,000 to 30,000. The silicone atom content of the silicone-based compound is not particularly limited but is preferably 18.0 mass % or more, more preferably from 25.0 to 37.8 mass %, and most preferably from 30.0 to 37.0 mass %. Specific preferred examples of the silicone-based compound include, but are not limited to, X-22-174DX, X-22-2426, X-22-164B, X-22-164C, X-22-170DX, X-22-176D and X-22-1821 (all are trade names) produced by Shin-Etsu Chemical Co., Ltd., and FM-0725, FM-7725, DMS-U22, RMS-033, RMS-083 and UMS-182 (all are trade names) produced by Chisso Corporation.

The fluorine-based compound is preferably a compound having a fluoroalkyl group. The fluoroalkyl group preferably has a carbon number of 1 to 20, more preferably from 1 to 10, and may be linear (e.g., —CF₂CF₃, —CH₂(CF₂)₄, —CH₂(CF₂)₈CF₃, —CH₂CH₂(CF₂)₄H), may have a branched structure (e.g., CH(CF₃)₂, CH₂CF(CF₃)₂, CH(CH₃)CF₂CF₃, CH(CH₃)(CF₂)₅CF₂H) or an alicyclic structure (preferably a 5- or 6-membered ring, for example, a perfluorocyclohexyl group, a perfluorocyclopentyl group or an alkyl group substituted with such a group) or may have an ether bond (e.g., CH₂OCH₂CF₂CF₃, CH₂CH₂OCH₂C₄F₈H, CH₂CH₂OCH₂CH₂C₈F₁₇, CH₂CH₂OCF₂CF₂OCF₂CF₂H). A plurality of the fluoroalkyl groups may be contained within the same molecule.

The fluorine-based compound preferably further has a substituent which contributes to the bond formation or compatibility with the low refractive index layer film. A plurality of substituents, which may be the same or different, are preferably present. Preferred examples of the substituent include an acryloyl group, a methacryloyl group, a vinyl group, an aryl group, a cinnamoyl group, an epoxy group, an oxetanyl group, a hydroxyl group, a polyoxyalkylene group, a carboxyl group and an amino group. The fluorine-based compound may be a copolymer or copolymerization oligomer with a compound not containing a fluorine atom. The molecular weight is not particularly limited. The fluorine atom content of the fluorine-based compound is not particularly limited but is preferably 20 mass % or more, more preferably from 30 to 70 mass %, and most preferably from 40 to 70 mass %. Specific preferred examples of the fluorine-based compound include, but are not limited to, R-2020, M-2020, R-3833 and M-3833 (all are trade names) produced by Daikin Kogyo Co., Ltd., and Megafac F-171, F-172, F-179A and DYFENSA MCF-300 (all are trade names) produced by Dai-Nippon Ink & Chemicals, Inc.

For the purpose of imparting properties such as dust protection and antistatic property, a dust inhibitor, an antistatic agent and the like such as known cationic surfactant or polyoxyalkylene-based compound may be appropriately added. A structural unit of such a dust inhibitor or antistatic agent may be contained as a part of the function in the above-described silicone-based compound or fluorine-based compound. In the case of adding such an additive, the additive is preferably added in the range from 0.01 to 20 mass %, more preferably from 0.05 to 10 mass %, still more preferably from 0.1 to 5 mass %, based on the entire solid content of the lower refractive index layer. Preferred examples of the compound include, but are not limited to, Megafac F-150 (trade name) produced by Dai-Nippon Ink & Chemicals, Inc. and SH-3748 (trade name) produced by Toray Dow Corning.

Various coating solutions for use in the present invention each is preferably subjected to a filtration treatment. In this filtration treatment, various filtering mediums generally known may be used. Examples of the filtering medium include polypropylene, polyester, nylon, polytetrafluoroethylene, polyvinylidene fluoride, polysulfone, glass fiber and stainless steel mesh. Particularly, the filtering medium for use in the treatment of an organic solvent-based coating solution is preferably polypropylene, polyester, nylon, polytetrafluoroethylene or the like. These filters are usually provided as a cartridge-type filter on the market. The filtering medium of the filter includes a surface-type filtering medium having a sheet form and effecting filtration on the surface, a depth-type filtering medium which is a thick filtering medium produced, for example, by a method of weaving and thermally melt-bonding fibers and effects filtration in the thickness direction, and the like. A depth-type filter using a filtering medium having a large surface area is preferred. Among the depth-type filters, a filter provided as a type capable of effecting precision filtration from various filter makers is preferred.

For the antiglare hard coat layer, light scattering layer, hard coat layer and the like, a polypropylene-made filter is often used. For the low refractive index layer, a polypropylene-made filter or a tetrafluoroethylene-made filter is often used. The filtration pore size of such a filter is generally expressed by a nominal filtration accuracy or an absolute filtration accuracy, and those having a pore size of approximately from 0.5 to 200 μm are known. The coating solutions for use in the present invention contain particles in many cases, and a filter having an optimal pore size may be selected according to the passing property of the particle and used for the coating solution.

[Production Method of Optical Film]

The optical film of the present invention can be formed by the following method, but the present invention is not limited to this method.

A coating solution containing components for forming the optical functional layer is prepared. The prepared coating solution for forming an optical functional layer is coated on a transparent support by a dip coating method, an air knife coating method, a curtain coating method, a roller coating method, a wire bar coating method, a gravure coating method or an extrusion coating method (see, U.S. Pat. No. 2,681,294), and then heated and dried. Among these coating methods, a wire bar coating method, an extrusion coating method and a microgravure coating method are preferred, and a microgravure coating method is more preferred. The formed coating is irradiated with light or heated to polymerize the monomer for the formation of an optical functional layer and effect curing, whereby an optical functional layer is formed.

If desired, the optical functional layer may comprise a plurality of layers and in this case, the layers may be stacked by repeatedly performing the coating and curing of an optical functional layer in the same manner.

Thereafter, for forming an antireflection film as needed, a coating solution for the formation of a low refractive index layer is coated on the optical functional layer in the same manner and light-irradiated or heated to form a low refractive index layer. In this way, the antireflection film of the present invention is obtained.

The microgravure coating method for use in the present invention is a coating method characterized in that a gravure roll having a diameter of about 10 to 100 mm, preferably from about 20 to 50 mm, and having a gravure pattern engraved on the entire circumference is rotated below the support in the direction reverse to the support-transporting direction and at the same time, a surplus coating solution is scraped off from the surface of the gravure roll by a doctor blade, so that a constant amount of the coating solution can be transferred to and coated on the downside surface of the support at the position where the upside surface of the support is in a free state. A roll-form transparent support is continuously unrolled and on one side of the unrolled support, at least one layer of the optical functional layer and the low refractive index layer containing a fluorine-containing polymer can be coated by the microgravure coating method.

With respect to the conditions for the coating by the microgravure coating method, the number of lines in the gravure pattern engraved on the gravure roll is preferably from 50 to 800 lines/inch, more preferably from 100 to 300 lines/inch, the depth of the gravure pattern is preferably from 1 to 600 μm, more preferably from 5 to 200 μm, the rotation number of the gravure roll is preferably from 3 to 800 rpm, more preferably from 5 to 200 rpm, and the support transportation speed is preferably from 0.5 to 100 m/min, more preferably from 1 to 50 m/min.

The haze value of the thus-formed antireflection film of the present invention is from 3 to 70%, preferably from 4 to 60%, and the average reflectance at 450 to 650 nm is 3.0% or less, preferably 2.5% or less.

With a haze value and an average reflectance of the antireflection film of the present invention in the above-described ranges, good antiglare and antireflection property can be obtained without incurring deterioration of the transmitted image.

In the case of using the optical film, particularly antireflection film, of the present invention for a liquid display device, the antireflection film is disposed on the outermost surface of a display, for example, by providing an adhesive layer on one surface. When the transparent support is triacetyl cellulose, since triacetyl cellulose is used as a protective film for protecting the polarizing layer of a polarizing plate, it is preferred in view of cost to use the optical film, particularly antireflection film, of the present invention as it is for the protective film.

In the case where the optical film, particularly antireflection film, of the present invention is disposed on the outermost surface of a display by providing an adhesive layer on one surface or used as it is for the protective film of a polarizing plate, in order to ensure satisfactory adhesion, a saponification treatment is preferably performed after forming an outermost layer mainly comprising a fluorine-containing polymer on a transparent support. The saponification treatment is performed by a known method, for example, by dipping the film in an alkali solution for an appropriate time. After dipping in an alkali solution, the film is preferably washed thoroughly with water or dipped in a dilute acid to neutralize the alkali component so as to prevent remaining of the alkali component in the film.

By performing a saponification treatment, the surface of the transparent support on the side opposite the surface having the outermost layer is hydrophilized.

The hydrophilized surface is effective particularly for improving the adhesive property to a deflecting film mainly comprising a polyvinyl alcohol. Furthermore, the hydrophilized surface hardly allows for attachment of dusts in air and dusts scarcely intrude into the space between the deflecting film and the antireflection film at the bonding to a deflecting film, so that point defects due to dusts can be effectively prevented.

The saponification treatment is preferably performed such that the surface of the transparent support on the side opposite the surface having the outermost layer has a contact angle to water of 400 or less, more preferably 30° or less, still more preferably 20° or less.

The specific method for the alkali saponification treatment can be selected from the following two methods (1) and (2). The method (1) is advantageous in that the treatment can be performed by the same step as that for general-purpose triacetyl cellulose film, but since the antireflection film surface is also saponified, the surface may be alkali-hydrolyzed to deteriorate the film or if the solution for saponification treatment remains, this causes a problem of staining. If the case is so, the method (2) is advantageous, though a special step for the treatment is necessary.

(1) After the formation of antireflection layer on the transparent support, the film is dipped at least once in an alkali solution, whereby the back surface of the film is saponified.

(2) Before or after the formation of antireflection layer on the transparent support, an alkali solution is coated on the antireflection film surface on the side opposite the surface where the antireflection film is formed, and then the film is heated and washed with water and/or neutralized, whereby only the back surface of the film is saponified.

[Usage]

The polarizing plate mainly comprises a polarizing film and two protective films sandwiching the polarizing film from both sides. The optical film, particularly antireflection film, of the present invention is preferably used for at least one sheet of those two protective films sandwiching the polarizing film from both sides. When the antireflection film of the present invention serves concurrently as a protective film, the production cost of the polarizing plate can be reduced. Also, when the antireflection film of the present invention is used as the outermost layer, a polarizing plate prevented from reflection of external light or the like and excellent in the scratch resistance, antifouling property and the like can be produced.

As the polarizing film, a known polarizing film or a polarizing film cut out from a lengthy polarizing film with the absorption axis of the polarizing film being neither parallel nor perpendicular to the longitudinal direction may be used. The lengthy polarizing film with the absorption axis of the polarizing film being neither parallel nor perpendicular to the longitudinal direction is produced by the following method.

That is, the polarizing film is obtained by stretching a continuously fed polymer film under application of tension while holding both edges of the film with holding means and can be produced by a stretching method where the film is stretched at least in the cross direction at a drawing ratio of 1.1 to 20.0, the holding devices at both edges of the film are moved in the longitudinal direction to creat a difference in the travelling speed of 3% or less therebetween and in the state of the film being held at both edges, the film travelling direction is bent such that the angle made by the film travelling direction at the outlet in the step of holding both edges of the film and the substantial stretching direction of the film is inclined at 20 to 70°. Particularly, a stretching method of giving a inclination angle of 45° is preferred in view of productivity.

The stretching method of the polymer film is described in detail in JP-A-2002-86554 (paragraphs [0020] to [0030]).

Out of two protective films of the polarizer, either one is preferably the optical film of the present invention. In particular, it is preferred that one protective film is the antireflection film. Furthermore, the film other than the antireflection film is preferably an optical compensatory film having an optical compensation layer comprising an optically anisotropic layer. The optical compensatory film (retardation film) can improve the viewing angle properties of a liquid crystal display screen.

The optical compensatory film may be a known optical compensatory film but from the standpoint of enlarging the viewing angle, an optical compensatory film described in JP-A-2001-100042 is preferred, where an optical compensation layer comprising a compound having a discotic structure unit is provided and the angle made by the discotic compound and the support is changing in the depth direction of the layer.

This angle is preferably increased as the distance from the support plane side of the optically anisotropic layer increases.

The optical film and antireflection film of the present invention can be applied to an image display device such as liquid crystal display device (LCD), plasma display panel (PDP), electroluminescence display (ELD) and cathode ray tube display device (CRT). Since the antireflection film of the present invention has a transparent support, this film is used by bonding the transparent support side to the image display surface of an image display device.

In the case of using the optical film or antireflection film of the present invention as one surface protective film of a polarizing film, the film can be preferably used for a transmissive, reflective or transflective liquid crystal display device in a mode such as twisted nematic (TN) mode, super twisted nematic (STN) mode, vertical alignment (VA) mode, in-plane switching (IPS) mode and optically compensated bend cell (OCB) mode.

The VA-mode liquid crystal cell includes (1) a VA-mode liquid crystal cell in the narrow sense where rod-like liquid crystalline molecules are substantially vertically aligned when no voltage is applied but the molecules are substantially horizontally aligned when a voltage is applied (see, JP-A-2-176625), (2) a multi-domain VA-mode (MVA-mode) liquid crystal cell for the enlargement of viewing angle (see, SID97, Digest of Tech. Papers (preparatory paper), 28, 845 (1997)), (3) a liquid crystal cell in a mode (n-ASM mode) where rod-like liquid crystalline molecules are substantially vertically aligned when no voltage is applied but the molecules are aligned in a twisted multi-domain manner when a voltage is applied (see, Nippon Ekisho Toron Kai (Japan Liquid Crystal Workshop) (preparatory paper), 58-59 (1998)) and (4) a SURVIVAL-mode liquid crystal cell (announced in LCD International '98).

The OCB-mode liquid crystal cell is a liquid crystal display device using a liquid crystal cell in a bend alignment mode where rod-like liquid crystalline molecules are aligned substantially in the reverse directions (symmetrically) between the upper and lower parts of the liquid crystal cell, and this is disclosed in U.S. Pat. Nos. 4,583,825 and 5,410,422. Since rod-like liquid crystalline molecules are symmetrically aligned in the upper and lower parts of the liquid crystal cell, this bend alignment-mode liquid crystal cell has a function of self-optical compensation. Therefore, this liquid crystal mode is also called an OCB (optically compensatory bend) liquid crystal mode. The bend alignment-mode liquid crystal display device is advantageous in that the response speed is fast.

In the ECB-mode liquid crystal cell, rod-like liquid crystalline molecules are substantially horizontally aligned when no voltage is applied. This is most popularly used as a color TFT liquid crystal display device and is described in a large number of publications such as EL, PDP, LCD Display, Toray Research Center (2001).

Particularly, in the case of a TN-mode or IPS-mode liquid crystal display device, when as described in JP-A-2001-100043, an optical compensatory film having an effect of enlarging the viewing angle is used for the surface opposite the antireflection film of the present invention out of front and back two protective films of a polarizing film, a polarizing plate having an antireflection effect and a viewing angle enlarging effect with a thickness of one polarizing plate can be obtained and this is preferred.

### EXAMPLES

The present invention is described in greater detail below by referring to Examples, but the present invention is limited thereto.

<Production of Support>

(1-1) Preparation of Cellulose Acylate Solution (a)

Cellulose Acylate Solution (a) having the following composition was prepared. Further, in the same way, Solutions (b) to (f) were prepared in which the added amount of the plasticizer was changed as shown in Table 1 (however, Plasticizer A/Plasticizer B=constant).

[Composition]: Cellulose Acylate Solution (a):

| | | |
|---|---|---|
| Cellulose Triacetate A (powder having a | 100 | parts by mass |
| substitution degree of 2.84, a viscosity | | |
| average polymerization degree of 306, a | | |
| water content of 0.2 mass %, a viscosity | | |
| of 315 mPa · s at 6 mass % in dichloromethane | | |
| solution and an average particle diameter of | | |
| 1.5 mm with standard deviation of 0.5 mm) | | |
| Methylene chloride (first solvent) | 320 | parts by mass |
| Methanol (second solvent) | 83 | parts by mass |
| 1-Butanol (third solvent) | 3 | parts by mass |
| Plasticizer A (triphenyl phosphate) | 7.6 | parts by mass |
| Plasticizer B (biphenyl diphenyl phosphate) | 3.8 | parts by mass |
| UV Agent a: 2-(2′-hydroxy-3′,5′-di- | 0.7 | parts by mass |
| tert-amylphenyl)-benzotriazole) | | |
| UV Agent b: 2-(2′-hydroxy-3′,5′-di- | 0.3 | parts by mass |
| tert-butylphenyl)-5-chlorobenzotriazole) | | |
| Citric acid ester mixture (a mixture of | 0.006 | parts by mass |
| citric acid and its monoethyl ester, diethyl | | |
| ester and triethyl ester) | | |
| Fine particle (silicone dioxide (particle | 0.05 | parts by mass |
| diameter: 15 nm), Mohs' hardness: about 7 | | |

(1-2) Preparation of Cellulose Acylate Solution (g)

In the same way as for cellulose acylate solution (a), Cellulose Acylate Solutions (g-1 to g-3) having the following compositions were prepared.

[Composition]: Cellulose Acylate Solution (g-1):

| | | |
|---|---|---|
| Cellulose Triacetate A (powder having a | 100 | parts by mass |
| substitution degree of 2.84, a viscosity | | |
| average polymerization degree of 306, a water | | |
| content of 0.2 mass %, a viscosity of 315 | | |
| mPa · s at 6 mass % in dichloromethane | | |
| solution and an average particle diameter | | |
| of 1.5 mm with standard deviation of 0.5 mm) | | |
| Methylene chloride (first solvent) | 320 | parts by mass |
| Methanol (second solvent) | 83 | parts by mass |
| 1-Butanol (third solvent) | 3 | parts by mass |
| Plasticizer A (triphenyl phosphate) | 7.6 | parts by mass |
| Plasticizer B (biphenyl diphenyl phosphate) | 3.8 | parts by mass |
| UV Agent a: 2-(2′-hydroxy-3′,5′-di- | 0.8 | parts by mass |
| tert-amylphenyl)benzotriazole) | | |
| UV Agent b: 2-(2′-hydroxy-3′-tert-butyl- | 0.2 | parts by mass |
| 5′-methylphenyl)-5-chlorobenzotriazole) | | |

[Composition]: Cellulose Acylate Solution (g-2):
Another solution was prepared by adding the following
additives to Cellulose Acylate Solution (g-1).

| | | |
|---|---|---|
| Citric acid ester mixture (a mixture of citric | 0.006 | parts by mass |
| acid and its monoethyl ester, diethyl ester | | |
| and triethyl ester) | | |
| Fine particle (silicone dioxide (particle | 0.05 | parts by mass |
| diameter: 15 nm), Mohs' hardness: about 7) | | |

[Composition]: Cellulose Acylate Solution (g-3):
Another solution was prepared by adding the following
additive to Cellulose Acylate Solution (g-1).

| | | |
|---|---|---|
| Fine particle (silicone dioxide (particle | 0.20 | parts by mass |
| diameter: 15 nm), Mohs' hardness: about 7 | | |

[Cotton Compound]

In Cellulose Triacetate A used here, the residual acetic acid amount was 0.1 mass % or less, the Ca content was 58 ppm, the Mg content was 42 ppm, the Fe content was 0.5 ppm, the free acetic acid content was 40 ppm and the sulfate ion content was 15 ppm. Also, the substitution degree of acetyl group at the 6-position was 0.91 corresponding to 32.5% of the entire acetyl. Furthermore, the acetone extraction was 8 mass %, the weight average molecular weight/number average molecular weight ratio was 2.5, the yellow index was 1.7, the haze was 0.08, the transparency was 93.5%, Tg (glass transition temperature, measured by DSC) was 160° C., and the heating value in crystallization was 6.4 J/g. Cellulose Triacetate A was a cellulose triacetate synthesized by using, as the raw material, cellulose obtained from cotton. In the following, this is called Cotton Raw Material TAC.

[Preparation of Cellulose Acylate Solution Dope]

(Dissolution Filtration of Dope)

A dope was prepared to have a total amount of 2,000 kg by mixing a plurality of those solvents above in a 4,000 L-volume stainless steel-made dissolution tank with a stirring blade to obtain a mixed solvent, and gradually adding thereto the cellulose triacetate powder (flake) while thoroughly stirring and dispersing the mixed solvent. Incidentally, the solvents used all had a water content of 0.5 mass % or less. First, the cellulose triacetate powder was charged into a dispersion tank and dispersed by a dissolver-type stirrer having anchor blades on the eccentric stirring shaft and on the center shaft under the conditions such that the powder was initially stirred at a peripheral velocity of 5 m/sec (shear stress: 5×10⁴ kgf/m/sec²) in terms of the stirring shear rate and then at a peripheral velocity of 1 m/sec (shear stress: 1×10⁴ kgf/m/sec²) for 30 minutes. The initial dispersion temperature was 25° C. and the final peak temperature was 48° C. After the completion of dispersion, the high-speed stirring was stopped and by setting the peripheral velocity of anchor blades to 0.5 m/sec, stirring was continued for 100 minutes, thereby swelling the cellulose triacetate flake. The inside of the tank was pressurized to 0.12 MPa with a nitrogen gas until the swelling was completed. At this time, the oxygen concentration in the tank was less than 2 vol % and a state free from a problem in view of explosion protection was maintained. Also, the water content in the dope was confirmed to be 0.5 mass % or less, and this was 0.3 mass % in this experiment.

The swollen solution was fed from the tank and heated in a pipeline with a jacket to 50° C. and further to 90° C. under a pressure of 2 MPa, thereby completely dissolving the solution. The heating time was 15 minutes.

After lowering the temperature to 36° C., the solution was passed through a filtering medium having a nominal pore size of 8 μm to obtain a dope. At this time, the filtration primary pressure was 1.5 MPa and the secondary pressure was 1.2 MPa. As for the filter, housing and pipeline, which are exposed to high temperatures, those made of a hastelloy alloy, assured of excellent corrosion resistance and having a jacket for circulating a heating medium to effect heat-retention or heating were used.

(Concentration, Filtration, Defoaming, Additives)

The thus-obtained dope before concentration was flashed in a tank at 80° C. under atmospheric pressure and the evaporated solvent was separated and recovered by a condenser. The solid content concentration of the dope after flashing was 21.8 mass %. The flash tank had an anchor blade on the center shaft and the dope was defoamed by stirring it with the anchor blade at a peripheral velocity of 0.5 m/sec. The temperature of the dope in the tank was 25° C. and the average residence time in the tank was 50 minutes. This dope was collected and the shear viscosity at 25° C. was measured and found to be 450 (Pa·s) at a shear rate of 10 (sec⁻¹).

The dope was then defoamed by applying a weak supersonic wave thereto. Thereafter, the dope in a pressurized state to 1.5 MPa was first passed through a sintered metal fiber filter having a nominal pore size of 10 μm and then passed through a sintered fiber filter having the same nominal pore size of 10 μm. These filters had a primary pore size of 1.5 MPa and 1.2 MPa, respectively, and a secondary pressure of 1.0 MPa and 0.8 MPa, respectively. The temperature of the dope after filtration was adjusted to 36° C., and the dope was stored in a 2,000 L-volume stainless steel-made stock tank. In the stock tank, an anchor blade was provided on the center shaft and the dope was always stirred at a peripheral velocity of 0.3 m/sec. In this way, Cellulose Acylate Dope (a) was prepared.

(2-1) Solvent Casting Method (Band Method)

After the step of preparing a cellulose acylate solution, a step of casting the obtained dope with use of a band casting machine, thereby forming a cellulose acylate film from the cellulose acylate solution, was performed.

The metal support (casting band) used was a stainless steel-made endless band having a width of 2 m, a length of 56 m (area: 112 m²) and a band thickness of 1.5 mm. In the metal support, the arithmetic average roughness (Ra) was 0.006 μm, the maximum height (Ry) was 0.06 μm, and the ten-point average roughness (Rz) was 0.009 μm. The arithmetic average roughness (Ra), the maximum height (Ry) and the ten-point average roughness (Rz) each was measured as prescribed in JIS B 0601. The band was a type of being driven by two drums. The band tension was adjusted to 1.5×10⁴ kg/m, the relative speed difference between the band and the drum was 0.01 m/min or less, and the fluctuation of the band-driving speed was 0.5% or less.

The drum used in the casting part had a unit for circulating a heat transfer medium (refrigerant) so as to cool the support. In another drum, a heat transfer medium for supplying heat to effect drying could be passed through. The heat transfer mediums were at a temperature of 5° C. (on the casting die side) and 40° C., respectively. The surface temperature in the center part of the support immediately before casting was 15° C. The difference in the temperature between both ends was 6° C. or less.

A surface defect should not be present on both the drum and the band, and a support having no pinhole of 30 μm or more, having 1 or less pinhole of 10 to 30 μm per m², and having 2 or less pinholes of 10 μm or less per m² was used.

On this support, three layers of dope were co-cast from the casting die. In the co-casting, the flow rate of the dope from the casting die with a casting width of 1,700 mm was adjusted such that the layers had a finished thickness of 4 μm, 73 μm and 3 μm, respectively, from the air surface and a product thickness of 80 μm was obtained.

(Casting, Drying)

The temperature in the casting chamber where the casting die and the support were provided was kept at 35° C. The dope cast on the band was first dried by feeding a drying air in a parallel flow. At the drying, the overall heat transfer coefficient from the drying air to the dope was 24 kcal/m²·hr·° C. The temperature of the drying air was 135° C. on the upstream side in the upper part of the band and 140° C. on the downstream side. In the lower part of the band, the temperature of the drying air was 65° C. The saturated temperature of each gas was near −8° C. The oxygen concentration in the drying atmosphere on the support was kept at 5 vol %. In order to keep the oxygen concentration to 5 vol %, the air was displaced with nitrogen gas.

For five seconds after casting, the drying air was prevented from directly blowing on the dope by using a wind shielding device to suppress the fluctuation of static pressure to ±1 Pa or less just near the casting die. When the solvent ratio in the dope became 50 mass % on the dry weight basis, the dope was stripped as a film from the casting support. The surface temperature of the stripped film was 15° C. The average drying rate on the support was 60 mass % of solvent on dry weight basis/minute.

(2-2) Solvent Casting Method (Drum Method)

As for the above-described step of casting a cellulose acylate solution and producing a cellulose acylate film from the cellulose acylate solution, the method of performing using a drum as the metal support was also performed.

A stainless steel-made drum having a width of 2.5 m and being polished to a surface roughness of 0.05 μm or less was used as the support. The construction material was SUS316 having sufficiently high corrosion resistance and strength. The thickness unevenness of the entire drum was 0.5% or less. The drum was rotated with a precision that the rotation unevenness was 0.2 mm or less. The drum also had an average surface roughness of 0.01 μm or less and was imparted with sufficiently high hardness and durability by chromium plating. The fluctuation of the vertical position of the support surface beneath the casting die along the rotation of the drum was suppressed to 200 μm or less. The support was placed in a casing having a wind pressure vibration suppressing device. On this support, three layers of dope were co-cast. The drum was rotated with a precision that the rotation unevenness was 0.2 mm or less. The drum also had an average surface roughness of 0.01 μm or less and was imparted with sufficiently high hardness and durability by chromium plating.

The surface temperature in the center part of the support immediately before casting was −5° C. The difference in the temperature between both ends was 2° C. or less.

A surface defect should not be present on both the drum and the band, and a support having no pinhole of 30 μm or more, having 1 or less pinhole of 10 to 30 μm per m², and having 2 or less pinholes of 10 μm or less per m² was used.

On this support, three layers of dope were co-cast from the casting die. In the co-casting, the flow rate of the dope from the casting die with a casting width of 1,700 mm was adjusted such that the layers had finished thicknesses of 3 μm, 74 μm and 3 μm, respectively, from the air surface and a product thickness of 80 μm was obtained.

In addition to the sample using Solution (a) (for which appropriate concentration adjustment was performed) as the cellulose acylate solution dopes for all the three layers, another sample was further prepared in which Solutions (g-3), (g-1) and (g-2) (for all of which appropriate concentration adjustments were performed) were used as the dopes with different compositions for the air surface, the central portion and the support surface, respectively.

(Casting, Drying)

The temperature in the casting chamber where the casting die and the support were provided was kept at 25° C. The dope cast on the metal support was first dried by feeding a drying air in a parallel flow. At the drying, the overall heat transfer coefficient from the drying air to the dope was 24 kcal/m²·hr·° C. The temperature of the drying air was set to 40° C. The saturated temperature of each gas was near −8° C. The oxygen concentration in the drying atmosphere on the support was kept at 5 vol %. In order to keep the oxygen concentration to 5 vol %, the air was displaced with nitrogen gas.

After casting, when the solvent ratio in the dope became 300 mass % on the dry weight basis, the dope was stripped as a film from the casting support. At this time, the stripping tension was 10 kgf/m, and the stripping rate (stripping roll draw) to the support speed was appropriately set to allow for stripping in the range of 100.1% to 120%. The surface temperature of the stripped film was −5° C. The average drying rate on the support was 600 mass % of solvent on dry weight basis/minute.

After the casting by the above-described band or drum method, the stripped film was transported on a transfer part where a large number of rollers were provided. The transfer part comprises three rollers and the temperature of the transfer part was kept at 40° C. During transportation by the rollers in the transfer part, a tension of 16 to 160N was applied to the film.

(3) Tenter Transportation, Drying, Trimming

The stripped film was transported in the drying zone of a tenter while fixing both ends by the tenter having clips and dried with a drying air. The inside of the tenter was divided into three zones and the drying air temperature was set to 90° C., 100° C. and 110° C. in respective zones from the upstream side. The gas composition of the drying air had a saturated gas concentration at −10° C. The average drying rate in the tenter was 120 mass % (solvent on dry weight basis)/minute. The conditions were adjusted such that the residual solvent amount in the film at the tenter outlet became from 7 to 10 mass %. In the tenter, the film was stretched in the width direction while transporting the film. Assuming that the width of the film transported into the tenter was 100%, the enlarged width was 103%. The draw ratio (tenter driving draw) from the stripping roller to the tenter inlet was 110%. As for the draw ratio in the tenter, the difference of the substantial draw ratio in the portion 10 mm or more distant from the tenter engagement part was 10% or less and the difference of the draw ratio between arbitrary two points 20 mm distant from each other was 5% or less. Out of base ends, the ratio of lengths fixed by the tenter was 90%. Also, the film was transported while cooling the tenter clips so as not to exceeds a temperature of 50° C.

Within 30 seconds from the tenter outlet, both ends were trimmed, that is, the edge of 50 mm on both sides was cut by an NT-type cutter. The oxygen concentration in the drying atmosphere of the tenter part was kept at 5 vol %. In order to keep the oxygen concentration to 5 vol %, the air was displaced with nitrogen gas. Before drying the film at a high temperature in the roller transportation zone described later, the film was preliminarily heated in a preliminary drying zone where a drying air at 100° C. was fed. At this time, the residual solvent amount in the film was nearly 5 mass %.

(4) Post-Drying

The cellulose triacetate film obtained by the above-described procedures was dried after trimming at a high temperature in a roller transportation zone. The roller transportation zone was divided into four sections and a drying air was fed thereto. The temperature of the drying air fed to the sections was 130° C., 130° C., 130° C. and 130° C. from the upstream side. At this time, the roller transportation tension for the film was 100 N/width and the film was dried for about 7 minutes until the residual solvent amount finally became 0.3 mass %. After the termination of drying, the cellulose triacetate film was cooled to 30° C. or lower, subjected to trimming at both ends further followed by knurling of both edges of the film. Knurling was provided by conducting emboss processing from one side whereby the knurling width was 10 mm and the maximum height was made 12 μm higher than the average thickness on average. Thereafter, the film was kept in a chamber with a temperature of 28° C. and a humidity of 70%, and wound up around a winding core with 169 mm diameter with an initial winding tension of 360 N/width and a terminal winding tension of 250 N/width. In this way as described heretofore, a cellulose acylate film (length: 3,500 m, width: 1,300 mm, and thickness: 80 μm) as the transparent support was produced.

In the thus-produced cellulose acylate film, the fluctuation width of the film thickness in Example 1 was +2.4% and the curl value in the width direction was −4.5/m.

(5) Evaluation of Cellulose Acylate Film

The surface plasticizer amount of the film produced above was determined by the ATR-IR measurement using FT-IR device Magma 760 manufactured by Nicolet Japan Corporation. As for the measurement conditions, KRS-5 was used as the crystal for measurement of reflection and the incident angle was set to 45°. The measurement of the plasticizer amount was performed by a method of measuring the intensities of plasticizer absorption peak (1,390 cm⁻¹) and cellulose acylate absorption peak (1,470 cm⁻¹) and determining the intensity ratio. The plasticizer content was determined from a calibration curve of samples varied in the plasticizer/cellulose acylate ratio.

Also, the plasticizer amount of whole of the film was measured by the same measuring method from the transmitted IR in the film thickness direction.

(Flexibility of Film)

The flexibility of the film was comprehensively judged from the handleability, processability, tear strength and the like of the film produced.

A: Soft.

B: Slightly soft.

C: Good flexibility.

D: Slightly hard and brittle.

E: Hard and brittle.

(6) Evaluation Results of Cellulose Acylate Film

Example Samples 1 to 15 and Comparative Samples 1 and 2 were produced in the same manner as above except for changing the plasticizer amount in the cellulose acylate solution, the casting method, the post-drying conditions and the like as shown in Table 1. In the Table, the support surface is a surface contacted with the metal support at the casting and the air surface is a surface on the opposite side to the metal support.

As a result, the surface plasticizer amount could be changed by varying the plasticizer charged amount. When the plasticizer charged amount was made 0%, the surface plasticizer amount could be made 0%, but the film obtained was bad in the flexibility and not suited for the support of the present invention. Also, as for the casting method, the drum casting where the time spent for stripping from the metal support at the casting is short can more decrease the plasticizer amount on the support surface side having good planarity. Furthermore, as seen from Samples 10 and 11, for which the post-drying condition is intense, the surface plasticizer amount can be decreased as compared with the plasticizer amount in whole of the film. In the meantime, a similar effect was also obtained in Samples 14 and 15 prepared by three-layer co-casting method with different compositions for the individual layers.

TABLE 1

| | | Ratio of | | | | | | | |
|---|---|---|---|---|---|---|---|---|---|
| | | Plasticizer | | | | Surface to be Applied | | | |
| | Cellulose | Component in | | | | with Coating of the | Surface | Plasticizer | Flexi- |
| | Acylate | Charged Solid | Casting | Post-Drying | | Present Invention is | Plasticizer | Amount of | bility of |
| | Solution | Content | Method | Conditions | | Performed | Amount | Whole of Film | Film |
| Example Sample 1 | a | 10% | band | 130° | C. 8 min. | support surface | 13.5% | 10% | C |
| Example Sample 2 | a | 10% | band | 130° | C. 8 min. | air surface | 6.5% | 10% | C |
| Example Sample 3 | b | 12% | band | 130° | C. 8 min. | support surface | 15.5% | 12% | C |
| Example Sample 4 | b | 12% | band | 130° | C. 8 min. | air surface | 8.5% | 12% | C |
| Comparative Sample 1 | c | 18% | band | 130° | C. 8 min. | support surface | 21.5% | 15% | B |
| Example Sample 5 | c | 18% | band | 130° | C. 8 min. | air surface | 14.5% | 15% | B |
| Example Sample 6 | d | 6% | band | 130° | C. 8 min. | support surface | 9.5% | 6% | C |
| Example Sample 7 | d | 6% | band | 130° | C. 8 min. | air surface | 3.0% | 6% | C |
| Example Sample 8 | e | 4% | band | 130° | C. 8 min. | support surface | 7.5% | 4% | D |
| Example Sample 9 | e | 4% | band | 130° | C. 8 min. | air surface | 1.5% | 4% | D |
| Comparative Sample 2 | f | 0% | band | 130° | C. 8 min. | support surface | 0.0% | 0% | E |
| Example Sample 10 | a | 10% | drum | 140° | C. 7 min. | support surface | 6.9% | 10% | C |
| Example Sample 11 | a | 10% | drum | 140° | C. 7 min. | air surface | 6.5% | 10% | C |
| Example Sample 12 | a | 10% | drum | 90° | C. 7 min. | support surface | 11.0% | 10% | C |
| Example Sample 13 | a | 10% | drum | 90° | C. 7 min. | air surface | 10.0% | 10% | C |
| Example Sample 14 | g-1˜g-3 | 10% | drum | 140° | C. 7 min. | support surface | 6.8% | 10% | C |
| Example Sample 15 | g-1˜g-3 | 10% | drum | 140° | C. 7 min. | air surface | 6.4% | 10% | C |

(7) Preparation of Coating Solution Coated on Cellulose Acylate Film, Production of Coated Sample
(Preparation of Coating Solution a for Light-Diffusing Layer)

A commercially available zirconia-containing UV-curable hard coat solution (DESOLITE Z7404, produced by JSR CORP., solid content concentration: about 61%, ZrO₂ content in solid content: about 70%, containing a polymerizable monomer and a polymerization initiator) (285 g) and 85 g of a dipentaerythritol pentaacrylate and dipentaerythritol hexaacrylate mixture (DPHA, produced by Nippon Kayaku Co., Ltd.) were mixed and then diluted with 60 g of methyl isobutyl ketone and 17 g of methyl ethyl ketone. Furthermore, 28 g of a silane coupling agent (KBM-5103, produced by Shin-Etsu Chemical Co., Ltd.) was mixed with stirring. The resulting solution was coated and UV-cured and the obtained coating film had a refractive index of 1.61.

To this solution, 35 g of a liquid dispersion obtained by dispersing a 30% methyl isobutyl ketone liquid dispersion of reinforced and crosslinked PMMA particles classified to an average particle diameter of 3.0 μm (MXS-300, produced by Soken Kagaku K.K., refractive index: 1.49) in a polytron dispersing machine at 10,000 rpm for 20 minutes was added. Subsequently, 90 g of a liquid dispersion obtained by dispersing a 30% methyl ethyl ketone liquid dispersion of silica particles having an average particle diameter of 1.5 μm (SEAHOSTA KE-P150, produced by Nippon Shokubai Co., Ltd., refractive index: 1.46) in a polytron dispersing machine at 10,000 rpm for 30 minutes was added. Furthermore, to this coating solution, 0.12 g of a fluorine-based polymer (FP-8) was added to prepare Coating Solution A. The solvent composition of the obtained coating solution was MIBK/MEK=8/2.

Coating Solution B having MIBK/MEK=6/4 was prepared in the same manner.

Incidentally, when the coating solution of the present invention was prepared by using an alcohol-based solvent, aggregation of zirconia particles was observed and a coating solution of giving objective optical properties could not be obtained.

(Preparation of Coating Solution C for Antiglare Hard Coat Layer)

A pentaerythritol triacrylate and pentaerythritol tetraacrylate mixture (PETA, produced by Nippon Kayaku Co., Ltd.) (50 g) was diluted with 38.5 g of a mixed solvent of MIBK/cyclohexanone. Furthermore, 2 g of a polymerization initiator (Irgacure 184, produced by Ciba Specialty Chemicals) was added and mixed with stirring. The resulting solution was coated and WV-cured and the obtained coating film had a refractive index of 1.51.

To this solution, 1.7 g of a 30% MBK liquid dispersion of polystyrene particles having an average particle diameter of 3.5 μm (SX-350, produced by Soken Kagaku K.K., refractive index: 1.60) obtained by dispersion in a polytron dispersing machine at 10,000 rpm for 20 minutes and 13.3 g of a 30% MIBK liquid dispersion of acryl-styrene particles having an average particle diameter of 3.5 μm (produced by Soken Kagaku K.K., refractive index: 1.55) were added. Finally, 0.75 g of a fluorine-based polymer (FP-8) and 10 g of a silane coupling agent (KBM-5103, produced by Shin-Etsu Chemical Co., Ltd.) were added to prepare Coating Solution C. The solvent composition of the obtained coating solution was MIBK/cyclohexanone—7/3.

Coating Solution D having toluene/cyclohexanone=7/3 was prepared in the same manner.

(Production of Optical Film)

The triacetyl cellulose film prepared by casting in Example above was unwound in a roll state and thereon, Coating Solution A or B for the optical functional layer was coated by using a doctor blade and a microgravure roll having a diameter of 50 mm and having a gravure pattern with a line number of 135 lines/inch and a depth of 60 μm, under the condition of a transportation speed of 20 m/min. Thereafter, the coating solution was dried at 100° C. for 40 seconds and then ultraviolet light was irradiated thereon at an illuminance of 400 mW/cm² and a dose of 250 mj/cm² by using an air-cooled metal halide lamp of 160 W/cm (manufactured by I-Graphics K.K.) to cure the coat layer and thereby form an optical functional layer. Then, the film was taken up. After the curing, the thickness of the optical functional layer was about 3.4 μm. Also, the coated amount as a coating solution at this time was about 10 ml/m².

Similarly, Coating Solution C or D for the optical functional layer was coated by using a doctor blade and a microgravure roll having a diameter of 50 mm and having a gravure pattern with a line number of 110 lines/inch and a depth of 65 μm, under the conditions of a gravure roll rotation number of 45 rpm and a transportation speed of 30 m/min. Thereafter, the coating solution was dried at 60° C. for 150 seconds and then ultraviolet light was irradiated thereon at an illuminance of 400 mW/cm² and a dose of 200 mJ/cm² by using an air-cooled metal halide lamp of 160 W/cm (manufactured by I-Graphics K.K.) under nitrogen purging to cure the coat layer and thereby form a functional layer of antiglare hard coat layer (thickness: 6 μm). Then, the film was taken up. At this time, the coated amount as a coating solution was about 20 ml/m².

(8) Evaluation and Results of Coated Sample

[Evaluation of Coated Surface State (Drying Unevenness, Streaks)]

The coated products obtained above were evaluated for the coated surface state. The evaluation was performed by the method of observing the prepared film by the transmission of light from a three-wavelength fluorescent light source and a method of laminating a black sheet or a polarizing plate blacked by the cross-Nicol arrangement on the back surface and inspecting the reflection of light from a three-wavelength fluorescent lamp or an artificial sunlight light source.

In the evaluation of coated product, the evaluation of transmission is severely judged, but A to C in the evaluation of reflection are within the allowable range as the optical film.

The evaluation results were rated as follows.

A: Almost no unevenness was observed.

B: Unevenness was slightly observed but no problem.

C: Unevenness was observed but allowable.

D: Unevenness was observed and not allowable.

E: Unevenness was fairly strong.

[Evaluation of Planarity Ascribable to Film Substrate]

When a polarizing plate was laminated on the coated product, surface undulation having a pitch of 1 to 2 mm was confirmed as the planarity ascribable to the cellulose acylate film. Allowable was rated ◯, unignorable level was rated Δ, and non-allowable was rated X.

(Preparation of Coated Product, Evaluation Results)

The evaluation results of the coated products of Example Samples 21 to 43 of the present invention and Comparative Samples are shown in Table 2. In Examples Samples 21 to 24 and Comparative Sample 1, as a result of coating Coating Solution A relatively hard to permeate into the substrate, coating unevenness was worsened with a large surface plasticizer amount and when the surface plasticizer amount exceeded 20%, the sample was rated non-allowable by the inspection of reflection. Coating Solution B readily permeated into the substrate and when the content of MEK having good drying property was increased, a large effect of improving the coating unevenness was obtained in the region having a small surface plasticizer amount, but in Example Sample 30 where the surface plasticizer amount was large, a non-allowable surface state occurs. In Example Samples 33 and 34 where the coating solution was coated on the air surface having a small surface plasticizer amount, the surface state of the coated product was good but irregularities ascribable to the planarity of the substrate cellulose acylate were slightly observed.

Also, when Coating Solution C or D was coated on substrates differing in the surface plasticizer amount, the coated surface state was worsened as the surface plasticizer amount came close to 13.5%. As for the handleability of the coating solution, Coating Solution C not using toluene was better.

TABLE 2

| | | Surface Applied | | | | | | | |
|---|---|---|---|---|---|---|---|---|---|
| | | with Coating of | Surface | | Solvent of Coating Solution | | | | |
| | Cellulose Acylate | the Present | Plasticizer | Coating | | Composi- | Coated Surface State | | |
| Sample Name | Film | Invention | Amount | Solution | Kind | tion | Transmission | Reflection | Planarity |
| Example | Example Sample | support surface | 7.5% | A | MIBK/MEK | 8/2 | B | A | ◯ |
| Sample 21 | 8 | | | | | | | | |
| Example | Example Sample | support surface | 9.5% | A | MIBK/MEK | 8/2 | B | A | ◯ |
| Sample 22 | 6 | | | | | | | | |
| Example | Example Sample | support surface | 13.5% | A | MIBK/MEK | 8/2 | C | A | ◯ |
| Sample 23 | 1 | | | | | | | | |
| Example | Example Sample | support surface | 15.5% | A | MIBK/MEK | 8/2 | D | C | ◯ |
| Sample 24 | 3 | | | | | | | | |
| Comparative | Comparative | support surface | 21.5% | A | MIBK/MEK | 8/2 | E | E | ◯ |
| Sample 21 | Sample 1 | | | | | | | | |
| Example | Example Sample | support surface | 6.9% | A | MIBK/MEK | 8/2 | A | A | ◯ |
| Sample 25 | 10 | | | | | | | | |
| Example | Example Sample | support surface | 11.0% | A | MIBK/MEK | 8/2 | B | A | ◯ |
| Sample 26 | 12 | | | | | | | | |
| Example | Example Sample | support surface | 7.5% | B | MIBK/MEK | 6/4 | A | A | ◯ |
| Sample 27 | 8 | | | | | | | | |
| Example | Example Sample | support surface | 9.5% | B | MIBK/MEK | 6/4 | B | A | ◯ |
| Sample 28 | 6 | | | | | | | | |
| Example | Example Sample | support surface | 13.5% | B | MIBK/MEK | 6/4 | C | B | ◯ |
| Sample 29 | 1 | | | | | | | | |
| Example | Example Sample | support surface | 15.5% | B | MIBK/MEK | 6/4 | D | D | ◯ |
| Sample 30 | 3 | | | | | | | | |
| Example | Example Sample | support surface | 6.9% | B | MIBK/MEK | 6/4 | A | A | ◯ |
| Sample 31 | 10 | | | | | | | | |
| Example | Example Sample | support surface | 11.0% | B | MIBK/MEK | 6/4 | B | B | ◯ |
| Sample 32 | 12 | | | | | | | | |
| Example | Example Sample | air surface | 6.5% | B | MIBK/MEK | 6/4 | A | A | Δ |
| Sample 33 | 2 | | | | | | | | |
| Example | Example Sample | air surface | 3.0% | B | MIBK/MEK | 6/4 | A | A | Δ |
| Sample 34 | 7 | | | | | | | | |
| Example | Example Sample | support surface | 13.5% | C | MIBK/ | 7/3 | D | D | ◯ |
| Sample 35 | 1 | | | | cyclohexanone | | | | |
| Example | Example Sample | support surface | 11.0% | C | MIBK/ | 7/3 | C | C | ◯ |
| Sample 36 | 12 | | | | cyclohexanone | | | | |
| Example | Example Sample | support surface | 9.5% | C | MIBK/ | 7/3 | B | B | ◯ |
| Sample 37 | 6 | | | | cyclohexanone | | | | |
| Example | Example Sample | support surface | 6.9% | C | MIBK/ | 7/3 | B | A | ◯ |
| Sample 38 | 10 | | | | cyclohexanone | | | | |
| Example | Example Sample | support surface | 13.5% | D | toluene/ | 7/3 | D | D | ◯ |
| Sample 39 | 1 | | | | cyclohexanone | | | | |
| Example | Example Sample | support surface | 11.0% | D | toluene/ | 7/3 | C | C | ◯ |
| Sample 40 | 12 | | | | cyclohexanone | | | | |
| Example | Example Sample | support surface | 9.5% | D | toluene/ | 7/3 | B | B | ◯ |
| Sample 41 | 6 | | | | cyclohexanone | | | | |
| Example | Example Sample | support surface | 6.9% | D | toluene/ | 7/3 | B | A | ◯ |
| Sample 42 | 10 | | | | cyclohexanone | | | | |
| Example | Example Sample | support surface | 6.8% | C | MIBK/ | 7/3 | B | A | ◯ |
| Sample 43 | 14 | | | | cyclohexanone | | | | |

(9) Production of Antireflection Film

A low refractive index layer was imparted to Example Samples 31, 38 and 42 of the present invention.

[Preparation of Coating Solution for Low Refractive Index Layer]

(Preparation of Sol Solution a)

In a reactor equipped with a stirrer and a reflux condenser, 120 parts of methyl ethyl ketone, 100 parts of acryloyloxypropyl trimethoxysilane (KBM-5103 (trade name), produced by Shin-Etsu Chemical Co., Ltd.) and 3 parts of diisopropoxyaluminum ethyl acetoacetate were added and mixed and after adding thereto 30 parts of ion-exchanged water, the mixture was allowed to react at 60° C. for 4 hours. Thereafter, the reaction mixture was cooled to room temperature to obtain Sol Solution a. The mass average molecular weight was 1,800 and in the oligomer or greater polymer components, components having a molecular weight of 1,000 to 20,000 occupied 100%. Also, the gas chromatography revealed that the raw material acryloyloxypropyl trimethoxysilane was not remaining at all.

(Preparation of Coating Solution for Low Refractive Index Layer)

The following composition was charged into a mixing tank and after stirring, filtered through a polypropylene-made filter having a pore size of 1 μm to prepare a coating solution for the low refractive index layer.

<Coating Solution Composition E for Low Refractive Index Layer>

| | | |
|---|---|---|
| Opstar JN-7228A (thermally crosslinking | 100 | parts by mass |
| fluorine-containing polymer liquid | | |
| composition, produced by JSR CORP.) | | |
| MEK-ST (silica dispersion, average particle | 4.3 | parts by mass |
| diameter: 15 nm, produced by Nissan | | |
| Chemicals Industries, Ltd.) | | |
| MEK-ST differing in the particle diameter | 5.1 | parts by mass |
| (silica dispersion, average particle | | |
| diameter: 45 nm, produced by Nissan | | |
| Chemicals Industries, Ltd.) | | |
| Sol Solution a | 2.2 | parts by mass |
| MEK | 15.0 | parts by mass |
| Cyclohexanone | 3.6 | parts by mass |

Coating Solution F using a thermally crosslinking fluorine-containing polymer having a refractive index of 1.44 (JTA-113, solid content concentration: 6%, produced by JSR Corp.) in place of the thermally crosslinking fluorine-containing polymer JN7228A used in the coating solution for the low refractive index layer was produced in the same manner.

(Coating of Low Refractive Index Layer)

The triacetyl cellulose film having provided thereon the functional group of Example Samples 31, 38 and 42 was again unwound and the coating solution for the low refractive index layer shown in Table 3 was coated by using a doctor blade and a microgravure roll having a diameter of 50 mm and having a gravure pattern with a line number of 200 lines/inch and a depth of 30 μm, under the conditions of a gravure roll rotation number of 30 rpm and a transportation speed of 15 m/min. Thereafter, the coating solution was dried at 120° C. for 150 seconds and further dried at 140° C. for 8 minutes, and then ultraviolet light was irradiated thereon at an illuminance of 400 mW/cm² and a dose of 900 mJ/cm² by using an air-cooled metal halide lamp of 240 W/cm (manufactured by I-Graphics K.K.) under nitrogen purging to form a 100 nm-thick low refractive index layer, thereby producing an antireflection film. Then, the film was taken up.

In this way, Example Samples 31E, 38E, 42E where Coating Solution E for Low Refractive Index Layer was coated, and Example Samples 31F, 38F and 42F where Coating Solution F for Low Refractive Index Layer was coated, were produced.

(Saponification Treatment of Antireflection Film)

After the film formation, Sample 1 above was subjected to the following treatment.

An aqueous 1.5 mol/liter sodium hydroxide solution was prepared and kept at 55° C. Furthermore, an aqueous 0.01 mol/liter dilute sulfuric acid solution was prepared and kept at 35° C. The produced antireflection film was dipped in the aqueous sodium hydroxide solution for 2 minutes and then dipped in water to thoroughly wash out the aqueous sodium hydroxide solution. Subsequently, the film was dipped in the aqueous dilute sulfuric acid solution for 1 minute and then dipped in water to thoroughly wash out the aqueous dilute sulfuric acid solution. Finally, the sample was thoroughly dried at 120° C.

In this way, a saponified antireflection film was produced.

(Evaluation of Antireflection Film)

The antireflection film samples obtained were evaluated on the following items. The results are shown in Table 3.

(1) Average Reflectance

The spectral reflectance at an incident angle of 5° in the wavelength region of 380 to 780 nm was measured by using a spectrophotometer (manufactured by JASCO Corp.). The integrating sphere average reflectance at 450 to 650 nm was used for the result.

(2) Evaluation of Scratch Resistance Against Steel Wool

A rubbing test was performed by using a rubbing tester under the following conditions.

Evaluation environment conditions: 25° C., 60% RH

Rubbing Material:

A steel wool (grade No. 0000, produced by Nippon Steel Wool K.K.) was wound around the rubbing tip (1 cm×1 cm) of the tester, which comes into contact with the sample, and fixed with a band to hold it there.

Moving distance (one way): 13 cm

Rubbing speed: 13 cm/sec

Load: 500 g/cm²

Tip contact area: 1 cm×1 cm

Number of rubbings: 10 reciprocations

An oily black ink was coated on the back side of the rubbed sample and the reflected light was observed with an eye. The scratch in the rubbed portion was evaluated according to the following criteria:

⊚: Scratch was not visible at all even when very carefully observed.

◯: Faint scratch was slightly visible when very carefully observed.

◯Δ: Faint scratch was visible.

Δ: Moderate scratch was visible.

ΔX-X: Scratch recognizable at a glance was present.

(3) Evaluation of Rubbing Resistance by Moistened Cotton Swab

A rubbing test was performed by fixing a cotton swab at the rubbing tip of a rubbing tester, fixing the sample at the top and the bottom by clips in a flat dish, dipping the sample and the cotton swab in water at 25° C. at room temperature of 25° C., applying a load of 500 g to the cotton swab, and varying the number of rubbings. The rubbing conditions are as follows.

Rubbing distance (one way): 1 cm

Rubbing speed: about 2 reciprocations/sec

The rubbed sample was observed and the rubbing resistance was evaluated by the number of rubbings of causing film separation according to the following criteria.

X: From 0 to 10 reciprocations for film separation.

XΔ: From 10 to 30 reciprocations.

Δ: From 30 to 50 reciprocations.

◯Δ: From 50 to 100 reciprocations.

◯: From 100 to 150 reciprocations.

⊚: No film separation even by 150 reciprocations.

The results are shown in Table 3. According to the present invention, an antireflection film having excellent surface state uniformity and high scratch resistance is obtained with high productivity.

TABLE 3

| | Coating Solution | Average | | Rubbing Resistance |
|---|---|---|---|---|
| Sample Name Head | for Low Refractive | Reflectance | Steel Wool | by Moistened |
| Coat Layer | Index Layer | (%) | Resistance | Cotton Swab |
| Example Sample 31E | E | 1.5 | ◯Δ | ◯ |
| Example Sample 38E | E | 1.2 | ◯Δ | ◯ |
| Example Sample 42E | E | 1.2 | ◯Δ | ◯ |
| Example Sample 31F | F | 1.7 | ◯ | ◯ |
| Example Sample 38F | F | 1.6 | ◯ | ◯ |
| Example Sample 42F | F | 1.6 | ◯ | ◯ |

[Production of Polarizing Plate]

A PVA film was dipped in an aqueous solution containing 2.0 g/liter of iodine and 4.0 g/liter of potassium iodide at 25° C. for 240 seconds and further dipped in an aqueous solution containing 10 g/liter of boric acid at 25° C. for 60 seconds. Subsequently, the film was introduced into a tenter stretching machine in the mode shown in FIG. 2 of JP-A-2002-86554 and 5.3-fold stretched. Then, the tenter was bent as shown in FIG. 2 with respect to the stretching direction and thereafter, the width was kept constant. The film was dried in an atmosphere at 80° C. and removed from the tenter. The difference in the transportation speed between right and left tenter clips was less than 0.05% and the angle made by the center line of the film introduced and the center line of the film delivered to the next step was 46°. Here, |L1−L2| was 0.7 m, W was 0.7 m and a relationship of |L1−L2|=W was established. The substantial stretching direction Ax-Cx at the tenter outlet was inclined at 45° with respect to the center line 22 of the film delivered to the next step. At the tenter outlet, wrinkling and film deformation were not observed.

The film was laminated with saponified Fujitac (cellulose triacetate, retardation value: 3.0 nm) produced by Fuji Photo Film Co., Ltd., by using a 3% aqueous solution of PVA (PVA-117H produced by Kuraray Co., Ltd.) as the adhesive and the combined films were dried at 80° C. to obtain a polarizing plate having an effective width of 650 mm. The absorption axis direction of the obtained polarizing plate was inclined at 45° with respect to the longitudinal direction. The transmittance of this polarizing plate at 550 nm was 43.7% and the polarization degree was 99.97%. Furthermore, the polarizing plate was cut into a size of 310×233 mm, as a result, a polarizing plate having an absorption axis inclined at 45° with respect to the side could be obtained with an area efficiency of 91.5%.

Subsequently, each film of the samples (saponified) of the present invention produced in Examples 38F and 42F was laminated with this polarizing plate to produce a polarizing plate with an antiglare and antireflection film. Using this polarizing plate, a liquid crystal display device where the antiglare and antireflection layer was disposed as the outermost layer was produced. In the produced liquid crystal display device, excellent contrast was obtained due to no reflection of external light and the reflected image was effaced by virtue of the antiglare property, so that high visibility could be ensured.

[Production of Display Device]

Both surfaces of a polarizer produced by adsorbing iodine to polyvinyl alcohol and stretching the film were protected to produce a polarizing plate by bonding one surface with a 80 μm-thick triacetyl cellulose film (TAC-TD80U, produced by Fuji Photo Film Co., Ltd.) which was dipped in an aqueous 1.5 mol/liter NaOH solution at 55° C. for 2 minutes, then neutralized and washed with water, and bonding another surface with the triacetyl cellulose film of each sample of the present invention produced in Examples 31F and 38F, of which back surface was saponified. The thus-obtained polarizing plate was exchanged with the polarizing plate on the viewing side of a liquid crystal display device (having D-BEF produced by Sumitomo 3M, which is a polarizing separation film having a polarizing selection layer, between the backlight and the liquid crystal cell) of a note-type personal computer having mounted thereon a transmissive TN liquid crystal display device, such that the antireflection film side came to the outermost surface. As a result, the projection of surrounding scenes was extremely reduced and a display device having very high display quality was obtained.

According to the present invention, a high-quality optical film reduced in the coating failure such as coating streak and drying unevenness is provided. Also, according to the present invention, an optical film forming method assured of good stability of the coating solution and reduced in the harmful effect and environmental load due to coating solvent as well as in the coating failure such as coating streak and drying unevenness is provided.

The entire disclosure of each and every foreign patent application from which the benefit of foreign priority has been claimed in the present application is incorporated herein by reference, as if fully set forth.

What is claimed is:

1. An optical film comprising
a support having thereon a coat layer formed by directly coating a coating solution containing at least one organic solvent selected from ketones and esters on a surface of the support, the support comprising a cellulose acylate film containing at least one plasticizer,
wherein a surface plasticizer amount in the cellulose acylate film is from 1 to 20 mass % of the cellulose acylate film.

2. The optical film as claimed in claim 1,
wherein said at least one organic solvent selected from ketones and esters is a solvent having permeability into the cellulose acylate film.

3. The optical film as claimed in claim 1,
wherein the coating solution comprises at least one solvent having no permeability into the cellulose acylate film other than said at least one organic solvent selected from ketones and esters.

4. The optical film as claimed in claim 1,
wherein the surface plasticizer amount in the cellulose acylate film is from 3 to 12 mass % of the cellulose acylate film.

5. The optical film as claimed in claim 1,
wherein the surface plasticizer amount in the cellulose acylate film is smaller than an average plasticizer amount in whole of the cellulose acylate film.

6. The optical film as claimed in claim 1,
wherein the cellulose acylate film is heat-treated at a temperature of 100 to 160° C. for 30 seconds or more before the coating.

7. The optical film as claimed in claim 1,
wherein the plasticizer is a phosphoric acid ester compound.

8. The optical film as claimed in claim 1,
wherein a thickness of the cellulose acylate film is from 20 to 120 μm.

9. The optical film as claimed in claim 1,
wherein the coating solution comprises at least one kind of translucent particles.

10. The optical film as claimed in claim 9,
wherein the coat layer is an antiglare property-imparting layer.

11. The optical film as claimed in claim 1,
wherein a low refractive index layer having a refractive index of 1.31 to 1.45 is further provided on the coat layer directly or through another layer to impart antireflection property.

12. A polarizing plate comprising:
a polarizing film; and
a protective film at least on one side of the the polarizing film,
wherein the protective film is an optical film claimed in claim 1.

13. A method for forming an optical film, comprising:
directly coating a coating solution containing at least one organic solvent selected from ketones and esters on a surface of a support, the support comprising a cellulose acylate film in which at least one plasticizer is contained and a surface plasticizer amount is from 1 to 20 mass % of the cellulose acylate film; and
drying the coating solution to form a coat layer.
